(19) United States
(12) Patent Application Publication
(10) Pub. No.: US 2017/0223023 A1
(43) Pub. Date: Aug. 3, 2017

(54) SCALABLE CONFIGURABLE UNIVERSAL OPERATING SYSTEM

(71) Applicant: Jeffry David Aronson, San Antonio, TX (US)

(72) Inventor: Jeffry David Aronson, San Antonio, TX (US)

(21) Appl. No.: 15/483,970

(22) Filed: Apr. 10, 2017

Related U.S. Application Data
(63) Continuation-in-part of application No. 15/236,337, filed on Aug. 12, 2016, now Pat. No. 9,660,996.
Application No. 15/236,337 is a continuation-in-part of application No. 14/447,283, filed on Jul. 30, 2014, now Pat. No. 9,479,507.
Application No. 14/447,283 is a continuation of application No. 13/702,537, filed on Mar. 4, 2013, now Pat. No. 8,832,794.
Application No. 13/702,537 is a continuation-in-part of application No. 12/908,162, filed on Oct. 20, 2010, now abandoned.

(51) Int. Cl. H04L 29/06; G06F 21/60

(52) U.S. Cl. CPC H04L 63/10; G06F 21/60; H04L 63/0876; H04L 63/20; G06F 1/162

(57) ABSTRACT

A scalable configurable universal operating system, and associated processes and procedures, which, together, are configurable to provide at least one operating system resource. The at least one operating system resource may be utilized by at least one cyber system for providing at least one individual with safe, secure, private cyber interactions with properly identified instances of the individual's cyber devices, with other parties, and with the cyber devices of other parties. Processes and procedures are also provided which may be configured to provide an individual with the ability to selectively grant or selectively deny another party or a cyber device access to at least one part of the individual's cyber activities, cyber interactions, cyber assets, and cyber resources. A scalable configurable universal operating system is also provided which may be configured to provide interoperable use of cyber content, cyber devices, and cyber programming throughout the at least one cyber system.

### CROSS REFERENCE TO RELATED APPLICATIONS

This application is a continuation-in-part application claiming priority to U.S. patent application Ser. No. 15/236,337, filed Aug. 12, 2016 entitled “POINT-OF-CYBER-ACCESS CYBER SYSTEM,” now allowed, having the same inventor, and which is incorporated herein by reference in its entirety; which application is a continuation-in-part application claiming priority to U.S. patent application Ser. No. 14/447,283, now U.S. Pat. No. 9,479,507 (Aronson), filed Jul. 30, 2014 entitled “SINGLE-POINT-OF-ACCESS CYBER SYSTEM,” having the same inventor, and which is incorporated herein by reference in its entirety; which application is a continuation application claiming priority to U.S. Ser. No. 13/702,537, now U.S. Pat. No. 8,832,794 (Aronson), filed Mar. 4, 2013, entitled “SINGLE-POINT-OF-ACCESS CYBER SYSTEM,” having the same inventor, and which is incorporated herein by reference in its entirety, filed as application PCT/US2011/056931 in Oct. 19, 2011, and which is incorporated herein by reference in its entirety; which application is a continuation-in-part application claiming priority to U.S. Ser. No. 12/908,162, filed Oct. 20, 2010, entitled “SINGLE-POINT-OF-ACCESS CYBER SYSTEM, having the same inventor, now abandoned, and which is incorporated herein by reference in its entirety.

### FIELD OF THE DISCLOSURE

The present disclosure pertains generally to a scalable configurable universal operating system that may be scaled or configured to provide for cyber interactions among individuals and cyber devices. More particularly, the present disclosure pertains to a scalable configurable universal operating system, scalable configurable universal operating system processes and scalable configurable universal operating system procedures that, together, may be configured to provide at least one operating system resource that may be utilized by at least one cyber system for providing at least one individual with at least one member selected from the group consisting of: (a) safe, secure, private cyber interactions with the individual's properly identified cyber devices, (b) safe, secure, private cyber interactions with properly identified other parties, and (c) safe, secure, private cyber interactions with the properly identified cyber devices of other parties. In addition, the present disclosure also pertains to processes and procedures that may be configured to provide at least one individual with the ability to selectively grant or to selectively deny at least one other party or at least one cyber device of at least one other party access to at least one part of the individual's cyber activities, cyber interactions, cyber assets, and cyber resources. The present disclosure further pertains to a scalable configurable universal operating system that may be configured to provide at least one cyber system with interoperable use of: (i) at least one cyber device, (ii) cyber content, and (iii) cyber programming of any kind, throughout the at least one cyber system.

### BACKGROUND OF THE DISCLOSURE

Individuals that access prior art cyber systems have little or no assurance or expectations that these systems will provide the individuals with security, privacy, or the ability to accurately grant or deny other parties (or the cyber devices of other parties) access to at least one part of at least one member selected from the group consisting of: (a) the individuals' cyber activities, (b) the individuals' cyber interactions, (c) the individuals' cyber assets, and (d) the individuals' cyber resources. In addition, current cyber systems cannot provide individuals with accurate confirmations of the identities of other parties, or with accurate confirmations of the identities of cyber devices with whom, through use of these systems, the individuals may interact. Further, prior art cyber systems do not provide for cyber system-wide interoperable use of any cyber device, cyber programming, or cyber content.

There thus remains a need in the art for scalable configurable universal operating system programming that can be utilized in conjunction with at least one cyber device of at least one cyber system to provide a safe and secure cyber system that provides at least one individual with safety, security, and privacy for the individual's cyber activities, and that also provides accurate and reliable control over access by other parties to the individual's: (a) cyber activities, (b) cyber interactions, (c) cyber assets, and (d) cyber resources. In addition, a need remains in the art for a combination of scalable configurable universal operating system programming and cyber system devices that may properly identify at least one cyber device and at least one individual that uses the at least one cyber system. Further, a need remains in the art for a combination of scalable configurable universal operating system programming and cyber system devices that provides cyber system-wide interoperable use of any cyber device, cyber programming, or cyber content.

### SUMMARY OF THE DISCLOSURE

A scalable configurable universal operating system is disclosed herein. The scalable configurable universal operating system includes programming that provides or enables processes or procedures that may be configured to be utilized in combination with the processes, procedures, system architectures, device architectures, and devices of at least one cyber system to provide at least one individual with at least one safe and secure cyber system. Within a properly configured safe and secure cyber system each individual and each cyber device may be properly identified prior to at least one cyber interaction with: (a) at least one other party, or (b) at least one cyber device. The programming of the scalable configurable universal operating system may also be configured to provide at least one individual with at least one level of privacy that is requested or required by the individual for the individual's cyber activities, cyber assets, or cyber resources. The scalable configurable universal operating system may also be configured to provide for cyber system-wide interoperable use of any cyber device, cyber programming, or cyber content that may either be previously configured to be used with the scalable configurable universal operating system, or that may be converted for use with the scalable configurable universal operating system through utilization of processes or procedures that are components of the scalable configurable universal operating system.

In one aspect, in combination with at least one cyber system, a scalable configurable universal operating system which provides or enables processes or procedures that may be utilized for at least one operation of at least one component of the at least one cyber system;

wherein the at least one cyber system may be utilized by at least one individual or at least one cyber device;

wherein the at least one cyber system includes at least one member selected from the group consisting of:
(a) cyber communications networks,
(b) cyber portals,
(c) point of cyber access computers,
(d) private computers,
(e) public computers,
(f) cyber telephone systems,
(g) cyber device managers,
(h) cyber assets, and
(i) cyber resources;

wherein the scalable configurable universal operating system may be configured in at least one way;

wherein the scalable configurable universal operating system may be scaled to include operating system resources that fall at one point in the range of from a minimum to a maximum, wherein at the minimum the scalable configurable universal operating system is scaled to provide at least one part of the operating system resources that are needed to provide for the least complex, in regard to included operating system resources, of all operating system needs, and wherein at the maximum, the scalable configurable universal operating system is scaled to include all of the operating system resources that are needed to provide for every operating system need from a full spectrum of operating system needs;

wherein the scalable configurable universal operating system further comprises at least one part of the at least one member selected from the group consisting of:
(a) programming that provides or enables processes or procedures that provide for properly identifying individuals,
(b) programming that provides or enables processes or procedures that provide for properly identifying cyber devices,
(c) programming that provides or enables processes or procedures that provide for requiring that at least one individual be properly identified prior to at least one step that at least one cyber interaction of the at least one individual carries out throughout the at least one cyber system,
(d) programming that provides or enables processes or procedures that provide for requiring that at least one cyber device be properly identified prior to at least one step that at least one cyber interaction of the at least one cyber device carries out throughout the at least one cyber system,
(e) programming that provides or enables processes or procedures that provide for at least one individual to be properly identified prior to at least one step that at least one cyber interaction of the at least one individual carries out throughout the at least one cyber system,
(f) programming that provides or enables processes or procedures that provide for at least one cyber device to be properly identified prior to at least one step that at least one cyber interaction of the at least one cyber device carries out throughout the at least one cyber system,
(g) programming that provides or enables processes or procedures that provide for the operations of, or the use of, cyber communications networks,
(h) programming that provides or enables processes or procedures that provide for the operations of, or the use of, cyber portals,
(i) programming that provides or enables processes or procedures that provide for the operations of, or the use of, point of cyber access computers,
(j) programming that provides or enables processes or procedures that provide for the operations of, or the use of, private computers,
(k) programming that provides or enables processes or procedures that provide for the operations of, or the use of, public computers,
(l) programming that provides or enables processes or procedures that provide for the operations of, or the use of, device-based cyber assets,
(m) programming that provides or enables processes or procedures that provide for the operations of, or the use of, device-based cyber resources,
(n) programming that provides or enables processes or procedures that provide for the operations of, or the use of, cyber device managers,
(o) programming that provides or enables processes or procedures that provide for the operations of, or the use of, cyber telephone systems,
(p) programming that provides or enables processes or procedures that provide for the operations of, or the use of, cyber transfer packet systems,
(q) programming that provides or enables processes or procedures that provide for the operations of, or the use of, mobile or in-motion cyber devices,
(r) programming that provides or enables processes or procedures that provide for the operations of, or the use of, cyber vaults,
(s) programming that provides or enables processes or procedures that provide for the operations of, or the use of, cyber health systems,
(t) programming that provides or enables processes or procedures that provide for the operations of, or the use of, at least one member selected from the group consisting of:
   (i) health care related cyber devices,
   (ii) health care related cyber assets, and
   (iii) health care related cyber resources,
(u) programming that provides or enables processes or procedures that provide for the operations of, or the use of, cyber rights licensing systems,
(v) programming that provides or enables processes or procedures that provide for the operations of, or the use of, cyber mail systems,
(w) programming that provides or enables processes or procedures that provide for the operations of, or the use of, cyber sites,
(x) programming that provides or enables processes or procedures that provide for the operations of, or the use of, cyber education systems,
(y) programming that provides or enables processes or procedures that provide for the operations of, or the use of, cyber payment systems,
(z) programming that provides or enables processes or procedures that provide for the operations of, or the use of, scalable configurable universal operating system standard device interconnection interfaces that may be utilized by cyber devices,
(aa) programming that provides or enables processes or procedures that provide for the operations of, or the use of, a frames and scrolls system or format for image-based cyber content,
(bb) programming that provides or enables processes or procedures that provide for the operations of, or the use of, autonomous devices,
(cc) programming that provides or enables processes or procedures that provide for at least one member selected from the group consisting of:
   (i) creating,
   (ii) accessing,
   (iii) modifying,
   (iv) using,
   (v) sharing,
   (vi) storing, and
   (vii) managing,
file-based cyber assets,
(dd) programming that provides or enables processes or procedures that provide for at least one member selected from the group consisting of:
   (i) creating,
   (ii) accessing,
   (iii) modifying,
   (iv) using,
   (v) sharing,
   (vi) storing, and
   (vii) managing,
file-based cyber resources,
(ee) programming that provides or enables processes or procedures that provide security,
(ff) programming that provides or enables processes or procedures that provide historical records regarding any aspect of the operations of cyber systems, and
(gg) programming that provides or enables processes or procedures that enable an individual to exclusively select at least one setting of at least one member selected from the group consisting of:
   (i) the administrative settings of the individual's cyber systems,
   (ii) the operational settings of the individual's cyber systems, and
   (iii) the access settings of the individual's cyber systems.

In some embodiments of the foregoing combination, the at least one cyber system is selected from the group consisting of the full spectrum of cyber systems;

wherein the full spectrum of cyber systems includes at least one point-of-cyber-access cyber system.

In some embodiments of the foregoing combination, the scalable configurable universal operating system further includes programming that provides or enables processes or procedures that require or provide for separate processing or support for one member or a combination of two or more members selected from the group consisting of:
(a) an individual's private cyber activities,
(b) an individual's private cyber content, and
(c) an individual's private cyber interactions,

as well as separate and different processing or support for one member or a combination of two or more members selected from the group consisting of:
(i) an individual's public cyber activities,
(ii) an individual's cyber content that is made available to at least one other party or at least one cyber device of at least one other party, and
(iii) an individual's public cyber interactions.

In some embodiments of the foregoing combination, the scalable configurable universal operating system further includes programming that provides or enables processes or procedures that provide for interoperable use of at least one member selected from the group consisting of:
(a) cyber programs,
(b) cyber files, and
(c) cyber devices,

that do not operate utilizing at least one member selected from the group consisting of:
(i) scalable configurable universal operating system standard processes,
(ii) scalable configurable universal operating system standard procedures, and
(iii) scalable configurable universal operating system standard formats,

by providing at least one process or procedure that may be utilized to convert the operations of at least one member selected from the group consisting of:
(A) the cyber programs,
(B) the cyber files, and
(C) the cyber devices,

to or from the operations of at least one member selected from the group consisting of:
(1) the scalable configurable universal operating system standard processes,
(2) the scalable configurable universal operating system standard procedures, and
(3) the scalable configurable universal operating system standard formats.

In some embodiments of the foregoing combination, the scalable configurable universal operating system further includes programming that provides or enables processes or procedures that require or provide for the use of at least one member selected from the group consisting of:
(a) unique processes,
(b) unique procedures,
(c) unique protocols,
(d) unique code, and
(e) unique formats,

to be used for at least one member selected from the group consisting of:
(i) cyber programs,
(ii) cyber applications,
(iii) cyber activities, and
(iv) cyber interactions,

that are utilized for different purposes.

In some embodiments of the foregoing combination, the scalable configurable universal operating system further includes programming that provides or enables processes or procedures that may enable an individual to have exclusive control of at least one setting selected from the group consisting of:
(a) administrative settings,
(b) operational settings, and
(c) access control settings,

for at least one member selected from the group consisting of:
(i) said individual's point of cyber access computers,
(ii) said individual's private computers,
(iii) said individual's public computers,
(iv) said individual's cyber device managers,
(v) said individual's cyber telephone systems,
(vi) said individual's cyber vaults,
(vii) said individual's cyber assets, and
(viii) said individual's cyber resources.

In some embodiments of the foregoing combination, the scalable configurable universal operating system further includes programming that provides or enables processes or procedures that utilize a combination of:
(a) a virtual equivalent of at least one projector, in conjunction with,
(b) a virtual equivalent of at least one projection display screen that receives the virtual equivalent of at least one image output from the at least one projector, and
(c) a virtual equivalent of at least one recorder or capture device that provides the virtual equivalent of at least one recording of at least one image from the at least one projection screen, or the virtual equivalent of at least one recording of at least one part of the audio output from the at least one projector,

all of which may be utilized for providing at least one member selected from the group consisting of:
(i) interoperability conversion of at least one member selected from the group consisting of:
   (A) cyber content,
   (B) cyber programming,
   (C) cyber interactions,
   (D) cyber activities, and
   (E) cyber device interactions,
to or from universal interactive operating system standard operations,
(ii) security,
(iii) at least one malicious content trap,
(iv) for altering the size of cyber images,
(v) for altering the resolution of cyber images,
(vi) for altering the visual presence of cyber images,
(vii) for interactive utilization of image-based cyber content, and
(viii) for converging two or more sources of image-based cyber content

into at least one converged source of image-based cyber content.

In some embodiments of the foregoing combination, the scalable configurable universal operating system further includes programming that provides or enables processes or procedures that enable an individual to perform at least one action selected from the group consisting of:
(a) adding architectural components to,
(b) adding programs to,
(c) adding cyber devices to,
(d) removing architectural components from,
(e) removing programs from,
(f) removing cyber devices from,
(g) altering architectural component of,
(h) altering programs of, and
(i) altering cyber devices of,

the at least one cyber system.

In some embodiments of the foregoing combination, the scalable configurable universal operating system further includes programming that provides or enables processes or procedures that enable at least one individual to perform at least one action selected from the group consisting of:
(a) adding processes or procedures to,
(b) removing processes or procedures from, and
(c) altering processes or the procedures of,

at least one component of the at least one cyber system.

In some embodiments of the foregoing combination, the scalable configurable universal operating system further includes programming that provides or enables processes or procedures that enable at least one individual to perform at least one action selected from the group consisting of:
(a) adding at least one member selected from the group consisting of:
   (i) components,
   (ii) processes and
   (iii) procedures,
to at least one cyber device,
(b) removing at least one member selected from the group consisting of:
   (i) components,
   (ii) processes, and
   (iii) procedures,
from at least one cyber device, and
(c) altering at least one member selected from the group consisting of:
   (i) components,
   (ii) processes, and
   (iii) procedures,
of at least one cyber device.

In some embodiments of the foregoing combination, the scalable configurable universal operating system further includes system standard processes or system standard procedures that are utilized for minimizing the number of differing processes or procedures used by others by providing the system standard processes or procedures for use by others.

In some embodiments of the foregoing combination, the scalable configurable universal operating system further includes programming that provides or enables processes or procedures that enable an individual to request or require that at least one other party or at least one cyber device of at least one other party provide the individual with the individual's at least one preference for at least one member selected from the group consisting of:
(i) cyber interactions
(ii) cyber content, and
(iii) privacy.

In some embodiments of the foregoing combination, the scalable configurable universal operating system further includes programming that provides or enables processes or procedures that enable an individual to selectively grant or to selectively deny at least one member selected from the group consisting of:
(a) the individual's device-based cyber assets,
(b) the individual's device-based cyber resources,
(c) other parties, and
(d) cyber devices of other parties,

access to at least one selected part of the individual's cyber assets or the individual's cyber resources, the at least one selected part being selected by the individual.

In another aspect, in combination with at least one cyber system, a tangible, non-transient medium having sufficient programming instructions recorded therein which, when executed by at least one computer processor, performs the steps of:

establishing a scalable configurable universal operating system which provides or enables processes or procedures that may be utilized for at least one part of at least one operation of at least one component of the at least one cyber system,

wherein the at least one cyber system may be utilized by at least one individual or at least one cyber device, wherein the at least one cyber system includes at least one member selected from the group consisting of:
(a) cyber communications networks,
(b) cyber portals,
(c) point of cyber access computers,
(d) private computers,
(e) public computers,
(f) cyber telephone systems,
(g) cyber device managers,
(h) cyber assets, and
(i) cyber resources,

wherein the scalable configurable universal operating system may be configured in at least one way, and

wherein the scalable configurable universal operating system may be scaled to include operating system resources that fall at one point in the range of from a minimum to a maximum, wherein at the minimum the scalable configurable universal operating system is scaled to provide at least one part of the operating system resources that are needed to provide for the least complex, in regard to included operating system resources, of all operating system needs, and wherein at the maximum the scalable configurable universal operating system is scaled to include all of the operating system resources that are needed to provide for every operating system need from a full spectrum of operating system needs; and

providing or enabling, with the established scalable configurable universal operating system, at least one part of at least one member selected from the group consisting of:
(a) processes or procedures that provide for properly identifying individuals,
(b) processes or procedures that provide for properly identifying cyber devices,
(c) processes or procedures that provide for requiring that at least one individual be properly identified prior to at least one step that at least one cyber interaction of the at least one individual carries out throughout the at least one cyber system,
(d) processes or procedures that provide for requiring that at least one cyber device be properly identified prior to at least one step that at least one cyber interaction of the at least one cyber device carries out throughout the at least one cyber system,
(e) processes or procedures that provide for at least one individual to be properly identified prior to at least one step that at least one cyber interaction of the at least one individual carries out throughout the at least one cyber system,
(f) processes or procedures that provide for at least one cyber device to be properly identified prior to at least one step that at least one cyber interaction of the at least one cyber device carries out throughout the at least one cyber system,
(g) processes or procedures that provide for the operations of, or the use of, cyber communications networks,
(h) processes or procedures that provide for the operations of, or the use of, cyber portals,
(i) processes or procedures that provide for the operations of, or the use of, point of cyber access computers,
(j) processes or procedures that provide for the operations of, or the use of, private computers,
(k) processes or procedures that provide for the operations of, or the use of, public computers,
(l) processes or procedures that provide for the operations of, or the use of, device-based cyber assets,
(m) processes or procedures that provide for the operations of, or the use of, device-based cyber resources,
(n) processes or procedures that provide for the operations of, or the use of, cyber device managers,
(o) processes or procedures that provide for the operations of, or the use of, cyber telephone systems,
(p) processes or procedures that provide for the operations of, or the use of, cyber transfer packet systems,
(q) processes or procedures that provide for the operations of, or the use of, mobile or in-motion cyber devices,
(r) processes or procedures that provide for the operations of, or the use of, cyber vaults,
(s) processes or procedures that provide for the operations of, or the use of, cyber health systems,
(t) processes or procedures that provide for the operations of, or the use of, at least one member selected from the group consisting of:
   (i) health care related cyber devices,
   (ii) health care related cyber assets, and
   (iii) health care related cyber resources,
(u) processes or procedures that provide for the operations of, or the use of, cyber rights licensing systems,
(v) processes or procedures that provide for the operations of, or the use of, cyber mail systems,
(w) processes or procedures that provide for the operations of, or the use of, cyber site systems,
(x) processes or procedures that provide for the operations of, or the use of, cyber education systems,
(y) processes or procedures that provide for the operations of, or the use of, cyber payment systems,
(z) processes or procedures that provide for the operations of, or the use of, at least one scalable configurable universal operating system standard device interconnection interface that may be utilized by at least one cyber device,
(aa) processes or procedures that provide for the operations of, or the use of, a frames and scrolls system or format for image-based cyber content,
(bb) processes or procedures that provide for the operations of, or the use of, autonomous devices,
(cc) processes or procedures that provide for at least one member selected from the group consisting of:
   (viii) creating,
   (ix) accessing,
   (x) modifying,
   (xi) using,
   (xii) sharing,
   (xiii) storing, and
   (xiv) managing,
file-based cyber assets,
(dd) processes or procedures that provide for at least one member selected from the group consisting of
   (viii) creating,
   (ix) accessing,
   (x) modifying,
   (xi) using,
   (xii) sharing,
   (xiii) storing, and
   (xiv) managing,
file-based cyber resources,
(ee) processes or procedures that provide security,
(ff) processes or procedures that provide historical records regarding any aspect of the operations of cyber systems, and
(gg) processes or procedures that enable an individual to exclusively select at least one setting of at least one member selected from the group consisting of:
(i) the administrative settings of the individual's at least one cyber system,
(ii) the operational settings of the individual's at least one cyber system, and
(iii) the access settings of the individual's at least one cyber system.

### BRIEF DESCRIPTION OF THE DRAWINGS

A better knowledge of the system, the components of the systems, processes and procedures of the present disclosure may be gained by referring to the drawing figures that illustrate particular non-limiting embodiments of the architectures, components, and functions of a scalable configurable point-of-cyber-access cyber system in accordance with the teachings herein.

FIG. 1 is an overview diagram that illustrates a particular, non-limiting embodiment of a scalable configurable point-of-cyber-access cyber system in accordance with the teachings herein.

FIG. 2 is a schematic block diagram that illustrates a particular, non-limiting embodiment of an architecture (and components thereof) of a scalable configurable point-of-cyber-access cyber system in accordance with the teachings herein.

FIG. 3 is a schematic block diagram that illustrates some particular non-limiting embodiments of interconnections and cyber activities that may occur within the architecture of a scalable configurable point-of-cyber-access cyber system in accordance with the teachings herein.

FIG. 4 is a schematic block diagram that illustrates a particular, non-limiting embodiment of a scalable configurable point-of-cyber-access cyber system in accordance with the teachings herein, and the cyber activities of an individual which may be associated with such a system.

FIG. 5 is a schematic block diagram that illustrates particular, non-limiting embodiments of cyber activities which may be associated with utilization of an individual's device-based cyber assets in accordance with the teachings herein.

FIG. 6 is a schematic block diagram that illustrates particular, non-limiting embodiments of cyber activities which may be associated with an individual, and cyber activities which may be associated with utilization of a remote cyber device in the systems and methodologies disclosed herein.

FIG. 7 is a schematic diagram that illustrates particular, non-limiting embodiments of cyber activities which may be associated with utilization of an individual's device-based cyber assets in the systems and methodologies disclosed herein, as well as cyber activities which may be associated with the individual, and cyber activities which may be associated with utilization of a remote cyber device in the systems and methodologies disclosed herein.

FIG. 8 is a schematic diagram that illustrates particular, non-limiting embodiments of cyber activities which may occur between other parties and an individual's public cyber resources in the systems and methodologies described herein.

FIG. 9 is a schematic diagram that illustrates particular, non-limiting embodiments of cyber activities which may occur between other parties, an individual's public cyber resources, or the individual's cyber telephone system in the systems and methodologies disclosed herein.

FIG. 10 is a schematic diagram that illustrates particular, non-limiting embodiments of cyber activities which may occur between other parties and an individual's cyber telephone system in the systems and methodologies disclosed herein.

FIG. 11 is a schematic diagram that illustrates particular, non-limiting embodiments of an individual's administrative-based, management-based, and operational cyber activities which may be associated with the individual's cyber assets in the systems and methodologies disclosed herein.

FIG. 12 is a schematic diagram that illustrates a particular, non-limiting embodiment of a point of cyber access computer in accordance with the teachings herein, as well as components, interconnections, and associated cyber activities that may occur within the point of cyber access computer.

FIG. 13 is a schematic diagram that illustrates a particular, non-limiting embodiment of an individual's private computer in accordance with the teachings herein, as well as components, interconnections, and associated cyber activities that may occur within the individual's private computer.

FIG. 14 is a schematic diagram that illustrates a particular, non-limiting embodiment of an individual's public computer in accordance with the teachings herein as well as components, interconnections, and associated cyber activities that may occur within the individual's public computer.

FIG. 15 is a schematic diagram that illustrates a particular, non-limiting embodiment of a cyber communications network of a point-of-cyber-access cyber system in accordance with the teachings herein.

FIGS. 16A-16F are illustrations of a particular, non-limiting embodiment of a two-screen cyber portal that may be configured for use in multiple forms in accordance with the teachings herein.

FIG. 17 is an illustration of a particular, non-limiting embodiment of a group of virtual equivalents of devices and processes in accordance with the teachings herein that may be used for at least one purpose selected from the group consisting of (a) security, (b) interoperability conversion, and (c) altering or merging cyber images.

FIGS. 18A-18G are illustrations depicting particular, non-limiting embodiments of cyber images in accordance with the teachings herein, shown in both frame format and scroll format.

### DETAILED DESCRIPTION OF THE DISCLOSURE

The following Detailed Description of the Disclosure is organized as follows:

| Section | | |
|---|---|---|
| No. | Title | Paragraph |
| 1 | Key Definitions | [0040] |
| 2 | General Definitions | [0059] |
| 3 | Advantages | [0091] |
| 4 | Short Overview | [0111] |
| 5 | Expanded Overview | [0127] |
| 6 | Point-of-Cyber-Access Cyber System Architecture | [0183] |
| 7 | Scalable Configurable Universal Operating System | [0198] |
| 8 | Cyber Communications Network | [0339] |
| 9 | Cyber Portal | [0357] |
| 10 | Cyber Communications Network Between a Cyber | [0414] |
| | Portal and a Point of Cyber Access Computer | |
| 11 | Point of Cyber Access Computer, Public | [0420] |
| | Computer, and Private Computer | |
| 12 | Cyber Telephone System | [0444] |
| 13 | Cyber Communications Network Between a | [0454] |
| | Sender's Point of Cyber Access Computer and a | |
| | Recipient's Point of Cyber Access Computer | |
| 14 | An Individual's Cyber Device Manager and The | [0463] |
| | Individual's Device-Based Cyber Assets | |
| 15 | Cyber Communications Network Between an | [0478] |
| | Individual's Cyber Device Manager and The | |
| | Individual's Remote Device-Based Cyber Assets | |
| 16 | Examples of Use of the Point-Of-Cyber-Access | [0487] |
| | Cyber System | |

### (1) Key Definitions

The following meanings and definitions for key words and key phrases shall be used when key words and phrases from this list occur throughout this disclosure.

Confirmed identity: a verified identity of an individual or a first cyber device which is subsequently confirmed by a second cyber device through the utilization of at least one reliable identity confirmation test, process, or procedure.

Cyber: at least one activity, device, system, process, procedure, program, or file that uses non-biological processing of programming for at least one purpose.

Cyber activities: the use by an individual or a cyber device of at least one component or resource of a cyber system.

Cyber assets: the cyber devices or cyber files associated with an individual.

Cyber content: cyber files or programming that may be utilized by an individual through the individual's use of at least one component of a cyber system.

Cyber device: a physical or virtual device, or at least one combination thereof, that directly or indirectly uses non-biological processing of programming to achieve at least one purpose or function.

Cyber resource: at least one part of at least one cyber asset of at least one other party that has been made available by the at least one other party for access or use by at least one selected individual, or at least one selected cyber device of at least one selected individual. The cyber assets that the other party makes available to the at least one individual may be considered to be the cyber resources of the at least one individual.

Device-based cyber assets: an individual's cyber devices.

Entity: any business, government, school, organization, or other group of at least one person that has its own cyber system entity identity designation.

Established identity: the step in a cyber identification process wherein, using at least one accurate and reliable identity test, the identity of an individual, or the identity of a cyber device is first established.

File-based cyber assets: an individual's cyber files, or programming.

Identity designation: The cyber system designation (name) of an individual, or the cyber system designation (name) of a device that is a component of the cyber system. Cyber system architectural rules may require that each individual that uses the cyber system, and that each cyber device that is a component of the cyber system, have one, and only one, permanent cyber system identity designation. An individual's cyber system identity designation, or a cyber device's cyber system identity designation, may also be considered to be their cyber system name.

Individual: any one person or any entity that has its own cyber system identity designation.

Private cyber activities: an individual's use of at least one member from the group consisting of: (a) at least one component, (b) at least one cyber asset, and (c) at least one cyber resource, of a cyber system, wherein all other parties and the cyber devices of all other parties may be excluded from access to at least one member selected from the group consisting of: (i) the individual's private cyber activities, (ii) the individual's private cyber assets, and (iii) the individual's private cyber resources.

Programming: at least one computer program or at least one computer application or at least one usable part thereof that serves at least one purpose. In the various embodiments disclosed herein, these programs may be disposed in tangible, non-transient media and may contain suitable instructions which, when executed by one or more computer processors, performs one or more processes or methods associated with the embodiment.

Properly identified: an individual or a cyber device whose identity has at least one status selected from the group consisting of (a) established, (b) verified, and (c) confirmed, as required by at least one member selected from the group consisting of: (i) cyber system processes, (ii) cyber system procedures, (iii) cyber system protocols, (iv) cyber system architectural rules, (iv) cyber system architectural requirements, and (v) selected criteria.

Public cyber activities: an individual's use of at least one of the individual's cyber assets, or cyber resources, wherein the individual selects to temporarily or permanently share at least one part of the individual's cyber assets, or cyber resources with at least one selected other party, or at least one selected cyber device of at least one selected other party.

Verified identity: an identity, established by a cyber device and of an individual or of a different cyber device, which has undergone subsequent reliable verification during at least one part of further cyber interactions with the individual or the different cyber device.

### (2) General Definitions

The following meanings and definitions for words or phrases shall be used when words or phrases from this list occur throughout this disclosure.

Administrative access: accessing a cyber device for the purpose of interacting with at least one of the administrative functions or settings of the cyber device.

Other party: at least one individual that is not utilizing the resources of a cyber system in the role of “the individual”, “an individual”, “at least one individual”, or “said individual”.

Computer: a physical or a virtual device or at least one combination thereof that includes at least one member selected from the group consisting of: (a) processors, (b) memory, (c) storage, (d) user interfaces, and (e) interconnection structures, that may be utilized to perform at least one action selected from the group consisting of: (i) processing, (ii) accessing, (iii) storing, (iv) modifying, (v) running, (vi) using, (vii) sharing, (viii) deleting, and (ix) copying, at least one member selected from the group consisting of: (1) cyber programming, (2) cyber files, (3) cyber code, and (4) cyber data.

Cyber access: access, in at least one form, to at least one member selected from the group consisting of: (a) at least one cyber device, (b) at least one cyber asset, (c) at least one cyber resource, and (d) at least one cyber activity.

Cyber communications: a communication made through the use of at least one member selected from the group consisting of: (a) cyber system telephone services, (b) cyber system video telephone services, (c) cyber system mail services, (d) cyber system message services, and (e) cyber system cyber interaction transfer services.

Cyber communications network: a communications network (including communications nodes and paths) in a cyber system. The cyber communications network may be configured to provide for safe and secure cyber interactions between cyber devices within a cyber system.

Cyber files: at least one file that (a) requires non-biological processing of content or programming or (b) may be utilized by at least one cyber device.

Cyber identity: at least one cyber file that contains at least one cyber characteristic of one individual or one cyber device that may be used during at least one identity test to safely, securely, and accurately establish or confirm the identity of the one individual, or the identity of the one cyber device.

Cyber interaction: at least one exchange of cyber activity among at least one member selected from the group consisting of: (a) at least one cyber device, (b) at least one component of at least one cyber device, and (c) at least one component of at least one cyber system.

Cyber portal: a cyber device that may be configured to perform at least one action selected from the group consisting of:

(a) sending input from the individual who is using the cyber portal, through a cyber communications network and to the individual's at least one point of cyber access computer;

(b) receiving output for the individual that was sent from the individual's point of cyber access computer and through at least one cyber communications network and to the cyber portal that is being used by the individual;

(c) providing information derived from a sensor observation that may enable the individual's point of cyber access computer to establish the identity of the individual that is using the cyber portal; and

(d) providing output that provides the individual with the ability to: (i) perceive at least one cyber interaction, and (ii) interact with at least one cyber interaction that was sent to the individual by the individual's point of cyber access computer.

Cyber site: a cyber system equivalent of a prior art internet web site.

Cyber system: at least one physical or virtual system (or at least one combination thereof) that uses non-biological processing of programming to achieve at least one purpose or function.

Cyber system address: a cyber system's designation for the location of a cyber device.

Cyber telephone device: at least one cyber portal that is configured to send or to receive at least one cyber telephone communication interaction or cyber video telephone communication interaction.

Cyber vault: a construct which is structured to enable an individual to exclude all other parties (and the cyber devices of all other parties) from gaining access to the contents thereof. Cyber files and cyber devices, including computers, may be contained within the constructs of a cyber vault. The cyber contents of an individual's cyber vault may include at least one part of the individual's: (a) cyber assets, (b) cyber resources, (c) cyber activities, and (d) personal or private information. An individual's private computer may be configured to form an individual's cyber vault. An individual may utilize at least one cyber vault.

Device: a mechanical or cyber device, or at least one combination thereof. A cyber device may be a virtual device or a physical device, or at least one combination thereof.

Frame: cyber image content that has a pixel grid size that is equal to or less than both the height and the width of the pixel grid size of the cyber image display device the image will be displayed upon.

Frames and scrolls format or system: a format or system for creating or using interactive image-based cyber content that utilizes the (x, y) pixel grid location of a cursor from a specific frame formatted image or the (x, y) pixel grid location of a cursor from a specific scroll formatted image to identify the location of an individual's interaction with the specific image.

Manage: the performance, on at least one cyber file, of at least one action selected from the group consisting of: (a) storing, (b) accessing, (c) using, (d) modifying, (e) sharing with other parties, (f) copying, (g) deleting, (h) moving, (i) naming, and (j) renaming.

Operational access: accessing a cyber device for the purpose of operating the cyber device.

Or: unless otherwise specified herein, the term “or” shall be construed as the logically inclusive “or”. Hence, the statement “A or B” shall be true if only A is true, if only B is true, or if both A and B are true. The notation “A and/or B” explicitly refers to the logically inclusive “or”.

Point of cyber access: the point where an individual, after being properly identified, gains further access to cyber resources.

Point of cyber access computer: a combination of devices and programming that are configured to provide an individual with a point of cyber access. The individual's point of cyber access computer provides the individual with proper-identity-based access controls for: (a) the individual, (b) other parties, and (c) cyber devices, and proper routing thereafter. The individual's point of cyber access computer may perform at least one action selected from the group consisting of: (i) establishing the identity of an individual prior to granting the individual further access to at least one part of the individual's cyber assets or cyber resources, (ii) establishing or confirming the identity of at least one other party as the sender of at least one cyber interaction prior to providing the at least one other party's at least one cyber interaction with further access to the individual's cyber assets or cyber resources, and (iii) establishing or confirming the identity of at least one cyber device as the sender of at least one cyber interaction prior to providing the at least one cyber device's at least one cyber interaction with further access to the individual's cyber assets or cyber resources.

An individual's locally or remotely accessible computer that provides the individual with proper-identity-based cyber access control services and at least one asset selected from the group consisting of: (a) cyber assets that provide processing or support for at least one member selected from the group consisting of: (i) the individual's private cyber activities, (ii) the individual's private cyber assets, and (iii) the individual's private cyber resources, and (b) separate and different cyber assets that provide processing or support for at least one member selected from the group consisting of: (i) the individual's public cyber activities, (ii) the individual's publicly available cyber assets, and (iii) the individual's publicly available cyber resources.

Pre-processed cyber interaction: a cyber interaction whose content has been processed to a state in which it may be used without the further processing of content.

Private computer: an individual's locally or remotely accessible computer that may be an integral part of, or work in conjunction with, an individual's point of cyber access computer. An individual's private computer may be configured to where it may only be accessed through utilization of the proper-identity-based cyber access control services of the individual's point of cyber access computer. An individual's private computer may be configured to where it may only be accessed by the individual, or at least one of the individual's selected device-based cyber assets.

Public computer: an individual's locally or remotely accessible computer that may be an integral part of, or work in conjunction with, an individual's point of cyber access computer. A public computer may be configured to where it may be accessed by the cyber interactions of specified other parties or the cyber interactions of specified device-based cyber assets or device-based cyber resources of specified other parties. An individual's public computer may be configured to where it may only be accessed through utilization of the proper-identity-based cyber access control services of the individual's point of cyber access computer.

Scroll: cyber image content that has a pixel grid height or a pixel grid width that is larger in size than the corresponding pixel grid height or pixel grid width of the cyber image display device the image will be displayed upon.

System: more than one process, procedure, or device that are configured together to perform or provide at least one function.

Thin device: a cyber device that is purposefully configured to provide for limited functionality. For example, a thin cyber portal may only provide the minimum functions and resources that are needed for: (a) the operation of the thin cyber portal, and (b) providing for limited specific use of the thin cyber portal. A thin cyber portal may rely on a sender of a cyber interaction to provide the cyber portal with cyber interactions that are pre-processed and ready for use without any further processing of interaction content by the thin cyber portal.

Transfer packet: labeled data, activities, interactions or programming that is transferred across at least one communications network.

User: an individual that uses a cyber system.

### (3) Advantages

Prior art cyber systems have many significant infirmities. One of the most significant of these infirmities is that prior art cyber systems cannot provide adequate and reasonable levels of safety, security, and privacy.

To that point, it is important to recognize that prior art cyber systems are not capable of accurately and reliably identifying one single person while that person is using cyber assets or resources. This, in turn, leads to the prior art system's inability to accurately and reliably hold at least one individual accountable for that individual's own cyber activities.

Further, if an individual's cyber assets are unable to accurately and reliably identify the individual as always being one, and only one, specific and unique individual, then the individual's cyber assets are also unable to accurately and reliably keep impostors from gaining access to the individual's personal and private cyber information, cyber assets, and cyber resources.

The scalable configurable point-of-cyber-access cyber system of the present disclosure, through scalable configurable use of its processes, procedures, architecture, programming, and devices, may be configured to incorporate the use of accurate and reliable identity testing as a tool to provide at least one individual with not only extremely high levels of cyber safety, security, and privacy while using cyber assets or cyber resources, but also with absolute cyber safety, security, and privacy for each individual's own personal and private cyber activities, cyber assets, and cyber resources. Suitable systems and methodologies for implementing such identity testing are disclosed in commonly owned, U.S. Ser. No. 15/456,542 (Aronson), entitled “SCALABLE UNIVERSAL FULL SPECTRUM CYBER DETERMINING PROCESS”, which was filed on Mar. 12, 2017, and which is incorporated herein by reference in its entirety.

The use of accurate and reliable identity testing alone will not provide the highest attainable levels of cyber safety, security, and privacy.

The unbelievably complex environments and ecosystems of prior art cyber systems also contribute greatly to the inability of these systems to provide each individual with adequate and reasonable levels of cyber safety, security, and privacy.

The point-of-cyber-access cyber system of the present disclosure may be configured to utilize a strategy of using a best performing blend of: (a) as simple as possible, (b) as concise as possible, and (c) as efficient as possible. This strategy may preferably be applied to all aspects of the cyber system.

Use of a best performing blend of as simple, as concise, and as efficient as possible as a strategy enables the scalable configurable point-of-cyber-access cyber system of the present disclosure to be configured to achieve the highest levels of cyber safety, security, and privacy that may be obtained. Through use of the point-of-cyber-access cyber system, the unbelievably complex environments that have always plagued prior art cyber systems may be eliminated.

One example of the point-of-cyber-access cyber system's use of as simple, as concise, and as efficient as possible, is its architecture. This architecture may be configured to integrate at least one member selected from the group consisting of: (a) at least one cyber activity, (b) utilization of at least one cyber asset, and (c) utilization of at least one cyber resource, into the operation of one single computer. This one computer may provide for at least one member selected from the group consisting of: (i) phones (ii) televisions (iii) computing devices, (iv) remote device integration devices, (v) personal health devices, and (vi) at least one other type of cyber device, to operate as a part of one system that may be configured to utilize a scalable configurable universal operating system that is as simple, as concise, and as efficient as possible.

Perhaps the greatest benefit an individual may gain from their use of their cyber assets and available cyber resources is the benefit that may be derived by first collecting, and then using, the individual's own personal and private information. This cyber function may be configured to provide the individual with technology-based augmentation of the individual's own natural cognitive and perceptive capabilities. An individual's use of cyber assets and cyber resources for the purpose of augmenting the individual's own natural cognitive and perceptive capabilities is similar in concept to an individual's use of an automobile to augment the individual's own natural ability to move from one location to another.

Further, each individual may also derive benefit from the use of their own body of collected information when the individual's cyber assets use that information to predict, and be prepared to provide for, whatever cyber assets or cyber resources the individual may want or need, both now and in the future.

The scalable configurable point-of-cyber-access cyber system of the present disclosure may be configured to provide each individual with absolute safety, security, and privacy for all personal and private cyber activities, cyber assets, and cyber resources.

To achieve the highest levels of cyber safety, security, and privacy for an individual, it is essential and of utmost importance that no others ever gain access to the individual's: (a) personal and private cyber activities, and (b) personal and private cyber assets.

The following six concepts, may be embodied in at least one configuration of the scalable configurable point-of-cyber-access cyber system. The six concepts may be configured to solve many of the existing problems with prior art cyber systems.

1. Each cyber device, and each individual that uses a cyber system, should be required to be properly identified prior to each step that the cyber interactions of the individual, or the cyber device, takes throughout the cyber system.

2. Each individual that uses a cyber system should have his or her identity established by the individual's at least one remotely accessible point of cyber access computer.

3. Each individual that uses a cyber system should gain access to the cyber system exclusively through the individual's at least one point of cyber access computer.

4. The at least one point of cyber access computer of each individual should utilize: (a) at least one separate and different computer that is exclusively utilized for the processing or support for one member or a combination of two or more members selected from the group consisting of: (i) the individual's private cyber activities, (ii) the individual's private cyber assets, and (iii) the individual's private cyber resources, and (b) at least one separate and different computer that is exclusively used for the processing or support for one member or the combination of two or more members selected from the group consisting of: (i) the individual's public cyber activities, (ii) the individual's publicly available cyber assets, and (iii) the individual's publicly available cyber resources.

5. Each individual should have exclusive access to the individual's own at least one private computer that provides processing and support for the individual's private cyber activities, private cyber assets, and private cyber resources.

6. A cyber system should provide for seamless interoperable use of any cyber content, cyber programming, and cyber devices that are being utilized as a part of the cyber system.

### (4) Short Overview

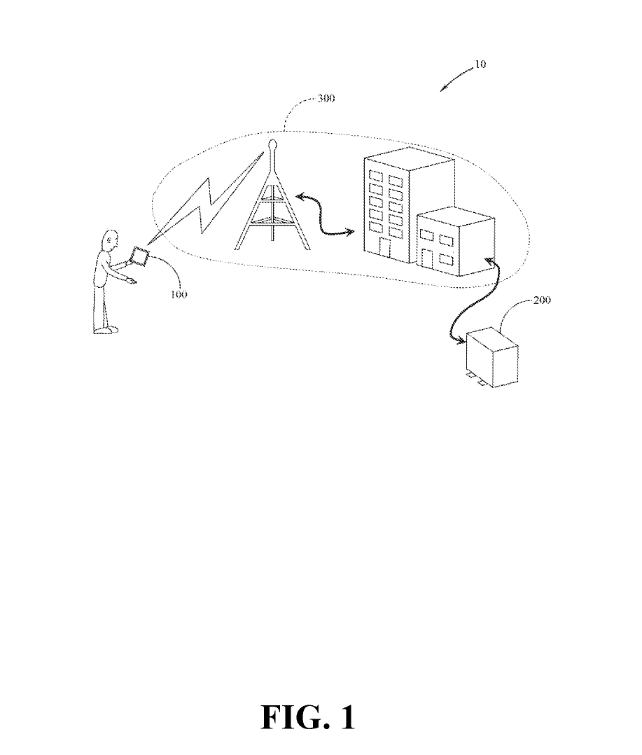

A simplified graphic representation of the disclosed scalable configurable point-of-cyber-access cyber system appears in FIG. 1, wherein an individual is shown using a cyber portal. Through use of the cyber portal, a cyber interaction from the individual gains access to, and is transferred through, the cyber communications network, and to one of the individual's at least one point of cyber access computers. There, the individual's identity may be properly established prior to the individual's cyber interaction gaining further access to the individual's point of cyber access computer. After having gained access to one of the individual's at least one point of cyber access computers, the individual, through the individual's cyber interactions with the cyber portal, may engage in at least one activity selected from the group consisting of: (a) private cyber activities, and (b) public cyber activities. Private cyber activities may be configured to be for the individual's use only. Public cyber activities involve at least one other party. By use of a properly configured version of the disclosed scalable configurable point-of-cyber-access cyber system, the individual may have complete access control over cyber interactions from other parties. Further, utilizing a properly configured version of the disclosed scalable configurable point-of-cyber-access cyber system, the individual may have complete control over the selected cyber resources that the individual makes available to share with selected other parties. When utilizing a properly configured version of the disclosed scalable configurable point-of-cyber-access cyber system, interoperability resources may enable interactions with, at least one cyber device.

A preferred embodiment of the disclosed scalable configurable point-of-cyber-access cyber system may be configured to require that each individual be properly identified prior to at least one step that the individual's cyber interactions carry out throughout the scalable configurable point-of-cyber-access cyber system. The disclosed scalable configurable point-of-cyber-access cyber system may further be configured to require that each cyber device be properly identified prior to at least one step that the cyber device's cyber interactions carry out throughout the point-of-cyber-access cyber system. Continuous identification of each individual and each cyber device may provide a safe, secure cyber environment for all that use at least one properly configured versions of the scalable configurable point-of-cyber-access cyber system. Continuous utilization of these identification requirements for all individuals and for all cyber devices may be necessary to enable the disclosed scalable configurable point-of-cyber-access cyber system to provide every individual with the ability to have a full range of cyber personal rights as well as a full range of cyber property rights.

A preferred non-limiting embodiment of the disclosed scalable configurable point-of-cyber-access cyber system provides at least one point of cyber access computer where a properly identified individual may gain access to at least one member selected from the group consisting of: (a) cyber interactions, (b) cyber communications, (c) the individual's cyber assets, and (d) the individual's cyber resources. An individual may enjoy significant security, privacy, and utility advantages over prior art cyber systems and prior art communications systems through the individual's use of at least one point of cyber access computer which provides for safe and secure access to at least one member selected from the group consisting of: (a) at least one cyber interaction, (b) at least one cyber communication, (c) at least one cyber activity, (d) at least one of the individual's cyber assets, and (e) at least one of the individual's cyber resources.

In a preferred non-limiting embodiment, the scalable configurable point-of-cyber-access cyber system disclosed herein may be configured to include a standard set of cyber processes and cyber procedures for interconnected cyber interactions with cyber devices. This feature of the scalable configurable point-of-cyber-access cyber system may provide at least one device or at least one cyber device with the ability to easily be configured to be used as a component of the scalable configurable point-of-cyber-access cyber system.

The architectures, devices, processes, and procedures of the scalable configurable point-of-cyber-access cyber system may be configured to provide a private, safe, secure cyber system for use by an individual. The provision of a private, safe, secure cyber system for an individual's cyber activities is essential in order for cyber personal rights, cyber property rights, and cyber privacy rights to be provided for the individual.

As compared to prior art cyber systems, where most computer programs use their own unique processes, procedures, and programming, in a preferred embodiment, the scalable configurable point-of-cyber-access cyber system of the present disclosure may be configured to provide all parties with the use of standard scalable configurable point-of-cyber-access cyber system processes, procedures, and programming to utilize as a part of their computer programs. The other parties' use of standard scalable configurable point-of-cyber-access cyber system processes, procedures, and programming may provide enormous advantages over the use of the processes, procedures, and programming of prior art systems in the areas of cyber system security, cyber system safety, cyber system interoperability, cyber system interconnectivity, and overall cyber system simplicity.

Through an individual's exclusive use of the individual's private computer that is properly configured to work in conjunction with the individual's point of cyber access computer, the disclosed scalable configurable point-of-cyber-access cyber system may provide the individual with the ability to safely, securely, and privately store, access, modify, use, share, and manage the individual's cyber-based information, the individual's file-based cyber assets, and the individual's file-based cyber resources. This use of the individual's properly configured private computer may create a cyber environment where cyber-based information, file-based cyber assets, and file-based cyber resources of the individual may be absolutely safe, secure, and at only the individual's control.

The disclosed scalable configurable point-of-cyber-access cyber system may be configured to enable an individual to selectively, safely, securely, and privately share at least one part of, the individual's cyber-based information, cyber assets, or cyber resources, with at least one selected other party. Utilization of features of at least one possible configuration of the scalable configurable point-of-cyber-access cyber system may provide an individual with the ability to have full control over access by other parties to at least one part of, the individual's cyber-based information, the individual's cyber assets, and the individual's cyber resources.

The scalable configurable point-of-cyber-access cyber system may be configured to require that cyber interactions be sent to a recipient as pre-processed content. This may drastically reduce the recipient's need for inbound content processing resources or cyber communications network resources that are used for the transfer of interconnected cyber activities and cyber interactions.

The disclosed scalable configurable point-of-cyber-access cyber system's use of pre-processed image-based cyber interactions may eliminate the recipient's risk of receiving malicious content in a cyber file that would need to be processed into ready to use content by the recipient.

The disclosed scalable configurable point-of-cyber-access cyber system may include at least one thin cyber portal for use by at least one individual. A thin cyber portal provides an individual with the ability to gain safe and secure remote access to at least one of the individual's at least one point of cyber access computers. The individual's at least one point of cyber access computer may be configured to where, after having been properly identified, the individual may gain further access to the individual's cyber assets and cyber resources such as the individual's cyber telephone system, the individual's cyber interactions with others, and the individual's cyber interactions with the individual's cyber assets and cyber resources. The thin cyber portal may be used to provide the individual with interconnected cyber interactions with the individual's remote point of cyber access computer.

The thin cyber portal may be configured to provide maximum utility and mobility for the individual's use of the scalable configurable point-of-cyber-access cyber system. This is because the thin cyber portal may be configured to provide the individual with the ability to locally or remotely gain safe, secure, and private access to at least one device selected from the group consisting of: (a) the individual's point of cyber access computer, (b) the individual's private computer, (c) the individual's public computer, (d) the individual's device-based cyber assets, and (e) device-based cyber resources that are available for use by the individual. Furthermore, the thin cyber portal may be configured to provide for the use of the minimum possible amount of physical componentry at the location of the individual.

The disclosed scalable configurable point-of-cyber-access cyber system may be scaled and configured to provide for a complete and full-featured cyber system that is nonetheless far less complex than prior art systems. This alters the need found in prior art systems for more computer processing capabilities for use with future cyber system enhancements and improvements. Use of the disclosed scalable configurable point-of-cyber-access cyber system may eliminate the need for development of bigger, better, faster, and more capable cyber processors. Encryption is the backbone of prior art cyber security. This is important because bigger, better, faster, more capable cyber processors may eventually have capabilities to regularly decrypt encrypted cyber files, thereby overcoming encryption-based prior art cyber security and cyber privacy measures.

The scalable configurable universal operating system derived ability to convert cyber content or cyber interactions to, and from, a scalable configurable universal operating system standard format provides any cyber device, cyber content, cyber interaction, or cyber activity that does not use the scalable configurable universal operating system with the interoperable ability to interact with an individual at a cyber portal, or to interact with, or be utilized by, at least one cyber device that uses the scalable configurable universal operating system.

As an example, the cyber processes and cyber procedures of the scalable configurable universal operating system, through use of captured video images, may translate a very old and generally obsolete form of communication (such as, for example, Native American Indian smoke signals) into text messages, voice messages, system commands, or cyber files.

As a further example, digital photos that were stored in cyber files using a prior art format from the late 1980's may be converted for interoperable use by the scalable configurable universal operating system component of the scalable configurable point-of-cyber-access cyber system. Therefore, the digital photos in a late 1980's cyber format may be used by an individual as long as the scalable configurable universal operating system component of the scalable configurable point-of-cyber-access cyber system is available for use by the individual.

### (5) Expanded Overview

In a preferred, non-limiting embodiment, the scalable configurable point-of-cyber-access cyber system disclosed herein is a scalable configurable combination of processes, procedures, programs, system architecture, device architecture, and cyber devices that together may be scaled and configured to provide a safe and secure cyber environment for at least one individual. In this environment, an individual may have interoperable access to at least one desired and available cyber function. In addition, the disclosed scalable configurable point-of-cyber-access cyber system may be configured to provide the individual with complete cyber privacy for the individual's personal and private cyber activities. Also, the disclosed scalable configurable point-of-cyber-access cyber system may be configured to provide the individual with varying levels of cyber privacy as specified by the individual for the individual's public cyber activities.

As shown in FIG. 1, one possible configuration of the scalable configurable point-of-cyber-access cyber system 10 includes three primary components. These primary components are: (a) at least one cyber portal 100, (b) at least one point of cyber access computer 200, and (c) at least one cyber communications network 300.

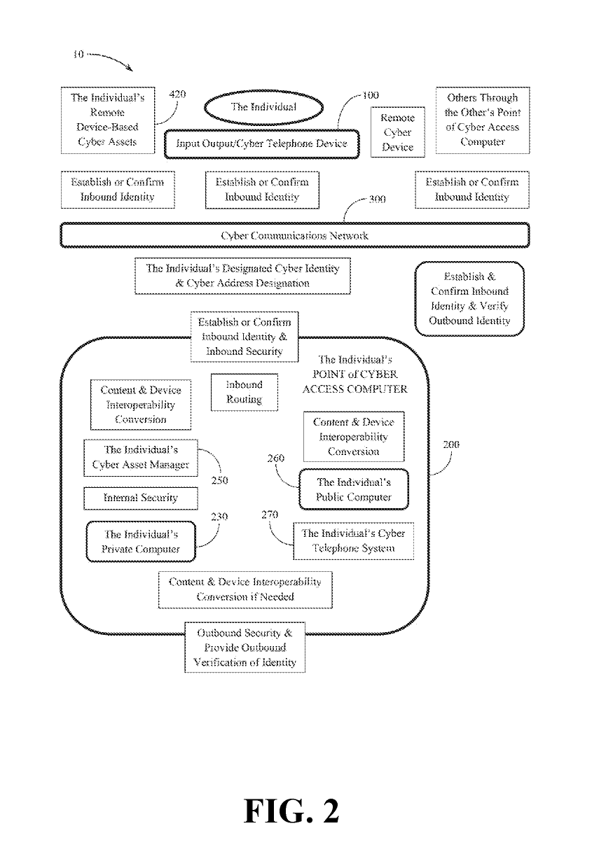

The architecture of the scalable configurable point-of-cyber-access cyber system 10 shown in FIG. 2 is configured to provide a simple, concise, safe, and secure array of efficient paths for cyber interactions among at least two members selected from the group consisting of: (a) at least one individual, (b) at least one cyber asset, (c) at least one cyber resource, and (d) at least one other party.

Significant cyber device architectural features and system architectural features that may be used to make up the scalable configurable point-of-cyber-access cyber system 10 include:

(a) integration of an individual's private and public interconnected cyber activities into one safe and secure system;

(b) integration of an individual's private and public cyber activities and cyber interactions into the operations of one configuration of a point of cyber access computer 200; and

(c) at least one point of cyber access computer 200.

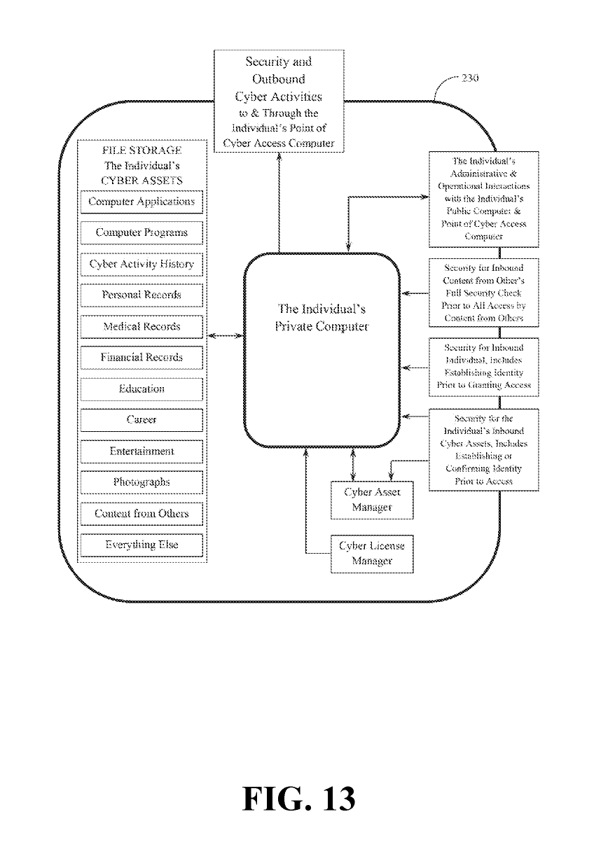

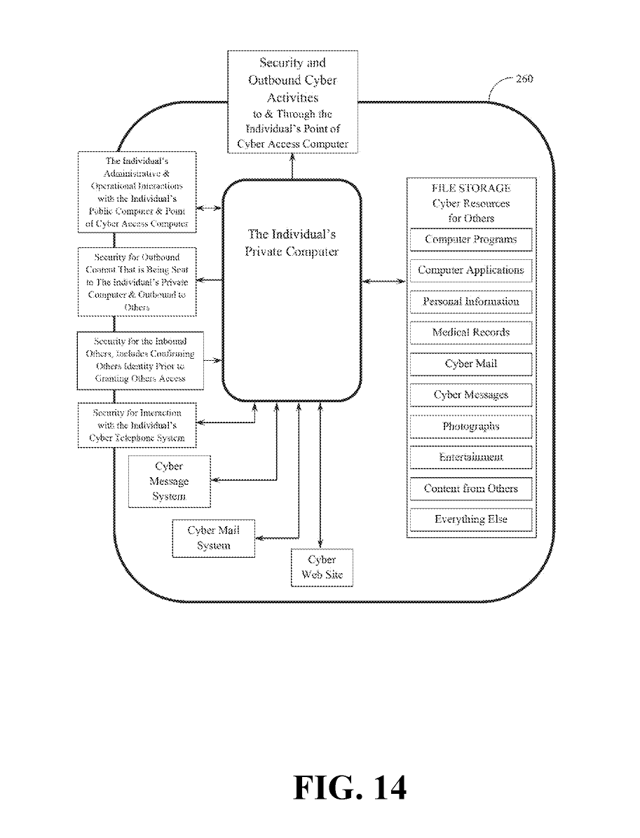

A still better understanding of the systems and devices disclosed herein may be gained by appreciating that the individual's at least one point of cyber access computer may be configured to work in conjunction with at least one separate private computer 230 shown in more detail in FIG. 13 or at least one separate public computer 260 (shown in more detail in FIG. 14). The individual's at least one point of cyber access computer may be configured to properly identify the individual, other parties, and cyber devices prior to providing the individual, selected other parties, and selected cyber devices further access to the individual's point of cyber access computer. The individual's at least one point of cyber access computer may also be configured to provide routing and security between the individual's point of cyber access computer and the individual's private computer or the individual's public computer.

At least one separate private computer 230 may be configured to provide separate unique and different processing and support for a combination of the individual's private cyber activities, the individual's private cyber assets, and the individual's private cyber resources.

At least one separate public computer 260 may be configured to provide separate, unique and different processing and support for a combination of the individual's public cyber activities, the individual's publicly available cyber assets, and the individual's publicly available cyber resources.

The individual's at least one separate private computer 230 may also be configured to serve as a cyber vault. By functioning as a cyber vault, the individual's at least one private computer 230 may provide the individual with safety, security, and privacy for: (a) the individual's personal and private cyber activities, (b) the individual's private cyber assets, and (c) the individual's private cyber resources that are within the constructs of the properly configured cyber vault.

The individual's at least one public computer 260 may be configured to provide for cyber interactions between the individual and at least one other party.

As shown in FIGS. 1 and 2, the scalable configurable point-of-cyber-access cyber system 10 may be scaled and configured to include at least one secure thin cyber portal 100. A thin cyber portal 100 may provide for remote cyber interactions between an individual and the individual's at least one point of cyber access computer 200.

The scalable configurable point-of-cyber-access cyber system 10 may provide for storage of the entire collection of an individual's file-based cyber assets.

The primary processes, procedures, and programs that may be utilized to make up at least one configuration of a preferred non-limiting embodiment of the scalable configurable point-of-cyber-access cyber system 10 are:

(a) system-wide use of processes or procedures that identify each cyber device and each individual that is interacting with the disclosed scalable configurable point-of-cyber-access cyber system;

(b) a system-wide requirement that each individual using the disclosed scalable configurable point-of-cyber-access cyber system be properly identified prior to each step that the cyber interactions of the individual carry out throughout the scalable configurable point-of-cyber-access cyber system;

(c) a system-wide requirement that each cyber device that is a part of the disclosed scalable configurable point-of-cyber-access cyber system be properly identified prior to each step that each cyber interaction of each cyber device carry out throughout the scalable configurable point-of-cyber-access cyber system;

(d) at least one scalable configurable universal operating system;

(e) processes or procedures for creating or using interactive cyber content;

(f) processes or procedures for providing cyber content interoperability by translating cyber content to and from a scalable configurable point-of-cyber-access cyber system standard cyber content format;

(g) processes or procedures that provide for a sender to send only pre-processed image-based cyber content to a recipient;

(h) interoperability processes or procedures that translate cyber interactions or cyber content to or from at least one scalable configurable point-of-cyber-access cyber system standard format;

(i) separate processing or support by a separate private computer for the private cyber activities of an individual, and separate and different processing or support by a separate public computer for public cyber activities of the individual;

(j) processes or procedures that exclude cyber interactions from all other parties and cyber interactions from the cyber devices of all other parties from gaining access to the individual's at least one private computer;

(k) processes or procedures that may provide an individual with exclusive and complete administrative control, operational control, or access control of at least one member selected from the group consisting of: (i) the individual's at least one point of cyber access computer, (ii) the individual's at least one public computer, (iii) the individual's at least one private computer, (iv) the individual's at least one device-based cyber asset, and (v) the individual's at least one device-based cyber resource; and

(vi) processes or procedures for enabling an individual to selectively grant or selectively deny at least one specified other party access to at least one part of at least one member selected from the group consisting of: (i) the individual's at least one point of cyber access computer, (ii) the individual's at least one cyber telephone system, (iii) the individual's at least one public computer, (iv) the individual's at least one cyber asset, and (v) the individual's at least one cyber resource.

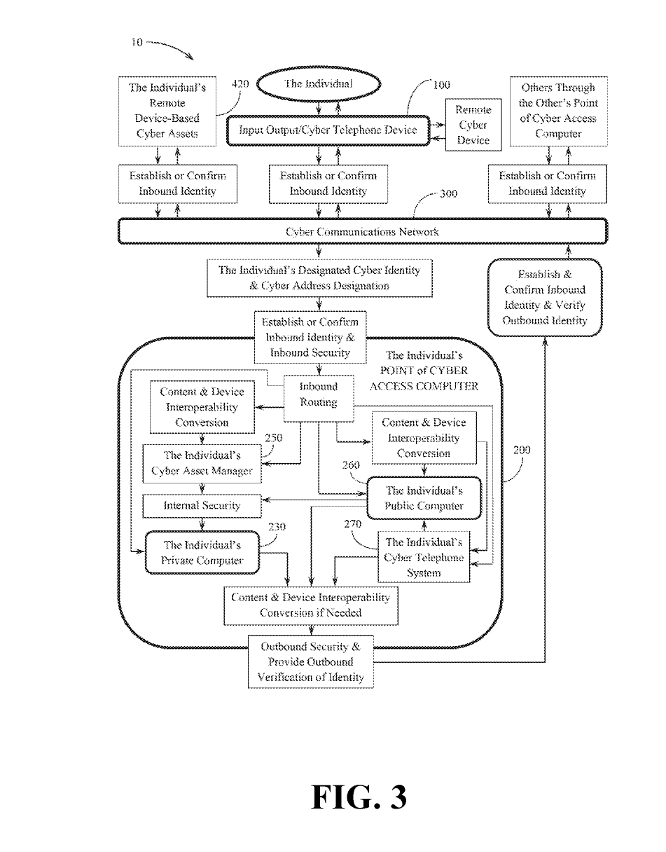

The foundation for at least one safe, secure, and private configuration of the disclosed scalable configurable point-of-cyber-access cyber system 10, as shown in FIG. 3, is the requirement that each individual and each cyber device be properly identified prior to each step their cyber interactions take throughout the scalable configurable point-of-cyber-access cyber system.

This foundational requirement for proper identification of the individual, other parties, and every cyber device may be used to provide a safe and secure cyber environment that provides a level of cyber safety, cyber security, and cyber privacy that far exceeds what may be found in prior art cyber systems. This foundational requirement also establishes a framework that supports cyber personal rights, cyber privacy rights, and cyber property rights for every individual.

The scalable configurable point-of-cyber-access cyber system provides an individual with only one unique lifelong scalable configurable point-of-cyber-access cyber system identity designation. This unique lifelong scalable configurable point-of-cyber-access cyber system identity designation, when combined with the scalable configurable point-of-cyber-access cyber system address designation of at least one point of cyber access computer 200 of the individual, provides all that others need to know to contact the individual for at least one cyber interaction or at least one cyber activity.

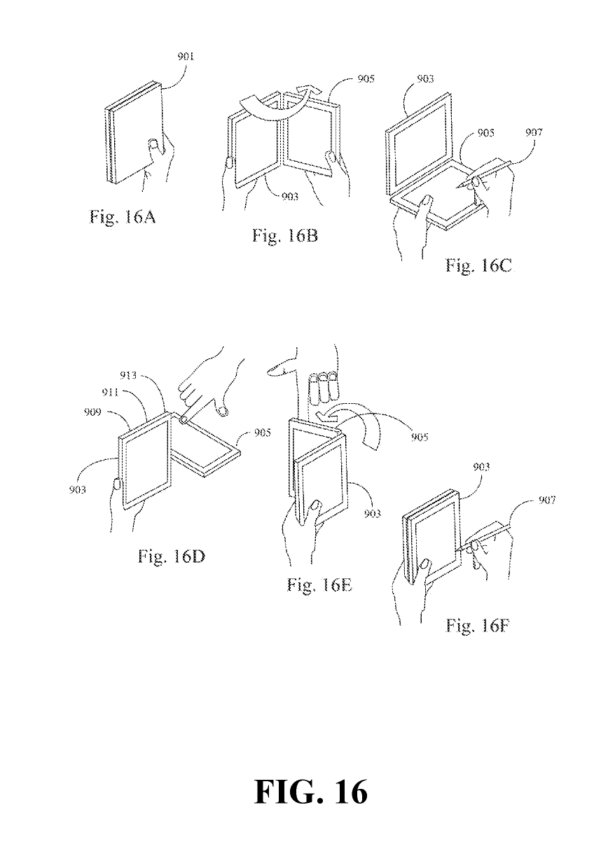

As shown in FIG. 1, the scalable configurable point-of-cyber-access cyber system 10 also includes at least one cyber portal 100. A cyber portal 100 may be configured to provide an individual with the ability to use the cyber portal 100 for secure remote cyber interactions with the individual's point of cyber access computer 200. An example of a group of embodiments of a cyber portal 100 appears in FIGS. 16A-16F.

As shown in FIG. 16B, for example, the cyber portal 901 may include two screens 903 and 905 hinged together like a book. As shown in FIG. 16C, a stylus 907 may be used by the individual for input interaction with one or both image display screens 901 of the cyber portal. Further adaptability of the cyber portal appears in FIG. 16D, where screen 905 may be rotated with respect to screen 903. Once rotated, screens 903 and 905 may be folded back together as shown in FIG. 16E. When folded together as in FIG. 16F, the individual may again use a stylus 907 to interact with the one accessible image display screen of the cyber portal 901. Each configuration of the cyber portal 901 provides at least one different functionality to the individual.

Those skilled in the art will appreciate that the cyber portal 901 shown in FIGS. 16A-16F is but one of many different types of devices that may serve as a cyber portal 100 that may be used as a component in the scalable configurable point-of-cyber-access cyber system 10 disclosed herein.

As shown in FIG. 3, an individual, through use of a cyber portal 100, communicates information derived from sensor observations to the individual's point of cyber access computer 200. This communication first enables the individual's point of cyber access computer 200 to establish the individual's identity. After the individual's identity has been established by the individual's point of cyber access computer 200, the individual's point of cyber access computer may further be configured to provide the individual with access to at least one cyber asset or at least one cyber resource that is available to the individual through the individual's point of cyber access computer 200.

Once the individual's identity has been established by the individual's point of cyber access computer 200, the individual's point of cyber access computer 200 may be configured to provide the individual with an array of functionalities including, but not limited to, at least one member selected from the group consisting of: (a) computing capabilities, (b) computer programs, (c) computer applications, (d) cyber telephone services, (e) cyber video telephone services, (f) cyber messaging services, (g) cyber mail services, (h) cyber television, (i) cyber video entertainment, (j) cyber radio, (k) cyber music, (l) verification of the individual's identity as needed for the individual's public cyber activities, (m) cyber interactions with the individual's cyber assets, (n) cyber interactions with other parties, and (o) cyber interactions with the cyber resources of other parties. Further, the individual may be provided with the option to have exclusive control of at least one function of at least one cyber asset of the individual. This at least one function may be selected from the group consisting of: (i) operational functions, (ii) system access functions, (iii) systems management functions, and (iv) systems configuration functions.

A point of cyber access computer 200 may be configured to work in conjunction with at least one of two additional and separate types of computers, each providing for separate and different areas of operation, namely:

(a) an individual's private computer 230, and

(b) an individual's public computer.

One particular, non-limiting embodiment of a possible configuration of an individual's private computer 230 is shown schematically in FIG. 13. The particular embodiment depicted therein may be configured to only be accessed by the cyber interactions of the individual or the cyber interactions of the individual's selected device-based cyber assets or selected device-based cyber resources.

One particular embodiment of a possible configuration of an individual's public computer 260 is shown schematically in FIG. 14. The particular embodiment depicted therein may be configured to provide at least one specified properly identified other party or at least one specified properly identified cyber device with access to at least one specified cyber resource that has been made available to the at least one specified other party or the at least one specified cyber device by the individual.

A private computer 230 that works in conjunction with the individual's point of cyber access computer 200 may be configured to establish a new dimension for an individual's cyber activities. This new dimension is a high level of privacy, safety, and security that is not provided by prior art systems.

An individual's private computer may be configured to where only the cyber interactions of the individual or the cyber interactions of the individual's selected device-based cyber assets or the individual's selected device-based cyber resources may gain access to the individual's private computer 230. Only after the individual's point of cyber access computer 200 has established the individual's identity, or the identity of the individual's specified device-based cyber assets, or the identity of the individual's specified device based cyber resources, will each be granted access to the individual's private computer 230. The individual's private computer 230 may be configured to deny access thereto by cyber interactions of all other parties. This feature of the scalable configurable point-of-cyber-access cyber system 10 may provide the individual with absolute privacy, safety, and security for the individual's cyber activities that occur within the individual's private computer 230.

An individual's at least one point of cyber access computer 200 may contain the entire collection of the individual's file-based cyber assets or file-based cyber resources.

Through use of one of an individual's at least one properly configured private computers 230, the individual may have access to at least one member selected from the group consisting of: (a) computing capabilities, (b) computer programs, (c) computer applications, (d) cyber telephone services, (e) cyber video telephone services, (f) cyber messaging services, (g) cyber mail services, (h) cyber television, (i) cyber video entertainment, (j) cyber radio, (k) cyber music, (l) cyber interactions with available cyber resources of other parties, and (m) at least one cyber interaction or cyber service of at least one other type. Further, through the individual's use of the individual's own properly configured at least one private computer 230, the individual may be provided with the option to have exclusive operational control of at least one: (i) system management function, (ii) system configuration function, and (iii) system access function. Any of the foregoing functions may be functions of: (A) the individual's at least one point of cyber access computer, (B) the individual's at least one private computer, and (C) the individual's at least one public computer. The individual may also be provided with operational control of the access control functions of the individual's at least one cyber asset or cyber device manager.

An individual's cyber assets include all of the individual's own cyber devices, programs, applications, processes, procedures, and files that use non-biological processing of programming in any way.

Cyber assets are the property of an individual. An individual may share at least one part of the individual's cyber assets with at least one specified other party. When the individual makes copies of the individual's file-based cyber assets available for specified other parties, such copies may be made available through the individual's at least one public computer 260. Copies of the individual's cyber assets that are made available to specified other parties are considered to be the cyber resources of the specified other parties.

An individual's file-based cyber assets may include, but are not limited to, at least one member selected from the group consisting of: (a) personal records, (b) financial records, (c) health records, (d) cyber historical records, (e) photographs, (f) cyber books, (g) cyber magazines, (h) music, (i) videos, (j) computer programs, (k) computer applications, and (l) cyber files of any other types.

An individual's device-based cyber assets, at a minimum, consist of the individual's point of cyber access computer 200. The individual's device-based cyber assets may also include at least one member selected from the group consisting of: (a) at least one cyber portal, (b) at least one private computer, (c) at least one public computer, (d) at least one audio output/image display device, (e) at least one cyber telephone device, (f) at least one health monitoring device, (g) at least one vehicle, (h) at least one cyber file backup or restore, device, (i) at least one video camera, (j) at least one home or office cyber automation device that may control or monitor lights, locks, security systems, thermostats, refrigerators, lawn sprinkler systems, water heater operations, water or electric consumptions, garage door openers, dog doors, printers, private weather stations, etc., (k) at least one global position locating device, (l) at least one robot, and (m) at least one other device-based cyber asset that an individual may interact with.

As shown in FIG. 3, an individual's private computer 230 may be configured to allow security processes or procedures to be used for all inbound cyber activities, for all inbound cyber interactions, and for all inbound cyber content that is transferred to the individual's private computer 230 from the individual's point of cyber access computer 200, or from the individual's public computer 260.

As also shown in FIG. 3, the individual's public computer 260 may be configured to be used as the individual's point of access to: (a) cyber activities, (b) cyber interactions, and (c) the transfer of cyber content to and from other parties.

An individual's point of cyber access computer 200 may be configured to provide verification of the individual's identity for at least one of the individual's outbound cyber activities, or for at least one of the individual's outbound cyber interactions.

The scalable configurable point-of-cyber-access cyber system may be configured to mandate that the device within the cyber communications network that comes into first contact with a sender's point of cyber access computer must establish the identity of the sender's point of cyber access computer and also establish the identity of the cyber portal that is being used by the sender, prior to granting further access to the sender's cyber interactions. The device within the cyber communications network 300 that comes into first contact with cyber interactions from the sender's point of cyber access computer may subsequently be required to provide verification of the identity of the sender's point of cyber access computer 200 prior to at least one step that the sender's cyber interactions take throughout the scalable configurable point-of-cyber-access cyber system 10.

An individual's point of cyber access computer 200 may be configured to require that it has received verification of the identity of another party prior to allowing cyber interactions from the other party to gain further access to the individual's point of cyber access computer 200. The individual's point of cyber access computer 200 may then be configured to require that it confirms the other party's verified identity. The individual's point of cyber access computer 200 may be further configured such that once the verified identity of a specified other party has been confirmed, the cyber interaction from the specified other party may then be granted specified access to the individual's point of cyber access computer 200.

Other parties may gain access to an individual's point of cyber access computer 200 or to an individual's public computer 260 for the purposes of cyber activities and cyber interactions.

An individual may have the ability, through use of the access and management functions of the individual's at least one properly configured private computer 260, to specify to whom the individual grants or denies access to at least one member selected from the group consisting of:

(a) the individual's at least one point of cyber access computer 200;

(b) the individual's at least one cyber telephone system 270;

(c) the individual's at least one public computer 260; and

(d) the individual's at least one private computer.

Further, the individual may grant or deny each specified other party access to at least one part of the cyber resources that the individual makes available to specified other parties through the specified other parties' cyber interactions with the individual's at least one properly configured public computer 260.

Other parties that are granted access to at least one member selected from the group consisting of: (a) at least one part of an individual's cyber resources (b) the individual's at least one cyber telephone system 270, and (c) the individual's at least one public computer 260, may only request a response from at least one member selected from the group consisting of: (i) the individual, (ii) the individual's at least one point of cyber access computer 200, (iii) the individual's at least one public computer 260, (iv) the individual's at least one cyber telephone system, and (v) the individual's at least one private computer 230.

Other parties may be excluded from gaining operational access or administrative control of an individual's cyber resources. Further, other parties may be excluded from gaining operational access or administrative control of at least one part of the individual's at least one public computer 260.

Cyber interactions from an individual's point of cyber access computer 200 to a cyber portal 100 that is being used by an individual as shown in FIG. 3 may be pre-processed as image-based or audio-based content prior to being sent as opposed to being sent as cyber interaction files that will need to be processed into image-based or audio-based content by the cyber portal.

A recipient may respond to an interaction received from a sender, and formatted by the point-of-cyber-access cyber system of the sender, by communicating to the sender:

(a) the recipient's specific cyber interaction;

(b) the specific point on the specific image or soundtrack where the recipient's cyber interaction was made; and

(c) the identification of the sender's specific content that was perceived by the recipient at the point in time when the recipient's cyber interaction was made.

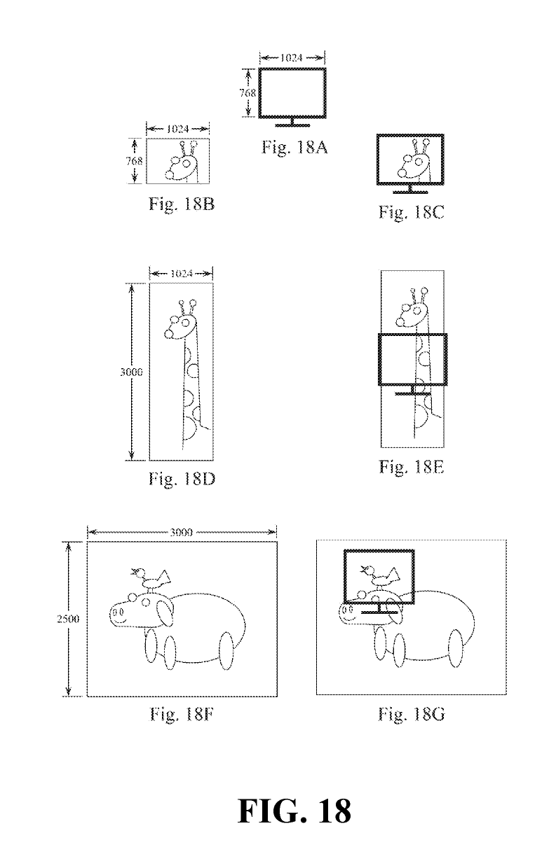

Embodiments of the systems and processes disclosed herein may provide or utilize a frames and scrolls format or system for image-based cyber content. Using the frames and scrolls format or system, as shown in greater detail in the array of images in FIGS. 18A-18G for image-based content, a recipient may respond to a cyber interaction from the sender by communicating the recipient's specific input, at the specific point on the specific image that the recipient perceived.

For example, FIG. 18A depicts a screen that is similar to screens 903 and 905 shown in FIGS. 16A-16 F. The size of the screen is 1024 pixels wide by 768 pixels high. An image having a dimension larger than 1024 pixels wide×768 pixels high, such as the 1024 pixels wide by 3000 pixels high image shown in FIG. 18D, will not appear in its entirety on a 1024 pixels wide×768 pixels high image display screen. Rather, only a portion of the image shown in FIG. 18D will appear at one time on a screen such as shown in FIG. 18E or in FIG. 18G using the disclosed frames and scrolls format or system. As shown in FIGS. 18E and 18G, the disclosed scrolls format may be used when one or both of the two image dimensions are larger than what may be presented at one time on an image display screen.

As shown in FIG. 3, an individual's point of cyber access computer 200 may also include at least one cyber telephone system 270. The at least one cyber telephone system 270 may provide for all aspects of the individual's needs or desires for cyber telephone services. The individual's at least one cyber telephone system 270 may be configured to perform at least one of the following steps:

(a) provide at least one historical record of at least one cyber telephone system activity;

(b) grant or deny at least one other party access to: (i) cyber telephone communication interactions with the individual, and (ii) at least one resource of the individual's at least one cyber telephone system;

(c) route cyber telephone communications interactions and related cyber alerts, to a cyber portal/cyber telephone device that is on, or near, the individual, or that is specified for use as a cyber telephone contact device by the individual;

(d) record messages from inbound cyber telephone communications interactions;

(e) deliver messages to specified others; and

(f) provide at least one other cyber telephone service or function that is needed, or desired, by the individual.

A key security feature of a preferred, non-limiting embodiment of the disclosed scalable configurable point-of-cyber-access cyber system 10 is that it may be configured to have differences among at least one member selected from the group consisting of: (a) operations, (b) processes, (c) code, (d) transfer packets, and (e) formats, that are utilized for at least one member selected from the group consisting of: (i) cyber interactions, (ii) cyber telephone communications, (iii) cyber mail, (iv) cyber messages, (v) cyber television, (vi) cyber video entertainment, (vii) cyber music, (viii) file transfers, (ix) computer programs, (x) computer applications, (xi) operational controls, and (xii) at least one other required, or desired, function. The reason for the use of differences among operations, processes, code, transfer packets, or formats, is: (i) to provide for security between different processes, (ii) to assure proper routing, and (iii) to assure that cyber interaction for one specific purpose cannot or will not be used for a different purpose.

A cyber communications network 300 that is utilized by at least one cyber system may be configured to require that an individual be properly identified prior to at least one step, or prior to each step that the individual's cyber interactions carry out throughout the cyber communications network 300.

A cyber communications network that is utilized by at least one cyber system may be configured to require that each cyber device be properly identified prior to at least one step, or prior to each step that the interactions of the cyber device take throughout the cyber communications network 300.

The scalable configurable point-of-cyber-access cyber system 10 may require at least one cyber activity to be properly formatted. Further, the scalable configurable point-of-cyber-access cyber system 10 may require that at least one cyber activity keep a historical record of at least one step, or of each step, that the at least one cyber activity carries out throughout the at least one cyber communications network 300, or throughout the scalable configurable point-of-cyber-access cyber system 10.

The scalable configurable point-of-cyber-access cyber system 10 may include policies, procedures, and devices that may be used for cyber interaction among: (a) an individual, (b) the individual's at least one point of cyber access computer 200, (c) the individual's at least one private computer 230, and (d) the individual's at least one device-based cyber asset 420 (see FIG. 2). These policies, procedures, and devices may be configured to provide for safe and secure cyber interactions between the individual's at least one device-based cyber asset 420 and the individual or the individual's at least one private computer 230 or the individual's at least one point of cyber access computer 200. In addition, these policies, procedures, and devices may be configured to exclude all other parties from gaining access to at least one part of the individual's cyber assets or cyber resources.

Another key feature of the disclosed scalable configurable point-of-cyber-access cyber system 10 is that it may be configured to include utilization of at least one scalable configurable universal operating system. The scalable configurable universal operating system provides programming that provides or enables processes and procedures. The processes and procedures may be configured to provide an interoperable interconnected cyber system. Within that cyber system at least one cyber device may use the safety and security of properly configured scalable configurable point-of-cyber-access cyber system components for safe, secure and private interconnected cyber interactions or cyber activities.

The systems and methodologies disclosed herein are preferably agnostic to the operating system used by a sender of a cyber interaction, or the operating system used by the recipient of a cyber interaction, as long as the cyber interaction between the sender and the recipient use the interoperability processes or procedures of the scalable configurable universal operating system of the disclosed cyber system for interoperable interconnected interactions.

The scalable configurable universal operating system that may be utilized as a part of the disclosed scalable configurable point-of-cyber-access cyber system has interoperability processes that translate cyber interactions, cyber activities, and cyber content to and from standard universal operating system formats.

An individual's at least one point of cyber access computer 200, the individual's at least one private computer 230, and the individual's at least one public computer 260, may each be configured to keep at least one historical record of cyber activities from within the cyber domain of the individual.

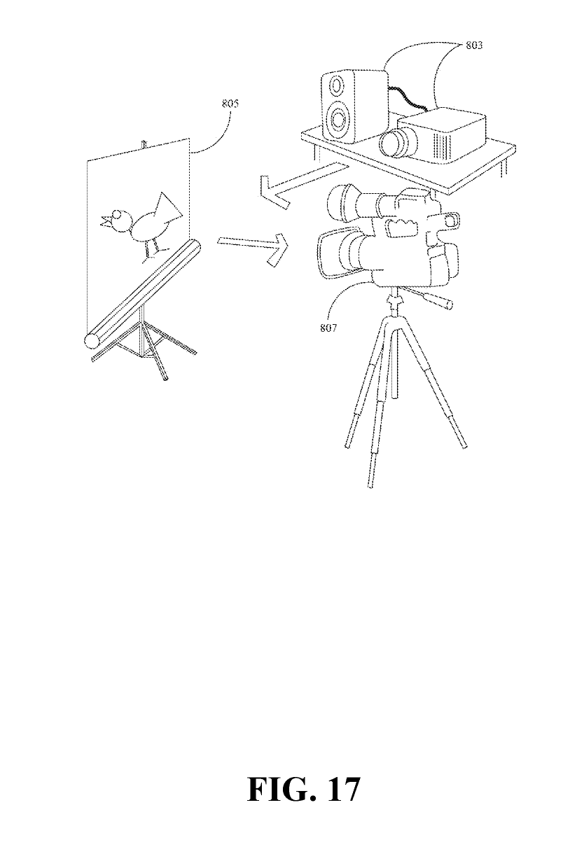

As shown in FIG. 17, the scalable configurable universal operating system may include resource-efficient processes and procedures that use: (a) a virtual equivalent of at least one projector 803, (b) a virtual equivalent of at least one projection display screen 805, and (c) a virtual equivalent of at least one recorder or capture device 807, to perform at least one activity selected from the group consisting of: (i) providing security, (ii) converting cyber content for interoperability, (iii) converting cyber interactions for interoperability, (iv) altering images (v) altering audio, and (vi) converging two or more sources of image-based cyber content into at least one converged source of image-based cyber content.

### (6) Point-of-Cyber-Access Cyber System Architecture

As shown in FIG. 2, the architecture of the disclosed scalable configurable point-of-cyber-access cyber system 10 defines the interrelationship of the components of the disclosed scalable configurable point-of-cyber-access cyber system 10. The architecture of the scalable configurable point-of-cyber-access cyber system 10 also defines the components of the scalable configurable point-of-cyber-access cyber system 10. Specifically, at a minimum, the components of the scalable configurable point-of-cyber-access cyber system 10 include: (a) architectural rules and requirements, (b) system structure, (c) at least one point of cyber access computer 200, (d) at least one cyber portal 100, (e) at least one cyber device, (f) at least one cyber communications network 300, and (g) at least one operating system.

The components of the scalable configurable point-of-cyber-access cyber system 10 may further include at least one member selected from the group consisting of: (a) at least one cyber device manager, 250 (b) at least one cyber telephone system 270, (c) at least one cyber vault, (d) at least one private computer, (e) at least one public computer, (f) at least one cyber rights license system, and (h) at least one other component.

The architecture of the disclosed scalable configurable point-of-cyber-access cyber system 10 may be configured to provide for at least one interconnected cyber system in which: (a) at least one point of cyber access computer 200, (b) at least one cyber portal 100, and (c) at least one cyber device, may have cyber interactions using at least one cyber communications network 300, and all utilizing the at least one operating system.

The device architecture of the disclosed scalable configurable point-of-cyber-access cyber system 10 provides for at least one member selected from the group consisting of: (a) at least one point of cyber access computer 200, (b) at least one private computer 230, (c) at least one public computer 260, and (d) at least one cyber device, to each be at least one member selected from the group consisting of: (i) physical devices, (ii) virtual devices, and (iii) at least one combination thereof

The architecture of the disclosed scalable configurable point-of-cyber-access cyber system 10 provides for at least one member selected from the group consisting of: (a) the addition of, (b) the removal from, (c) the alteration of, and (d) the reconfiguration of, the cyber processes or the cyber procedures of the scalable configurable point-of-cyber-access cyber system 10.

The architecture of the disclosed scalable configurable point-of-cyber-access cyber system 10 provides for at least one member selected from the group consisting of: (a) the addition of, (b) the removal from, (c) the alteration of, and (d) the reconfiguration of, cyber components or cyber devices that are a part of the point-of-cyber-access cyber system 10.

The architecture of the disclosed scalable configurable point-of-cyber-access cyber system 10 includes device architecture. The device architecture, in turn, may provide for at least one member selected from the group consisting of: (a) unique separate and different processing and support be used for: (i) an individual's private cyber activities, (ii) an individual's private cyber assets, and (iii) an individual's private cyber resources, and (b) separate and different unique processing and support be used for: (i) an individual's public cyber activities, (ii) an individual's publicly available cyber assets, and (iii) an individual's publicly available cyber resources.

The device architecture of the disclosed scalable configurable point-of-cyber-access cyber system 10 further provides for at least one point of cyber access computer 200 that may be configured to work in conjunction with two additional separate types of computers. These two types of computers are: (a) a private computer 230, and (b) a public computer 260. At least two of the three foregoing computer types may be integrated into at least one single device, or at least one of the three foregoing computer types, may be a physically separate computer that may also physically be at one or more locations.

The device architecture of the disclosed scalable configurable point-of-cyber-access cyber system 10 provides for at least one member selected from the group consisting of: (a) the addition of, (b) the removal from, (c) the alteration of, and (d) the reconfiguration of, at least one member selected from the group consisting of: (i) the components, (ii) the cyber processes, and (iii) the cyber procedures, of at least one cyber device.

The architecture of the disclosed scalable configurable point-of-cyber-access cyber system 10 preferably provides for the use of at least one system-standard interface or interaction cyber process or cyber procedure. The at least one system-standard interface or interaction cyber process or cyber procedure may be configured to provide a system of cyber interoperability where any cyber device may be seamlessly used as a component of the scalable configurable point-of-cyber-access cyber system 10.

An individual's at least one point of cyber access computer 200 may be configured to establish or confirm the identity of at least one device or at least one person selected from the group consisting of: (a) at least one individual, (b) at least one other party, and (c) at least one cyber device, prior to providing further point of cyber access computer access to at least one cyber interaction from the properly identified individual, other, or cyber device.

The architecture of the disclosed scalable configurable point-of-cyber-access cyber system 10 may be configured to provide for or require the proper identification of each individual prior to at least one step, or prior to each step that the cyber interactions of the individual take throughout the scalable configurable point-of-cyber-access cyber system 10. The architectural rules and regulations may also require properly identifying each cyber device prior to at least one step, or prior to each step that the cyber interactions of the cyber device take throughout the scalable configurable point-of-cyber-access cyber system 10.

The architectural rules and requirements may require that an individual's at least one private computer 230 may only be accessed by cyber interactions from a cyber portal 100 that is being used by the individual, or by cyber interactions from at least one of the individual's selected device-based cyber assets. Further, the architectural rules and requirements may require that the individual's at least one private computer 230 may only be accessed through the individual's point of cyber access computer 200.

The architectural rules and requirements may require that an individual's at least one public computer 260 may only be accessed by cyber interactions from at least one other party that has been selected to be granted access by the individual. Further, the individual's at least one public computer 260 may be configured such that it may only be accessed through use of the individual's at least one point of cyber access computer 200.

The architecture of the disclosed scalable configurable point-of-cyber-access cyber system 10 may provide at least one member selected from the group consisting of:

(a) an interconnected cyber system for use by at least one individual for the at least one individual's cyber interactions or cyber activities;

(b) a system-wide set of standard cyber processes or cyber procedures for requiring that each individual or each cyber device that uses the cyber system be properly identified;

(c) at least one remotely accessible point of cyber access computer for use by at least one individual; and

(d) an individual with the ability to utilize at least one cyber portal to locally or remotely access cyber assets or cyber resources.

### (7) Scalable Configurable Universal Operating System

A scalable configurable universal operating system may be the primary or the only operating system that is used by the components of a scalable configurable point-of-cyber-access cyber system.

The scalable configurable universal operating system may be configured to provide programming that provides processes or procedures that provide a cyber system wherein cyber activities of every type may be integrated into at least one interconnected cyber system. Such cyber systems may use the scalable configurable universal operating system as its primary, or as its only, operating system.

The scalable configurable universal operating system may be configured to provide programming that provides or enables processes or procedures that enable at least one individual to consolidate access to at least one part of the individual's cyber activities into at least one safe and secure remotely accessible device. The at least one safe and secure remotely accessible device may include the individual's at least one point of cyber access computer.

The scalable configurable universal operating system may be configured to provide programming that provides or enables the processes or procedures that provide a cyber system where cyber activities and cyber devices of every type may be accessed and used by at least one individual through the at least one individual's use of at least one cyber portal that works in conjunction with the individual's at least one point of cyber access computer.

The scalable configurable universal operating system may be configured to minimize the number of same operational processes or procedures that are used by others. This minimization of the number of same operational processes or procedures may be accomplished by providing or requiring the use of system-standard operational processes or procedures.

The scalable configurable universal operating system may be configured to provide programming for device operating systems for at least one member selected from the group consisting of:

(a) point of cyber access computers;

(b) private computers;

(c) public computers;

(d) cyber portals;

(e) cyber telephone devices;

(f) cyber communications network devices;

(g) cyber device managers; and

(h) at least one other device that requires the use of an operating system.

The scalable configurable universal operating system may be configured to provide programming that provides or enables the processes or procedures that assure that each individual is properly identified prior to at least one step, or prior to each step that the cyber interactions of that individual take throughout a cyber system. The processes and procedures requiring proper identification may further assure that each cyber device is properly identified prior to at least one step, or prior to each step that the cyber device's cyber interactions take throughout a cyber system.

The scalable configurable universal operating system may be configured to provide programming that provides or enables the processes or procedures that enable at least one cyber device to perform at least one member selected from the group consisting of: (a) establishing the identity of, (b) confirming the identity of, and (c) providing verification of the identity of, at least one individual, or of at least one cyber device.

The scalable configurable universal operating system may be configured to provide programming that provides or enables the processes or procedures that provide a safe and secure cyber system. Within this safe and secure cyber system at least one cyber device that is a component of the cyber system may properly identify at least one individual or at least one other cyber device prior to having further cyber interactions with the properly identified individual or the properly identified cyber device.

The scalable configurable universal operating system may be configured to provide programming that provides or enables processes or procedures for establishing the identity of at least one individual. These processes or procedures may be utilized by at least one point of cyber access computer or by at least one cyber device.

The scalable configurable universal operating system may be configured to provide programming that provides or enables processes or procedures that enable an individual's at least one point of cyber access computer to establish the individual's identity prior to granting further access to cyber interactions from the cyber portal that is being used by the individual.

The scalable configurable universal operating system may be configured to provide programming that provides or enables processes or procedures that require or provide for an individual's at least one point of cyber access computer to provide at least one other party or at least one cyber device with verification of the individual's identity. Such verifications may occur prior to at least one step, or prior to each step that the individual's cyber interactions take throughout a cyber system.

The scalable configurable universal operating system may be configured to provide programming that provides or enables processes or procedures that require an individual's point of cyber access computer to establish the identity of the individual's at least one device-based cyber asset, and for the individual's at least one device-based cyber asset to establish the identity of the individual's at least one point of cyber access computer, prior to further cyber interaction between the individual's at least one point of cyber access computer and the individual's at least one device-based cyber asset.

The scalable configurable universal operating system may be configured to provide programming that provides or enables processes or procedures that enable an individual's at least one point of cyber access computer to confirm the verified identity of at least one other party or to confirm the verified identity of at least one cyber device. Such identity confirmation may occur prior to further cyber interaction with the at least one other party, or prior to further cyber interaction with the at least one cyber device.

The scalable configurable universal operating system may be configured to provide programming that provides or enables processes or procedures that require or provide for at least one cyber device within the at least one cyber communications network to be utilized to establish the identity of at least one individual's at least one point of cyber access computer upon the at least one individual's at least one point of cyber access computer's first interaction with a cyber communications network device.

The scalable configurable universal operating system may be configured to provide programming that provides or enables processes or procedures that require the device within a cyber communications network that establishes the identity of one of an individual's at least one point of cyber access computers to provide verification of the identity of the individual's point of cyber access computer prior to at least one step, or prior to each step that the individual's cyber interactions take throughout a cyber system.

The scalable configurable universal operating system may be configured to provide programming that provides or enables processes or procedures that enable at least one cyber portal to sensor observe identity information in regard to an individual. This identity information may then be transferred, as at least one cyber interaction, to at least one of the individual's at least one point of cyber access computers, wherein the cyber interaction containing sensor observed identity information regarding the individual may be used by the individual's point of cyber access computer to establish the individual's identity.

The scalable configurable universal operating system may be configured to provide programming that provides or enables processes or procedures that enable at least one individual to use the cyber system identity designation of at least one other party or the cyber system identity designation of at least one device-based cyber asset of at least one other party to obtain additional information about the at least one other party or to obtain additional information about the at least one other party's at least one device-based cyber asset.

The scalable configurable universal operating system may be configured to provide programming that provides or enables the processes or procedures that require or assure that each person has one and only one unique lifelong cyber system identity designation.

The scalable configurable universal operating system may be configured to provide programming that provides or enables processes or procedures that require or assure that each cyber device has one and only one unique cyber system identity designation.

The scalable configurable universal operating system may be configured to provide programming that provides or enables processes or procedures that provide operating-system-based cybersecurity functions or services for use throughout at least one part of at least one cyber system.

The scalable configurable universal operating system may be configured to provide programming that provides or enables processes or procedures that require or provide security measures for all inbound cyber interactions or for all inbound cyber activities that have been sent to at least one of an individual's at least one point of cyber access computers.

The scalable configurable universal operating system may be configured to provide programming that provides or enables processes or procedures that require or provide security measures for all cyber interactions or for all cyber activities within at least one of an individual's at least one point of cyber access computers.

The scalable configurable universal operating system may be configured to provide programming that provides or enables processes or procedures that require or provide security for all outbound cyber interactions or all outbound cyber activities from at least one of an individual's at least one point of cyber access computers.

The scalable configurable universal operating system may be configured to provide programming that provides or enables processes or procedures that provide at least one individual with the ability to manage security at each of the individual's at least one device-based cyber assets including at least one device-based cyber asset selected from the group consisting of: (a) the individual's point of cyber access computers, (b) the individual's private computers, (c) at the individual's public computers, (d) the individual's remote cyber devices, and (e) the individual's cyber telephone systems.

The scalable configurable universal operating system may be configured to provide programming that provides or enables processes or procedures that provide differences among at least one member selected from the group consisting of: (a) cyber operations, (b) processes, (c) codes, (d) transfer packets, and (e) formats for cyber interactions for at least one member selected from the group consisting of: (i) cyber telephone communications, (ii) cyber mail, (iii) cyber messages, (iv) cyber television, (v) cyber video entertainment, (vi) cyber music, (vii) cyber file transfers, (viii) computer programs, (ix) computer applications, (x) operational controls, and (xi) at least one other needed or desired operation of a cyber system. The differences among (A) cyber operations, (B) cyber processes, (C) cyber codes, (D) cyber transfer packets, and (E) cyber formats for cyber interactions may provide for security between different processes, may assure proper routing, and may assure that a cyber interaction for one specific purpose may not be used for a different purpose.

The scalable configurable universal operating system may be configured to provide programming that provides or enables processes or procedures that inspect at least one inbound cyber interaction to determine if the at least one inbound cyber interaction contains at least one member selected from the group consisting of: (a) dangerous content, (b) malicious content, (c) inappropriate content, and (d) unwanted content.

The scalable configurable universal operating system may be configured to provide programming that provides or enables processes or procedures that deny further access to at least one inbound cyber interaction that contain at least one member selected from the group consisting of: (a) dangerous content, (b) malicious content, (c) inappropriate content, and (d) unwanted content.

The scalable configurable universal operating system may be configured to provide programming that provides or enables the processes or procedures that provide at least one member selected from the group consisting of:

(a) safe and secure cyber interactions between an individual's at least one private computer and the individual's at least one point of cyber access computer;

(b) safe and secure cyber interactions between an individual's at least one private computer and the individual's at least one public computer;

(c) safe and secure cyber interactions between an individual's at least one private computer and the individual's at least one device-based cyber asset;

(d) safe and secure cyber interactions between an individual's at least one private computer and the individual's at least one device manager; and

(d) safe and secure cyber interactions between an individual's at least one private computer and the individual's at least one cyber telephone system.

The scalable configurable universal operating system may be configured to provide programming that provides or enables processes or procedures that require or provide security for at least one member selected from the group consisting of:

(a) cyber interactions between an individual and the individual's device-based cyber assets;

(b) cyber interactions between an individual and the individual's file-based cyber assets; and

(c) cyber interactions between an individual and the individual's cyber resources.

The scalable configurable universal operating system may be configured to provide programming that provides or enables processes or procedures that provide for at least one security-based cyber interaction to occur between cyber system devices as an integral part of simultaneous corresponding cyber interaction that are being transferred between the same two or more cyber system devices.

The scalable configurable universal operating system may be configured to provide programming that provides or enables processes or procedures that provide a system-wide protocol. The system-wide protocol may be utilized to require at least one other party to have the ability to only request that an individual provide the at least one other party with at least one requested cyber interaction. The system-wide protocol may be utilized to further require that the individual either directly, or through automated interaction from the individual's at least one cyber device, have the exclusive ability to send cyber interactions to at least one other party from at least one member selected from the group consisting of: (a) the individual's point of cyber access computers, (b) the individual's private computers, (c) the individual's public computers, and (d) the individual's cyber telephone systems. The point of cyber access cyber system may be configured to where no other parties may send cyber interactions from at least one member selected from the group consisting of: (i) the individual's point of cyber access computers, (ii) the individual's private computers, (iii) the individual's public computers, and (iv) the individual's cyber telephone systems.

The scalable configurable universal operating system may be configured to provide programming that provides or enables processes or procedures that provide for the deletion of at least one member selected from the group consisting of: (a) cyber interactions from individuals that cannot be properly identified, (b) cyber interaction from other parties that cannot be properly identified, and (c) cyber interaction from cyber devices that cannot be properly identified.

The scalable configurable universal operating system may be configured to provide programming that provides or enables processes or procedures that provide for the identification of, or the deletion of, at least one cyber interaction that contains at least one instance of content selected form the group consisting of: (a) dangerous content, (b) malicious content, (c) inappropriate content, (d) unwanted content, (e) improperly labeled content, and (f) improperly identified content.

The scalable configurable universal operating system may be configured to provide programming that provides or enables processes or procedures that use (see FIG. 17) the combination of: (a) a virtual equivalent of at least one projector 803, (b) a virtual equivalent of at least one virtual projection display screen 805, and (c) a virtual equivalent of at least one virtual recorder or capture device 807, to provide cyber security by converting cyber content from at least one cyber interaction that is not in scalable configurable universal operating system standard format to safe and secure cyber interactions that are in scalable configurable universal operating system standard format.

The scalable configurable universal operating system may be configured to provide programming that provides or enables processes or procedures that provide encryption or at least one other cyber security process or cyber security procedure for use with at least one selected cyber interaction or cyber activity.

The scalable configurable universal operating system may be configured to provide programming that provides or enables processes or procedures that require that encryption or at least one other cyber security process or cyber security procedure be used for at least one cyber interaction that uses radio frequency signals for cyber communication.

The scalable configurable universal operating system may be configured to provide programming that provides or enables processes and procedures that back up stored information from, or restore backed up information to at least one member selected from the group consisting of:

(a) an individual's point of cyber access computers;

(b) an individual's private computers;

(c) an individual's public computers;

(d) an individual's cyber telephone systems;

(e) an individual's cyber device managers; and

(f) an individual's device-based cyber assets.

The scalable configurable universal operating system may be configured to provide programming that provides or enables processes or procedures that provide for safety, security, and privacy for at least one member selected from the group consisting of: (a) cyber financial interactions, (b) cyber financial transactions, (c) cyber payment transactions, and (d) operations of cyber-based financial record keeping systems.

The scalable configurable universal operating system may be configured to provide programming that provides or enables processes or procedures that provide safe, secure, and private cyber interactions between an individual, through the individual's use of a cyber portal, and the individual's own at least one point of cyber access computer and at least one member selected from the group consisting of: (a) health care related cyber devices that are being relied upon by the individual, and (b) health care related cyber resources that are being relied upon by the individual.

The scalable configurable universal operating system may be configured to provide programming that provides or enables processes or procedures that enable at least one individual to use varying levels of security for access to, or the operations of, at least one component of a cyber system.

The scalable configurable universal operating system may be configured to provide programming that provides or enables processes or procedures that enable at least one individual to selectively grant, or to selectively deny cyber interactions from at least one specified other party or cyber interactions from at least one specified cyber device, access to at least one member selected from the group consisting of: (a) the individual's point of cyber access computers, (b) the individual's cyber telephone systems, or (c) the individual's public computer.

The scalable configurable universal operating system may be configured to provide programming that provides or enables processes or procedures that enable at least one individual to make at least one copy of at least one of the individual's at least one file-based cyber assets available for use by at least one specified other party as at least one cyber resources. The at least one cyber resource may be made available to the at least one specified other party through the interactions of at least one specified other party with the individual's at least one point of cyber access computer or the individual's at least one public computer.

The scalable configurable universal operating system may be configured to provide programming that provides or enables processes or procedures that enable an individual to selectively grant, or to selectively deny cyber interactions from at least one specified other party or cyber interactions from at least one specified cyber device of at least one specified other party access to at least one part of the cyber resources that have been made available for the at least one specified other party through the interactions of the at least one specified other party or the at least one specified cyber device of the at least one specified other party with the individual's at least one public computer or with the individual's at least one point of cyber access computer.

The scalable configurable universal operating system may be configured to provide programming that provides or enables processes or procedures that enable an individual to safely and securely provide at least one specified other party with at least one member selected from the group consisting of: (a) specified levels of administrative control, (b) specified levels of access control, and (c) specified levels of operational access to at least one part of at least one member selected from the group consisting of: (i) the individual's point of cyber access computers, (ii) the individual's private computers, (iii) the individual's public computers, (iv) the individual's device-based cyber assets, (v) the individual's file-based cyber assets, (vi) the individual's cyber vaults, (vii) the individual's cyber device managers, and (viii) the individual's cyber telephone systems.

The scalable configurable universal operating system may be configured to provide programming that provides or enables processes or procedures that enable at least one individual to provide at least one specified other party with at least one member selected from the group consisting of: (a) specified cyber resources, (b) specified cyber content, and (c) specified cyber services.

The scalable configurable universal operating system may be configured to provide programming that provides or enables processes or procedures that provide for converting at least one cyber interaction output from at least one cyber device that does not use the scalable configurable universal operating system into at least one cyber interaction output that interacts seamlessly with at least one cyber device that utilizes the scalable configurable universal operating system.

The scalable configurable universal operating system may be configured to provide programming that provides or enables processes or procedures that provide for converting at least one cyber interaction output from at least one cyber device that uses the scalable configurable universal operating system into at least one cyber interaction output that interact seamlessly with at least one cyber device that uses at least one operating systems that is not the scalable configurable universal operating system.

The scalable configurable universal operating system may be configured to provide programming that provides or enables processes or procedures that provide for converting cyber content that is not in a format that may directly be used by the scalable configurable universal operating system into cyber content that is in the standard scalable configurable universal operating system format.

The scalable configurable universal operating system may be configured to provide programming that provides or enables processes or procedures that provide for converting cyber content that is in a standard scalable configurable universal operating system format into cyber content that is in at least one format that may be used by at least one cyber device that is using at least one operating systems that is not the scalable configurable universal operating system. The combination of this process and procedure and the previous three processes and procedures immediately above is one reason why the disclosed operating system may be described as being universal.

The scalable configurable universal operating system may be configured to provide programming that provides or enables processes or procedures that enable interoperable use of any cyber asset or any cyber resource. Cyber interoperability enables an individual to utilize the scalable configurable universal operating system to access or interact with any available cyber devices or any available cyber content.

The scalable configurable universal operating system may be configured to provide programming that provides or enables processes or procedures that use (see FIG. 17): (a) a virtual equivalent of at least one projector 803, (b) a virtual equivalent of at least one projection display screen 805, and (c) a virtual equivalent of at least one recorder or capture device 807, to convert inbound image-based cyber content that may not be useable as system standard content by the scalable configurable universal operating system into image-based cyber content that may seamlessly be used as scalable configurable universal operating system standard content.

The scalable configurable universal operating system may be configured to provide programming that provides or enables processes or procedures that enable at least one safe and secure cyber interaction with at least one content or device interoperability conversion process.

The scalable configurable universal operating system may be configured to provide programming that provides or enables processes or procedures that enable at least one safe and secure cyber interaction with at least one output from at least one content or device interoperability conversion process.

The scalable configurable universal operating system may be configured to provide programming that provides or enables processes or procedures that convert at least one member selected from the group consisting of: (a) administrative cyber interactions, and (b) systems configuration cyber interactions between cyber devices, to or from a system-standard scalable configurable universal operating system format.

The scalable configurable universal operating system may be configured to provide programming that provides or enables processes or procedures that identify inbound or outbound cyber interactions that require at least one content or device interoperability conversion.

The scalable configurable universal operating system may be configured to provide programming that provides or enables processes or procedures that enable at least one individual to use at least one operating system that is not the scalable configurable universal operating system. The at least one individual may require the use of the at least one operating system that is not the scalable configurable universal operating system for the purpose of converting cyber content or cyber interactions that may be used by at least one operating system that is not the scalable configurable universal operating system into cyber content or cyber interactions that may be seamlessly used by the scalable configurable universal operating system. Further, the at least one individual may require the use of at least one operating system that is not the scalable configurable universal operating system for the purpose of using at least one computer program or at least one computer application that requires the use of at least one operating system that is not the scalable configurable universal operating system.

The scalable configurable universal operating system may be configured to provide programming that provides or enables processes or procedures that exclude at least one other party or at least one cyber device from gaining at least one member selected from the group consisting of: (a) operational control, (b) administrative control, and (c) access control, of at least one member selected from the group consisting of: (i) an individual's point of cyber access computers, (ii) an individual's private computers, (iii) an individual's public computers, (iv) an individual's cyber device managers, and (v) an individual's device-based cyber assets.

The scalable configurable universal operating system may be configured to provide programming that provides or enables processes or procedures that enable an individual to exclude at least one other party or at least one cyber device from gaining administrative control or access control of the individual's at least one public computer or the individual's at least one cyber telephone system.

The scalable configurable universal operating system may be configured to provide programming that provides or enables processes or procedures that enable the use of at least one outbound cyber interaction that has been pre-processed by at least one sender. The at least one pre-processed cyber interaction of the at least one sender is ready to be used with no further processing of content required by at least one thin cyber portal.

The scalable configurable universal operating system may be configured to provide programming that provides or enables processes and procedures that enable at least one sender to pre-process at least one outbound cyber interaction so that the at least one outbound cyber interaction is ready to be used with no further processing of content required by at least one thin cyber portal.

The scalable configurable universal operating system may be configured to provide programming that provides or enables processes or procedures that enable the pre-processing of cyber interactions that are sent from an individual's at least one point of cyber access computer to a thin cyber portal that is being used by the individual. In particular, these processes and procedures may require that such cyber interactions are pre-processed cyber interactions that require no further processing of content prior to use by the thin cyber portal that the individual is using.

The scalable configurable universal operating system may be configured to provide programming that provides or enables processes or procedures that utilize at least one cyber system address designation or at least one cyber system identity designation for at least one step, or for each step of at least one cyber interaction.

The scalable configurable universal operating system may be configured to provide programming that provides or enables processes or procedures that enable an individual to request or to require that at least one other party only provide the individual with cyber interactions or cyber content that comply with the individual's preferences or requirements for cyber interactions or for cyber content.

The scalable configurable universal operating system may be configured to provide programming that provides or enables processes or procedures that enable an individual to request or require that at least one other party provide the individual with varying levels of privacy, as defined by the individual, for the individual's cyber interactions with the at least one other party.

The scalable configurable universal operating system may be configured to provide programming that provides or enables processes or procedures that enable at least one individual to perform at least one member selected from the group consisting of: (a) add cyber components or cyber devices to a cyber system, (b) remove cyber components or cyber devices from a cyber system, (c) alter cyber components or cyber devices that are a part a cyber system, and (d) change the configuration of cyber components or cyber devices that are a part of a cyber system.

The scalable configurable universal operating system may be configured to provide programming that provides or enables the processes or procedures that enable at least one individual to perform at least one action selected from the group consisting of:

(a) adding processes or procedures to a cyber system;

(b) removing processes or procedures from a cyber system;

(c) altering processes or procedures that are a part of a cyber system; and

(d) changing the configuration of processes or procedures that are a part of a cyber system.

The scalable configurable universal operating system may be configured to provide programming that provides or enables processes or procedures that enable an individual to perform at least one action selected from the group consisting of:

(a) adding to cyber devices, at least one member selected from the group consisting of: (i) cyber processes, (ii) cyber procedures, and (iii) cyber components;

(b) removing from cyber devices, at least one member selected from the group consisting of: (i) cyber processes, (ii) cyber procedures, and (iii) cyber components;

(c) altering at least one member selected from the group consisting of: (i) cyber processes, (ii) cyber procedures, and (iii) cyber components that are parts of cyber devices; and

(d) changing the configuration of at least one member selected from the group consisting of: (i) cyber processes, (ii) cyber procedures, and (iii) cyber components that are parts of cyber devices.

The scalable configurable universal operating system may be configured to provide programming that provides or enables processes or procedures that enable an individual's cyber system architecture, cyber devices, cyber components, cyber processes, and cyber procedures to be configured in at least one way. Providing an individual with the ability to configure, in at least one way, the individual's cyber system architecture, cyber devices, cyber components, cyber processes, and cyber procedures provides for the varying needs and desires of different and unique individuals. Further, individuals that are entities such as businesses, or schools, or governments, or at least one other type of entity that uses a cyber system identity designation, may have many different and specific needs for cyber devices, cyber components, cyber processes, cyber procedures, and configurations for a cyber system.

The scalable configurable universal operating system may be scaled to where at least one scalable configurable universal operating system may be configured, in regard to included operating system resources, to fall at one point in the range of from a minimum to a maximum, wherein at the minimum the scalable configurable universal operating system is scaled to include only the resources that are needed to provide for the smallest possible part of the least complex, in regard to included necessary operating system resources, of all operating system needs, and wherein at the maximum the scalable configurable universal operating system is scaled to include all of the operating system resource that are needed to provide for every operating system need from a full spectrum of operating system needs.

The scalable configurable universal operating system may be configured to provide programming that provides or enables processes or procedures that provide at least one cyber interoperability process or cyber interoperability procedure that enables at least one individual to seamlessly use at least one member selected from the group consisting of: (a) non-system-standard cyber activities, (b) non-system-standard cyber processes, and (c) non-system-standard cyber devices.

The scalable configurable universal operating system may be configured to provide programming that provides or enables processes or procedures that provide for the interrelationship between any combination of members selected from the group consisting of: (a) cyber components, (b) cyber devices, (c) cyber processes, and (d) cyber procedures, of at least one cyber system.

The scalable configurable universal operating system may be configured to provide programming that provides or enables processes or procedures that provide for cyber interactions between any combination of members selected from the group consisting of: (a) cyber components, (b) cyber devices, (c) cyber processes, and (d) cyber procedures, of at least one cyber system.

The scalable configurable universal operating system may be configured to provide programming that provides or enables processes or procedures that enable an individual to operationally access the individual's at least one point of cyber access computer. Such access may be enabled by the use of at least one cyber portal that provides sensor observation derived identity information regarding the individual to the individual's at least one point of cyber access computer. The sensor derived identity information may be utilized to enable the individual's at least one point of cyber access computer to establish the individual's identity.

The scalable configurable universal operating system may be configured to provide programming that provides or enables processes or procedures that provide seamless cyber interactions when at least two cyber portals are simultaneously used for at least one cyber activity.

The scalable configurable universal operating system may be configured to provide programming that provides or enables processes or procedures that provide for cyber interactions utilizing at least one input device of at least one type, or at least one output device of at least one type.

The scalable configurable universal operating system may be configured to provide programming that provides or enables processes or procedures that provide a graphic user interface (GUI). The GUI may utilize frames and scrolls formatted image-based cyber content in conjunction with the processes that use: (a) a virtual equivalent of at least one projector, (b) a virtual equivalent of at least one projection display screen, and (c) a virtual equivalent of at least one recorder or capture device, for at least one member selected from the group consisting of: (i) conversion of, (ii) alteration of, and (iii) convergence of, image-based cyber content.

The scalable configurable universal operating system may be configured to provide programming that provides or enables processes or procedures that make up at least one part of at least one device operating system for at least one point of cyber access computer.

The scalable configurable universal operating system may be configured to provide programming that provides or enables processes or procedures that enable a point of cyber access computer to work in conjunction with at least one separate private computer or to work in conjunction with at least one separate public computer. The at least one separate private computer and the at least one separate public computer may at least one member selected from the group consisting of: (a) each be an integral part of at least one point of cyber access computer, (b) both be an integral part of the at least one point of cyber access computer, (c) be combined as at least one separate device, and (d) each be separate devices.

The scalable configurable universal operating system may be configured to provide programming that provides or enables processes or procedures that route or transfer cyber interactions or cyber activities (a) within point of cyber access computers, (b) between point of cyber access computers and private computers, (c) between point of cyber access computers and public computers, and (d) between public computers and private computers.

The scalable configurable universal operating system may be configured to provide programming that provides or enables processes or procedures that enable at least one individual to locally or remotely use at least one cyber portal for interacting with at least one of the individual's at least one point of cyber access computers.

The scalable configurable universal operating system may be configured to provide programming that provides or enables processes or procedures that enable an individual's at least one point of cyber access computer to independently have cyber interactions with at least one other party based upon at least one member selected from the group consisting of: (a) predetermined operational settings, (b) predetermined administrative settings, and (c) predetermined access settings.

The scalable configurable universal operating system may be configured to provide programming that provides or enables processes or procedures that make up at least one part of at least one device operating system for at least one private computer.

The scalable configurable universal operating system may be configured to provide programming that provides or enables processes or procedures that provide an individual with at least one private computer that may be configured to only be accessed by the individual or by the individual's selected device-based cyber assets.

The scalable configurable universal operating system may be configured to provide programming that provides or enables processes or procedures that exclude all other parties, as well as the cyber devices of all other parties, from having cyber interactions with at least one of an individual's at least one private computers. Because all other parties and the cyber devices of all other parties are excluded from having cyber interactions with the individual's at least one private computer, the individual's at least one private computer may provide the individual with a cyber environment that may be absolutely safe, secure, private, and free from intrusion by other parties as described above. An individual's at least one private computer may be configured to be at least one cyber vault.

The scalable configurable universal operating system may be configured to provide programming that provides or enables processes or procedures that provide safe and secure cyber interactions between an individual's at least one private computer and all cyber activities or all cyber interactions from within the individual's at least one point of cyber access computer.

The scalable configurable universal operating system may be configured to provide programming that provides or enables processes or procedures that enable an individual to use the individual's at least one private computer to run or use at least one computer program or to run or use at least one computer application.

The scalable configurable universal operating system may be configured to provide programming that provides or enables processes and procedures that enable an individual to perform at least one action selected from the group consisting of: (a) storing, (b) accessing, (c) using, (d) sharing, and (e) managing, at least one part of the individual's file-based cyber assets from within the individual's at least one private computer.

The scalable configurable universal operating system may be configured to provide programming that provides or enables processes or procedures that make up at least one part of at least one device operating system for at least one public computer.

The scalable configurable universal operating system may be configured to provide programming that provides or enables the processes or procedures for an individual's at least one public computer to use to enable the individual's at least one public computer to participate in cyber interactions with at least one other party or with at least one cyber device. Such participation may be based upon at least one member selected from the group consisting of: (a) predetermined operational settings, (b) predetermined administrative settings, and (c) predetermined access settings.

The scalable configurable universal operating system may be configured to provide programming that provides or enables processes or procedures that enable an individual to perform at least one action selected from the group consisting of: (a) using, (b) receiving, and (c) storing, cyber interactions or cyber content that was received from at least one other party through use of the storage capabilities or other resources of the individual's at least one public computer.

The scalable configurable universal operating system may be configured to provide programming that provides or enables processes or procedures that enable an individual to selectively grant, or to selectively deny at least one other party or at least one cyber device, access to the individual's at least one public computer.

The scalable configurable universal operating system may be configured to provide programming that provides or enables processes or procedures that enable an individual to selectively grant, or to selectively deny at least one specified other or at least one specified cyber device access to at least one part of the individual's cyber resources that are available for use by the at least one specified other or the at least one cyber device through cyber interactions with the individual's at least one public computer.

The scalable configurable universal operating system may be configured to provide programming that provides or enables processes or procedures that provide for all aspects of operations of, or interaction with, at least one safe, secure, and full-featured cyber telephone system.

The scalable configurable universal operating system may be configured to provide programming that provides or enables processes or procedures that enable an individual's at least one cyber telephone system to independently interact with at least one other party based upon at least one member selected from the group consisting of: (a) predetermined operational settings, (b) predetermined administrative settings, and (c) predetermined access settings.

The scalable configurable universal operating system may be configured to provide programming that provides or enables processes or procedures that are utilized for at least one part of at least one aspect of the operations of, or cyber interactions with, at least one safe, secure and full-featured cyber device manager.

The scalable configurable universal operating system may be configured to provide programming that provides or enables processes or procedures that exclude at least one of an individual's device-based cyber assets from having cyber interactions with at least one other party.

The scalable configurable universal operating system may be configured to provide programming that provides or enables processes or procedures that exclude at least one other party from having cyber interactions with at least one of the at least one individual's at least one device-based cyber assets.

The scalable configurable universal operating system may be configured to provide programming that provides or enables processes or procedures that provide an interoperable cyber system wherein at least one interconnected cyber device of at least one type may be seamlessly used as at least one component of the cyber system.

The scalable configurable universal operating system may be configured to provide programming that provides or enables processes or procedures that are utilized to provide at least one system-standard interconnection interface for use by at least one cyber device.

The scalable configurable universal operating system may be configured to provide programming that provides or enables processes or procedures that provide for utilization of at least one member selected from the group consisting of:

(a) lines of cyber communications;

(b) type of lines of cyber communications; and

(c) providers of lines of cyber communications.

The scalable configurable universal operating system may be configured to provide programming that provides or enables processes or procedures require or provide for all devices within at least one cyber communications network to exclude all from interacting with at least one cyber interaction or all cyber interactions while the at least one cyber interaction or all cyber interactions are being transferred through the at least one cyber communications network.

The scalable configurable universal operating system may be configured to provide programming that provides or enables processes or procedures that enable each stream of cyber interactions to use a separate line of cyber communications whereby no two streams of cyber interactions may use the same line of cyber communications at the same time.

The scalable configurable universal operating system may be configured to provide programming that provides or enables processes or procedures that are utilized to enable a sender's cyber interactions to move one way only through a cyber communications line and for the recipient's cyber interactions to move one way only and to be sent through at least one separate cyber communications line.

The scalable configurable universal operating system may be configured to provide programming that provides or enables processes or procedures that enable safe and secure cyber interactions from at least one cyber device that are sent to and through a cyber portal that is being used by an individual and to at least one of the individual's at least one point of cyber access computers. Further, the scalable configurable universal operating system may be configured to provide programming that provides or enables processes or procedures that enable safe and secure cyber interactions from at least one of an individual's at least one point of cyber access computers, to and through, a cyber portal that is being used by the individual to at least one cyber device.

The scalable configurable universal operating system may be configured to provide programming that provides or enables the processes or procedures for routing or transferring at least one cyber interaction through at least one cyber communications network.

The scalable configurable universal operating system may be configured to provide programming that provides or enables processes or procedures that make up at least one part of at least one operation of the scalable configurable universal operating system's safe, secure, and full-featured transfer packet system.

The scalable configurable universal operating system may be configured to provide programming that provides or enables processes or procedures that require or provide for the use of at least one transfer packet label. The at least one transfer packet label may be used to provide for at least one member selected from the group consisting of (a) security, (b) determining identity, (c) routing, (d) communicating a sender's requirements or requests, and (e) at least one other required or desired utility that may be provided by information from the at least one transfer packet label.

The scalable configurable universal operating system may be configured to provide programming that provides or enables processes or procedures that compare a transfer packet's label to the contents of the transfer packet.

The scalable configurable universal operating system may be configured to provide programming that provides or enables processes or procedures that provide for safe and secure deletion of transfer packets that have packet contents that do not match the transfer packet's label.

The scalable configurable universal operating system may be configured to provide programming that provides or enables processes or procedures that enable safe and secure use of mobile or in-motion cyber devices such as, for example, a vehicle or a mobile cyber portal.

The scalable configurable universal operating system may be configured to provide programming that provides or enables processes or procedures that provide or make use of at least one cyber system address designation for at least one mobile or in-motion cyber device.

The scalable configurable universal operating system may be configured to provide programming that provides or enables processes or procedures that enable the use of at least one cyber communications network by at least one mobile or in-motion cyber device.

The scalable configurable universal operating system may be configured to provide programming that provides or enables processes or procedures that enable the use of at least one global position locating device either independently or in conjunction with at least one other cyber device.

The scalable configurable universal operating system may be configured to provide programming that provides or enables processes or procedures that provide at least one menu or at least one other user-perceptible output that provides at least one individual with knowledge of, and access to, at least one choice of at least one cyber interaction with at least one member selected from the group consisting of: (a) cyber assets, and (b) cyber resources.

The scalable configurable universal operating system may be configured to provide programming that provides or enables processes or procedures that make up at least one voice recognition-driven user interface.

The scalable configurable universal operating system may be configured to provide programming that provides or enables processes and procedures that enable at least one individual to perform at least one operation on at least one file-based cyber asset or at least one file-based cyber resource. The at least one operation may be at least one member selected from the group consisting of: (a) storing, (b) accessing, (c) modifying, (d) using, (e) sharing, and (f) managing, such assets or resources.

The scalable configurable universal operating system may be configured to provide programming that provides or enables processes or procedures that enable at least one individual to perform at least one operation on all or any part of the at least one individual's file-based cyber assets. The at least one operation may be at least one member selected from the group consisting of: (a) storing, (b) accessing, (c) modifying, (d) sharing, (e) using, and (f) managing, the file-based cyber assets.

The scalable configurable universal operating system may be configured to provide programming that provides or enables processes or procedures that provide at least one individual with at least one absolutely safe and secure location for performing at least operation on at least one part of the at least one individual's file-based cyber assets. The at least one operation may be at least one member selected from the group consisting of: (a) storing, (b) accessing, (c) modifying, (d) sharing, (e) using, and (f) managing, the file-based cyber assets.

The scalable configurable universal operating system may be configured to provide programming that provides or enables processes or procedures that provide at least one historical record of at least one individual's at least one cyber activity or at least one historical record of at least one cyber device's at least one cyber activity.

The scalable configurable universal operating system may be configured to provide programming that provides or enables processes or procedures that utilize a combination of: (a) a virtual equivalent of at least one projector, (b) a virtual equivalent of at least one projection display screen, and (c) a virtual equivalent of at least one recorder or capture device, to converge a plurality of sources of image-based cyber content into at least one converged source of image-based cyber content.

The scalable configurable universal operating system may be configured to provide programming that provides or enables processes or procedures that utilize a combination of: (a) a virtual equivalent of at least one projector, (b) a virtual equivalent of at least one projection display screen, and (c) a virtual equivalent of at least one recorder or capture device, to alter at least one aspect of image-based cyber content in at least one way.

The scalable configurable universal operating system may be configured to provide programming that provides or enables the universal operating system's set of standard cyber processes and standard cyber procedures for at least one member selected from the group consisting of: (a) use, (b) management, and (c) alteration, of image-based cyber content.

The scalable configurable universal operating system may be configured to provide programming that provides or enables processes or procedures that provide for creation or use of frames and scrolls formatted image-based cyber content.

The scalable configurable universal operating system may be configured to provide programming that provides or enables processes or procedures that provide for frames and scrolls formatted image-based cyber content wherein, such content may use the total pixel width by total pixel height size of the target image display output device to determine the total pixel width by total pixel height size of at least one image that is to be transferred to the at least one image display device.

The scalable configurable universal operating system may be configured to provide programming that provides or enables processes or procedures that provide for or enable the use of image-based cyber content that has both a total pixel width and a total pixel height that are smaller than or equal to the pixel width and the pixel height of the target image display device. Such content is considered to be a cyber image in frame format as shown in FIGS. 18B and 18C.

The scalable configurable universal operating system may be configured to provide programming that provides or enables processes or procedures that provide for or enable the use of image-based cyber content that has a total pixel width that is greater than the pixel width of the target image display device or a total pixel height that is greater than the pixel height of the target image display device. Such content is considered to be a scroll formatted cyber image as shown in FIGS. 18E and 18G.

The frames and scrolls format for image-based cyber content provides an individual with ability to scroll through a scroll formatted cyber image so that an entire scroll formatted cyber image may be displayed, although not simultaneously.

Further, the frames and scrolls format for image-based cyber content uses a pixel width by pixel height grid to identify the point on at least one frame-formatted or at least one scroll-formatted, cyber image where at least one input interaction was made by at least one individual as shown in FIGS. 16C and 16F.

The scalable configurable universal operating system may be configured to provide programming that provides or enables processes or procedures that provide for all aspects of operations or use of at least one part of at least one safe, secure, and full-featured cyber rights license system.

Utilizing the at least one cyber rights license system that is enabled by the scalable configurable universal operating system, at least one licensee may be required to provide at least one licensor with at least one member selected from the group consisting of:

(a) the licensee's cyber system identity designation;

(b) the licensee's cyber system address designation;

(c) the identity designation of the licensed cyber resources that the licensee is requesting; and

(d) the rights that the licensee has to the requested cyber resources.

The scalable configurable universal operating system may be configured to provide programming that provides or enables processes or procedures that provide for all aspects of operations or use of at least one safe, secure, and full-featured cyber mail system.

The scalable configurable universal operating system may be configured to provide programming that provides or enables processes or procedures that provide for all aspects of operations or use of at least one safe, secure, and full-featured cyber message or cyber alert, system.

The scalable configurable universal operating system may be configured to provide programming that provides or enables processes or procedures that provide for all aspects of operations or use of at least one safe, secure, and full-featured cyber site system.

The scalable configurable universal operating system may be configured to provide programming that provides or enables processes or procedures that provide at least one sender with the option to receive at least one cyber acknowledgement of at least one recipient's receipt of at least one cyber interaction.

The scalable configurable universal operating system may be configured to provide programming that provides or enables processes or procedures that provide at least one system generated cyber message when at least one cyber activity does not execute properly.

The scalable configurable universal operating system may be configured to provide programming that provides or enables processes or procedures that enable at least one individual to send to themselves, or to send to at least one other party, at least one system-generated cyber message or system-generated cyber alert.

The scalable configurable universal operating system may be configured to provide programming that provides or enables processes or procedures that enable safe, secure, and private interaction between at least one member selected from the group consisting of: (a) individuals, (b) an individual's private computers, and (c) an individual's point of cyber access computers, and at least one member selected from the group consisting of (i) health care related cyber devices, (ii) health care related cyber assets, and (iii) health care related cyber resources.

The scalable configurable universal operating system may be configured to provide programming that provides or enables processes or procedures that provide job management for at least one of the operation of the scalable configurable universal operating system or task management for at least one operation of the scalable configurable universal operating system.

The scalable configurable universal operating system may be configured to provide programming that provides or enables processes or procedures that are utilized to provide management for or of at least one cyber device.

The scalable configurable universal operating system may be configured to provide programming that provides or enables processes or procedures that provide accurate and reliable determination of the identity of any one specific and unique individual through use of at least one combination of sensor observed changes to the specific individual that occur with movement of the individual or that occur over time.

### (8) Cyber Communications Network

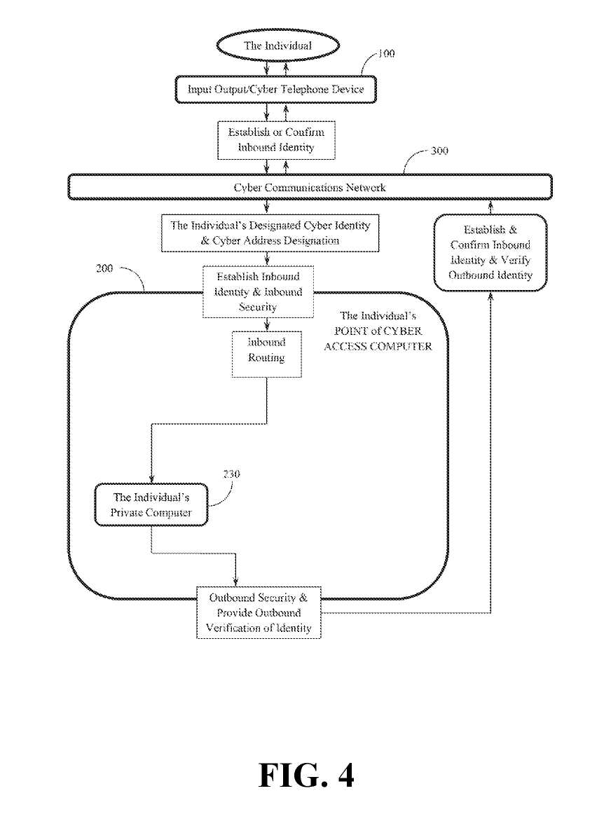

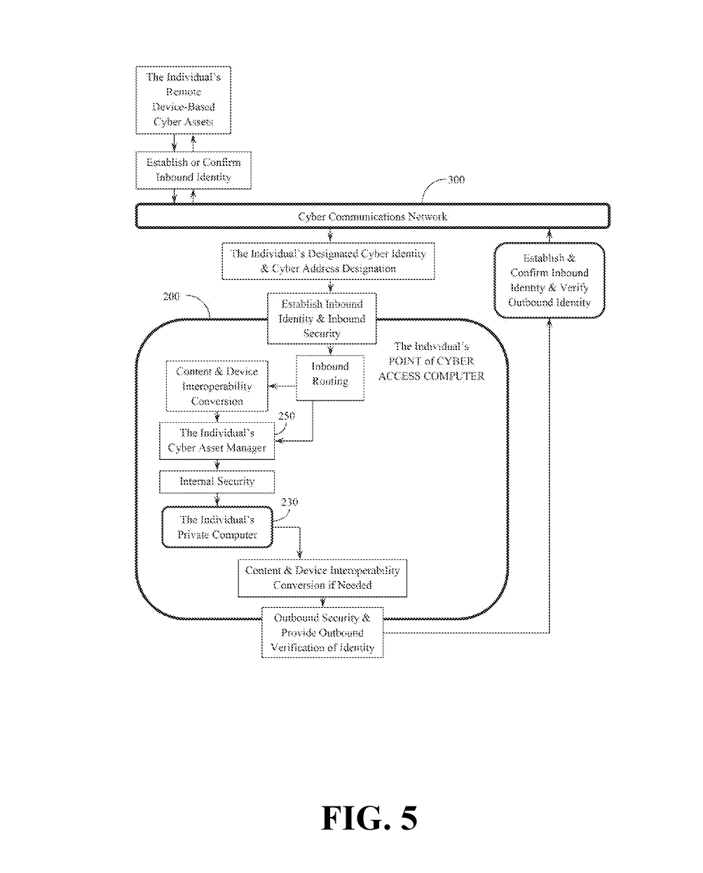

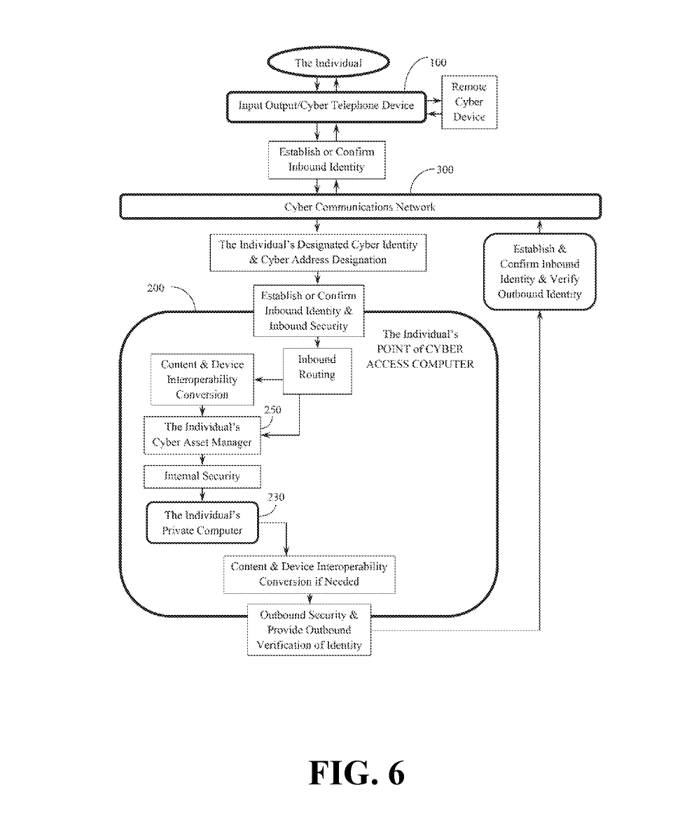

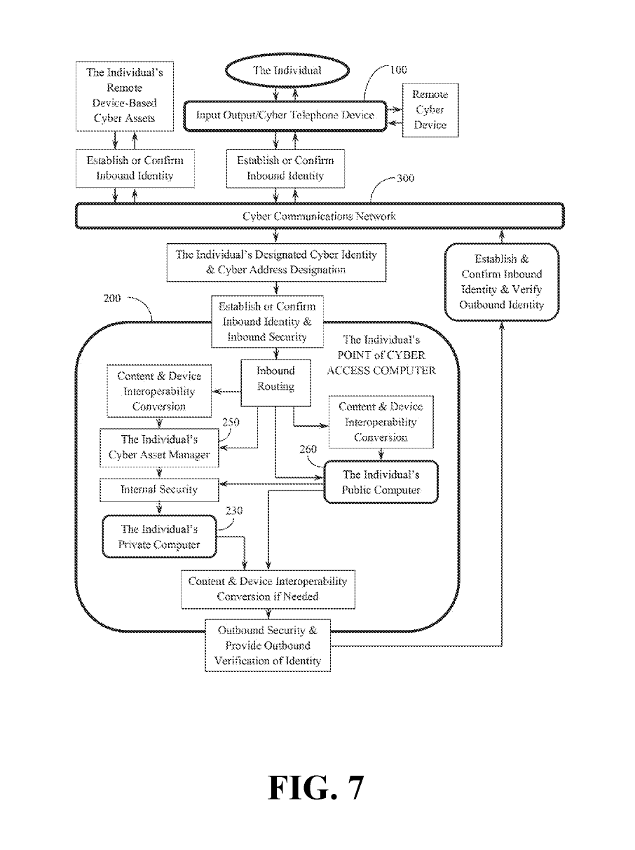

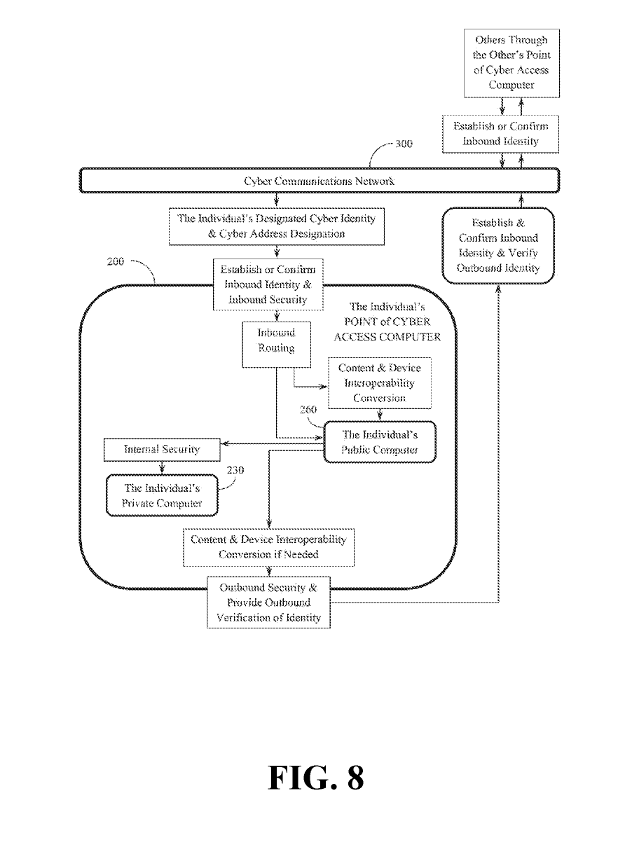

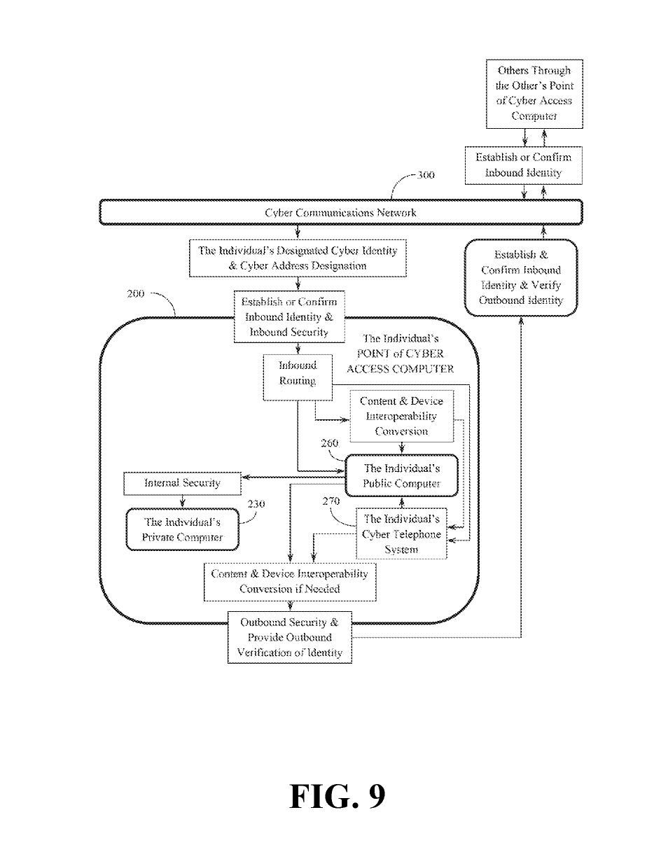

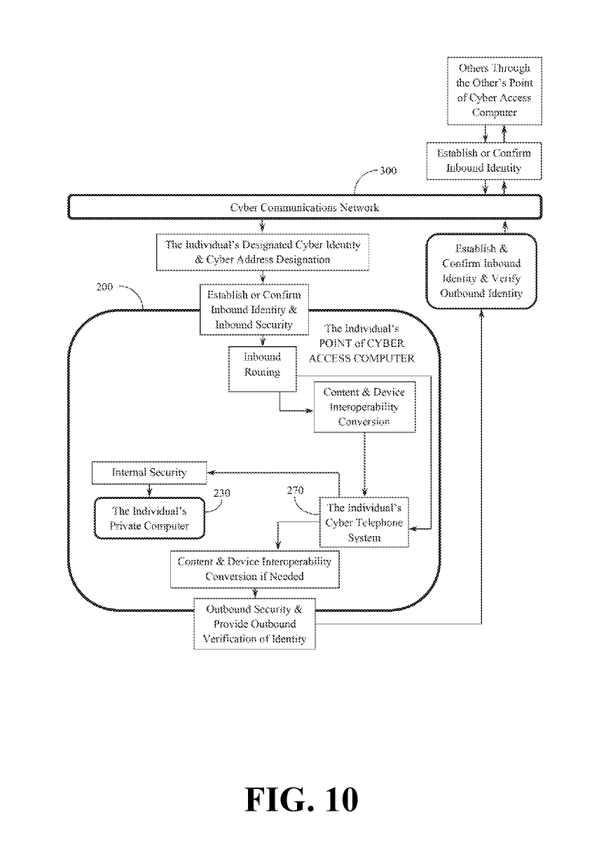

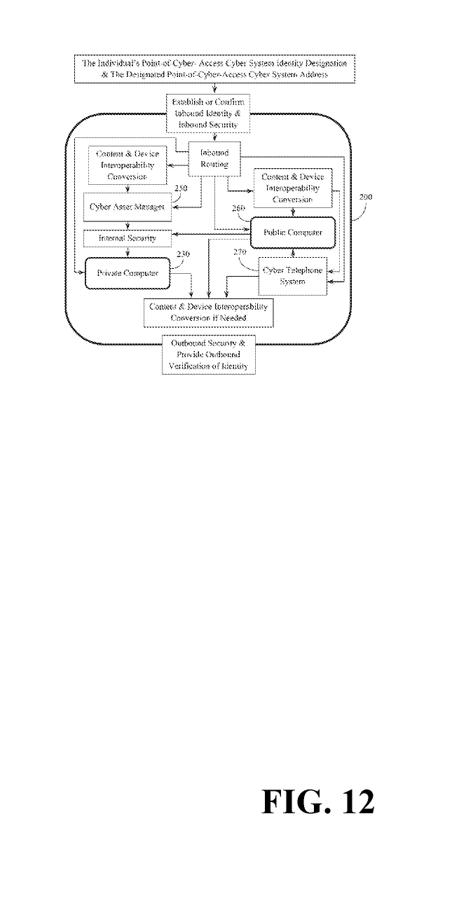

The purpose of the at least one cyber communications network 300 (see FIGS. 2-15) is to safely, securely, and efficiently transfer at least one properly formatted and properly identified transfer packet from a sender to a recipient.

Transfer packets may be the only cyber system vehicles that are used to transfer at least one cyber interaction from a sender to a recipient.

A cyber system may use many different, and unique, transfer packet formats. The different and unique transfer packet formats may be used for different types of cyber activities or for cyber activities that are for different purposes.

A point of cyber access computer may use differences in transfer packet formats to aid in providing security for inbound cyber activities. The point of cyber access computer may also use differences in transfer packet formats to aid in the proper routing of cyber activities and cyber interactions.

The packet portion of a transfer packet may contain all, or any part of, a sender's cyber interaction.

A sender's cyber interaction requires at least one transfer packet. A cyber interaction that requires more than one transfer packet uses transfer packets that may be identified as being a specific part of a group of transfer packets.

Each transfer packet, at a minimum, has a label that may provide at least one member selected from the group consisting of:

(a) the cyber system address designation of the recipient's point of cyber access computer;

(b) the recipient's cyber system identity designation;

(c) the sender's cyber system identity designation;

(d) verification of the sender's identity;

(e) the cyber system identity designation of the sender's point of cyber access computer;

(f) verification of the designated identity of the sender's point of cyber access computer;

(g) information about the contents of the transfer packet regarding if the transfer packet is one in a series of transfer packets, that together, in proper sequence, make up one single cyber interaction from a sender;

(h) information about the contents of a transfer packet that may aid the recipient in determining if the sender's cyber interaction conforms with the recipient's requirements or preferences for privacy, or the recipient's requirements or preferences for cyber interaction content;

(i) the at least one cyber interaction; and

(j) at least one historical record of at least one cyber interaction that the transfer packet has with at least one cyber system cyber device.

A transfer packet label may include any information about the sender or any information about the contents of the transfer packet that were required or desired by the sender or the recipient of the cyber transfer packet.

Recipients of transfer packets may require that transfer packets include specific label information that may include any information about the sender or about the contents of the transfer packet that may aid the recipient in determining if the sender's cyber interaction will be allowed to gain further access to the recipient's point of cyber access computer.

An example of a recipient's requirements for additional transfer packet label information about the sender or about the contents of a transfer packet would occur if a recipient required all business senders to identify the sender as being a business. The recipient may further require cyber interactions from a business to identify if the business was making an unsolicited marketing cyber interaction. In such a case the recipient has the ability to exclude all unsolicited business marketing cyber interactions from gaining further access to the recipient's point of cyber access computer.

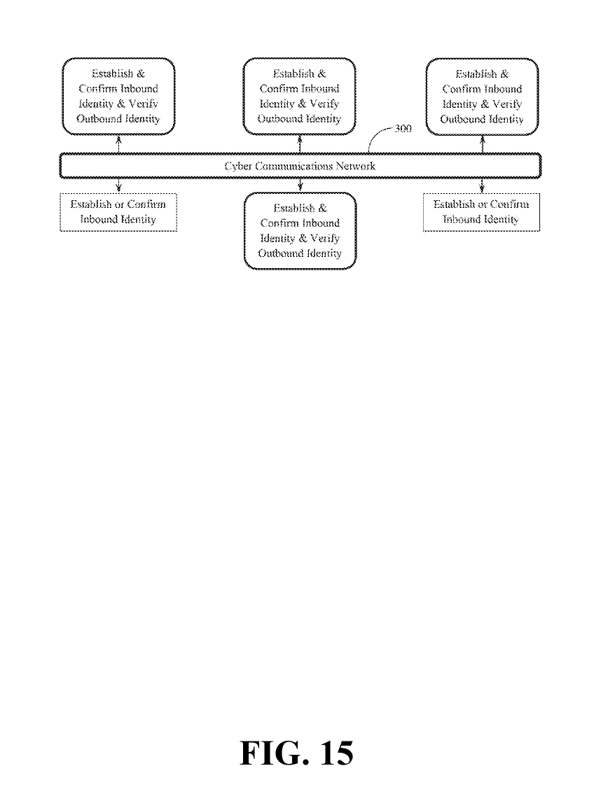

The at least one cyber communications network (see FIG. 15), may require that at least one individual be properly identified prior to at least one step, or prior to each step that the individual's cyber interactions take throughout the at least one cyber communications network. Further, the cyber communications network may require that at least one cyber device or that each cyber device be properly identified prior to at least one step, or prior to each step that a cyber device's cyber interactions take throughout the at least one cyber communications network. Cyber interactions from at least one improperly or inadequately identified individual or at least one improperly or inadequately identified cyber device may not be transferred through the at least one cyber communications network.

The cyber devices that make up the at least one cyber communications network may not have the ability to make changes to transfer packet labels or transfer packet contents.

A recipient may have the ability to keep at least one part of a historical record of transfer packet label information from at least one inbound cyber interaction that is received by the recipient. The recipient may also have the ability to keep at least one historical record of transfer packet label information from at least one inbound cyber interaction that was denied access to the recipient's at least one point of cyber access computer.

Communications between the devices within the at least one cyber communications network may use at least one member selected from the group consisting of: (a) wires, (b) optical fibers, (c) radio frequencies, (d) any other communication means, and (e) at least one combination thereof. When radio frequencies are used for cyber communications, the cyber system may use encryption or at least one other cyber security process that may make the contents of at least one transfer packet useless to all but the sender and the designated recipient.

The at least one device in the at least one cyber communications network, the at least one cyber portal, the at least one point of cyber access computer, and the at least one remote device-based cyber asset may each provide separate security-based cyber interactions as an integral part of at least one corresponding cyber interaction that is being transferred between any of the same cyber devices. This process may be used to prevent intruders from interacting with transfer packets or the operations of the cyber communications network.

At least one device that is a component of the at least one cyber communications network may keep at least one historical record of its own cyber activities or cyber interactions.

The device within the at least one cyber communications network that comes in first contact with cyber interactions from an individual's point of cyber access computer may establish the identity of the individual's point of cyber access computer prior to further transfer of the individual's cyber interaction. The device within the at least one cyber communications network that come in first contact with the individual's point of cyber access computer may use at least one safe, secure and accurate process, test or method to establish the identity of the individual's point of cyber access computer.

After having properly established the identity of an individual's point of cyber access computer, the device within the cyber communications network that comes in first contact with cyber interactions from the individual's point of cyber access computer may then provide verification of the identity of the individual's point of cyber access computer prior to at least one step, or prior to each step that the individual's cyber interactions take throughout the cyber system.

### (9) Cyber Portal

The purpose of the at least one cyber portal 100 (referring again to FIG. 1) is to perform at least one action selected from the list consisting of:

(a) sending input from an individual using the cyber portal, through the cyber communications network, to the individual's at least one point of cyber access computer;

(b) receiving output for the individual that was sent from the individual's point of cyber access computer, through the at least one cyber communications network, to the cyber portal that is being used by the individual;

(c) providing information derived from sensor observations that may enable the individual's point of cyber access computer to establish the identity of the individual that is using the cyber portal; and

(d) provide output from the cyber portal that provides the individual with the ability to: (i) perceive at least one cyber interaction, and (ii) interact with at least one cyber interaction that was sent by the individual's point of cyber access computer.

As shown in FIG. 1, the at least one cyber portal 100 uses the at least one cyber communications network 300 to transfer at least one transfer packet between the cyber portal that is being used by an individual and the individual's at least one point of cyber access computer.

The at least one cyber portal 100 uses at least one operating system that provides functional and operational programming for the functions of the at least one cyber portal.

One type of cyber portal is a thin cyber portal 100. A thin cyber portal has limited processing or functional capabilities. A thin cyber portal relies on at least one other device to have previously processed the content of the cyber interaction so that the cyber interaction may be used by the thin cyber portal with no further processing of content.

As a part of its operations, one type of cyber portal 100 has the ability to store its at least one operating system or store at least one cyber interaction or resource that is desired or required to be stored.

A cyber portal 100 may also be a cyber telephone device. When a cyber portal is also a cyber telephone device, an individual's point of cyber access computer 200 may be configured to initiate cyber telephone communication interactions with the individual through use of the individual's cyber portal telephone device. When an individual is using a cyber portal that is not a cyber telephone device, the individual would need to initiate the cyber telephone communication process.

Cyber interaction from an individual to the individual's point of cyber access computer may originate from a cyber portal 100. The cyber portal 100 may provide the individual's point of cyber access computer with sensor observation derived identity information regarding the individual that enables the individual's point of cyber access computer to properly establish the individual's identity.

Sending a cyber interaction from an individual using a cyber portal to the individual's point of cyber access computer may require that the cyber portal use properly formatted transfer packets. The properly formatted transfer packets are preferably addressed to the individual as the recipient. The address may contain the individual's identity designation, as well as the address designation and the identity designation of the individual's point of cyber access computer that will receive the interaction.

Sending a cyber interaction from an individual's point of cyber access computer to a cyber portal that is being used by the individual may require that the individual's point of cyber access computer send properly formatted transfer packets to the cyber portal. The to-the-cyber portal formatted transfer packets may be addressed to the identity designation and address designation of the cyber portal that is being used by the individual.

Upon first contact with the individual's point of cyber access computer, the individual's cyber interaction's request for access may be routed to the processes or procedures for granting the individual's cyber interactions access to the individual's point of cyber access computer.

Following an individual's request for the individual's cyber interaction to gain further access to the individual's own point of cyber access computer, process or procedures may be executed for establishing the identity of this specific individual. The cyber interactions from the individual that is using the cyber portal may only be granted access to the individual's own point of cyber access computer after the individual's own point of cyber access computer has accurately established the individual's identity.

An individual's point of cyber access computer, working in conjunction with the cyber portal that is being used by the individual, may establish the individual's identity through use of at least one member selected from the group consisting of: (a) a combination of sensor observed changes to an individual that occur with movement of the individual or that occur over time (b) other suitable methods of identity determination known to those skilled in the art, and (c) at least one combination thereof, to remotely establish the individual's identity.

Once cyber interactions from the individual gain access to the individual's properly configured point of cyber access computer, the cyber interactions from the individual may be routed to the individual's private computer. It is from within the constructs of the individual's private computer where the individual, through the individual's interactions with the cyber portal, may have safe and secure operational and administrative access to at least one member selected from the group consisting of: (a) the individual's private computers, (b) the individual's point of cyber access computers, (c) the individual's public computers, (d) the individual's cyber assets, (e) the individual's cyber resources, (f) the individual's cyber device managers, and (g) the individual's cyber telephone systems.

An individual's at least one private computer may be configured to where only cyber interactions from the individual may gain access to the individual's at least one private computer 230 (see FIGS. 2-12). An individual's at least one private computer may also be configured to where all cyber interactions from all other parties may be excluded from gaining access to the individual's at least one private computer.

Once the individual has gained access to the individual's private computer 230, through the individual's interactions with the cyber portal, the individual may be provided with options for further cyber interactions.

Referring again to FIG. 3, an individual using at least one cyber portal 100 sends at least one cyber interaction through the cyber communications network to the individual's private computer 230. In turn, the individual's private computer 230 processes the individual's at least one cyber interaction. The cyber interaction to be processed by the individual's private computer 230 may include at least one cyber activity that is available for use by the individual through at least one member selected from the group consisting of: (a) the individual's point of cyber access computers 200, (b) the individual's public computers 260, (c) the individual's cyber assets, (d) the individual's cyber resources, (e) the individual's cyber device managers, and (f) the individual's cyber telephone systems.

Cyber interactions with cyber activities, cyber interactions with cyber devices, and cyber interactions with cyber content that are available for use by the individual through the individual's private computer 230 may include at least one member selected from the group consisting of: (a) the individual's computer programs or application, (b) the individual's cyber telephone systems, (c) the individual's cyber device managers, (d) the individual's home automation systems and their resources, (e) the individual's vehicles, (f) the individual's owned copies of cyber television content, (g) the individual's cyber video entertainment and cyber music (h) the individual's cyber assets which may include cyber activity history, personal financial information, personal health information, photographs, or at least one other cyber activity, cyber device, or cyber content, and (i) access to cyber resources of at least one other party that are available for the individual's use including books, magazines, newspapers, libraries, cyber educational systems, cyber services, cyber health systems, and at least one other cyber resource.

As a result of an individual's cyber interactions, at least one member selected from the group consisting of: (a) the individual's private computers 230, (b) the individual's point of cyber access computers 200, and (c) the individual's public computers 260, may be configured to respond to the individual by sending cyber interactions through the at least one cyber communications network to the cyber portal 100 that is being used by the individual.

An example would be that the individual, at a cyber portal 100, interacts with an image on the display screen of the cyber portal 100. Several images appearing on the display screen provide the individual with choices for cyber interactions that are labeled for identification purposes. The individual interacts with one of the images appearing on the image display screen of the cyber portal 100, thereby communicating the interaction to the individual's remote point of cyber access computer. The individual's point of cyber access computer, in turn, processes the individual's cyber interaction, and responds by providing the cyber portal 100 that the individual is using with a new image. The new image is the result of the individual's point of cyber access computer's processing the individual's immediately prior cyber interaction.

Another example would be that instead of a physical interaction with a display screen of the cyber portal, the individual speaks certain words such as the instruction to “open the garage door” to the cyber portal 100. The cyber portal 100 communicates the individual's spoken cyber interaction to the individual's point of cyber access computer. In turn, the individual's point of cyber access computer operates the individual's garage door opener. The individual's point of cyber access computer may or may not notify the individual at the cyber portal of the status of the opening of the garage door, depending on the previously established preferences of the individual.

An individual's point of cyber access computer may be configured to remotely alter the functional or operational settings of a cyber portal 100 that is being used by the individual.

One possible result of an individual's cyber interactions with the individual's point of cyber access computer may be that the individual's point of cyber access computer responds in part, or in whole, to the individual's cyber interactions by providing cyber interactions that alter the functional or operational settings of the cyber portal 100 that is being used by the individual.

Alterations to the functional or operational settings of the cyber portal 100 may be requested by at least one member selected from the group consisting of: (a) the cyber portal 100, (b) the individual (through the individual's interactions with the cyber portal 100), (c) the individual's point of cyber access computer, (d) at least one cyber device, and (e) at least one executed cyber file.

A cyber portal 100 may be configured to return to predetermined functional or operational settings upon request or upon completion of a cyber interaction that requested or required the altered functional or operational settings for the cyber portal.

An individual's point of cyber access computer and a cyber portal 100 may be configured to each establish an interconnection with the cyber communications network. This cyber communications network interconnection may be an interconnection ranging from a momentary single line cyber communications network interconnection, to continuous multiple line cyber communications network interconnections.

Cyber interaction may be configured to include at least one instance of cyber interactions between at least one member selected from the group consisting of:

(a) an individual's cyber assets and the individual's cyber device managers;

(b) an individual using a cyber portal 100 and the individual's point of cyber access computers 200;

(c) cyber resources and an individual's public computers 260

(d) an individual's private computers 230 and the individual at a cyber portal 100;

(e) an individual's point of cyber access computers 200 and cyber devices;

(f) an individual's private computers 230 and cyber assets; and

(g) an individual's public computers 260 and cyber resources.

A cyber portal 100 may be configured to be used as a cyber communications network link between at least one device-based cyber assets or device-based cyber resources and an individual's point of cyber access computer.

A cyber portal 100 may be configured to use at least one line of cyber communication. The at least one line of cyber communication may be between a cyber portal 100 and an individual's point of cyber access computer, or between a cyber portal 100 and at least one device-based cyber assets or device-based cyber resource.

The operations of a thin cyber portal 100 may be limited to processing only functional and operational programming. Therefore, the thin cyber portal 100 may be configured to only run the programming that is required for the operations or use of the thin cyber portal itself. When working in conjunction with a thin cyber portal, an individual's point of cyber access computer must provide required processing, management, and support for the cyber interactions that are sent to the thin cyber portal 100.

Cyber interactions from an individual's point of cyber access computer to a thin cyber portal 100 that the individual is using should be pre-processed and made ready for use by the thin cyber portal prior to being sent through the cyber communications network.

The cyber portal 100 may be configured to, upon first cyber interaction with an individual's point of cyber access computer, provide the individual's point of cyber access computer with information regarding the display screen size, the type of display screen the cyber portal is equipped with, as well as information about the operational capabilities and the operational settings of the cyber portal 100.

A cyber portal's components may be configured to include at least one member selected from the group consisting of:

(a) one cyber system identity designation;

(b) one cyber system address designation;

(c) devices that provide for transferring cyber transfer packets over a cyber communications network;

(d) interconnecting circuits;

(e) sources of power;

(f) protective housings;

(g) image display screens;

(h) audio output devices 909;

(i) cameras 911;

(j) microphones 913;

(k) manual input devices;

(l) cyber storage devices;

(m) auxiliary input means for interactions with other cyber devices; and

(n) auxiliary output means for interaction with other cyber devices.

The scalable configurable universal operating system may be configured to provide at least one part of at least one operating system that enables at least one cyber portal 100 to be used as a cyber portal.

The scalable configurable universal operating system may be configured to provide at least one part of at least one program that may be utilized to provide for the interoperable use of the cyber portal 100 as a cyber portal 100 that may engage in cyber interactions with cyber devices that do not use the scalable configurable universal operating system.

The scalable configurable universal operating system may be configured to provide at least one program that provides for or enables an individual to alter the operational configuration of a cyber portal 100 on a temporary or permanent basis.

The scalable configurable universal operating system may be configured to provide or enable at least one program that provides the identity designation of a cyber portal to the first device in the cyber communications network that the cyber portal 100 has cyber interactions with.

The scalable configurable universal operating system may be configured to provide or enable at least one program that enables the cyber portal to provide all necessary cyber communications functions, including use of properly formatted transfer packets, for interactions with at least one type of cyber device.

A cyber portal 100 may be configured to at least one member selected from the group consisting of: (a) be an integral part of a point of cyber access computer, (b) be directly connected to at least one point of cyber access computer, and (c) operate as a separate remote cyber device that communicates with at least one remote point of cyber access computer through use of at least one cyber communications network 300.

Communications between a cyber portal 100 and an individual's point of cyber access computer may be configured to use at least one member selected from the group consisting of: (a) radio frequencies, (b) fiber optics, (c) wires, (d) at least one other suitable method for communications known to those skilled in the art, and (e) at least one combination thereof.

A remote, thin cyber portal 100, working in conjunction with at least one point of cyber access computer, may be configured to provide an individual with the highest attainable level of functional utility and computing or communications mobility.

A cyber portal 100 may be configured to interact with at least one cyber device.

A cyber portal 100 may include at least one member selected from the group consisting of: (a) cameras, (b) microphones, (c) keyboards, (d) pointing devices, (e) touchless interaction image display screens, (f) digital tablet enabled display screens, (g) sensors, (h) input devices, (i) media readers, (j) stored information links, (k) global position locating devices, (l) interconnections for other input devices, and (m) any other sources of input known to those skilled in the art.

A cyber portal 100 may be configured to provide user perceptible output utilizing at least one member selected from the group consisting of: (a) image display devices, (b) audio output devices, (c) tactile output devices, (d) interconnections for use with other output devices, (e) printers, and (f) any other useful user perceptible output devices that are known to those skilled in the art.

The size of a cyber portal's image display screen may range from the smallest usable image display screen size to the largest image display screen size available.

A cyber portal 100 may be configured to include at least one remote or local connection for cyber interaction with an individual's point of cyber access computer.

Each cyber portal that is not an integral part of a point of cyber access computer has a unique cyber system identity designation and a mobile or stationary cyber system address designation.

At least one individual may use at least one properly configured cyber portal for at least one cyber interaction with the individual's at least one remote point of cyber access computer. Cyber portals need not be user-specific. Properly configured cyber portals may also be utilized as cyber telephone devices.

Computers such as those incorporated into smart phones, tablets, laptop computers, or desktop computers may also be used as a cyber portal. These cyber portals have the ability to provide the additional feature of local computing functions to an individual.

An individual may require the use of a cyber portal 100 for cyber interactions with the individual's remote point of cyber access computer. In some embodiments, the cyber portal 100 may be configured with two 8.5″×11″ touchless interaction or digital tablet-enabled image display screens that are hinged together like a book in portrait format as shown in FIG. 16B. The illustrated cyber portal 901 shown in the array of images appearing in FIGS. 16A-16F makes an excellent, lightweight, and manageable cyber book, or a cyber portal that may be used to review, modify, or create cyber-based content of at least one type. The cyber portal shown in the array of images in FIGS. 16A-16F is typically not a computer. Rather, the cyber portal shown in the array of images in FIGS. 16A-16F is typically a remote thin cyber portal that is used for cyber interactions with an individual's at least one point of cyber access computer or for cyber interactions with at least one other cyber device.

As shown in FIGS. 16A and 16B, if an individual takes the cyber portal 901 that the individual is holding in book configuration and the individual places the cyber portal on a table where it is oriented as, and may be used as, an open laptop computer, then, through use of at least one cyber communications network interconnection with the individual's at least one point of cyber access computer, this cyber portal may become a remote terminal for cyber interactions with one of the individual's at least one point of cyber access computers.

An individual may use the touchless interaction or the digital tablet enabled functions of the image display screens on the illustrated cyber portal as a keyboard, or as a tablet for drawing, or as a tablet for handwriting, or as a tablet for marking of content.

Both of the image display screens on the illustrated cyber portal may also be arranged side-by-side to form one single larger sized image display screen.

With a 180-degree flip and a fold over of one of the image display screens of the cyber portal as shown in FIGS. 16D and 16E, the cyber portal may be transformed into a single-screen digital pad, or a single-screen digital tablet, or an interactive single-screen image display device as shown in FIG. 16F.

As shown in FIG. 16D, a cyber portal may include at least one camera, microphone, or speaker to provide for multimedia functions or to provide the individual's at least one point of cyber access computer with sensor observation derived identity information that may be used to establish the individual's identity.

The previously described remote cyber portal may well be a commonly used mid-sized mobile cyber portal. A cyber portal such as an iPhone-sized thin cyber portal puts interpersonal cyber communications as well as all of the capabilities of an individual's remote point of cyber access computer in the palm of the mobile individual's hand.

Televisions, telephones, computer monitors, computers, cell phones, tablets, vehicles, and other devices that provide audio/visual output may easily be adapted, by a person skilled in the art, for use as a cyber portal.

A cyber portal 100 may be configured to provide additional functions beyond that of a basic cyber portal. These additional functions may be used to provide for at least one member selected from the group consisting of: (a) the needs of at least one disabled individual, (b) integration of the cyber portal into at least one special or single-purpose cyber system, and (c) at least one other purpose.

### (10) Cyber Communications Network Between a Cyber Portal and a Point of Cyber Access Computer

The purpose of the part of the cyber communications network 300 that is used between a cyber portal 100 and an individual's point of cyber access computer is to safely and securely transfer at least one properly formatted and properly identified transfer packet between the cyber portal 100 and the individual's point of cyber access computer.

There may be unique transfer packet formats for at least one member selected from the group consisting of:

(a) cyber interactions from an individual's point of cyber access computer, to and through the cyber communications network 300, and to a cyber portal that is being used by the individual 100;

(b) cyber interactions from an individual using a cyber portal 100, to and through the cyber communications network 300, and to the individual's point of cyber access computer;

(c) cyber interactions from at least one of an individual's cyber assets, to and through a cyber portal 100 that is being used by an individual, to and through the cyber communications network 300, and to the individual's point of cyber access computer;

(d) cyber interactions from the cyber resources of other parties, to and through a cyber portal 100 that is being used by an individual, to and through, the cyber communications network 300, and to the individual's point of cyber access computer; and

(e) cyber interactions from an individual's point of cyber access computer, to and through the cyber communications network 300, to and through a cyber portal 100 that is being used by the individual, and to at least one cyber asset or to at least one cyber resource.

Cyber interactions between a cyber portal 100 and an individual's at least one point of cyber access computer may use at least one member selected from the group consisting of:

(a) lines of cyber communications;

(b) types of lines of cyber communications; and

(c) sources of lines of cyber communications.

Cyber interactions that use the part of the cyber communications network 300 between a cyber portal 100 and an individual's point of cyber access computer may be protected from intrusion or interference by others through the use of encryption or at least one other cyber security process that may renders the contents of a transfer packet useless to all but the sender or the intended recipient.

The part of the cyber communications network 300 between a cyber portal 100 that is being used by an individual and the individual's at least one point of cyber access computer may use for communication, at least one member selected from the group consisting of: (a) radio frequencies, (b) fiber optics, (c) wires, (d) at least one other suitable communications method or means, and (e) at least one combination thereof.

The cyber devices, cyber processes, and cyber procedures that serve the part of the cyber communications network 300 between a cyber portal 100 and an individual's at least one point of cyber access computer may be configured to provide for transfers of transfer packets that are free from intrusion and interference by others.

### (11) Point of Cyber Access Computer, Public Computer, and Private Computer

A point of cyber access computer 200 may be configured to provide one specific individual with a safe and secure remotely accessible computer that provides the one individual with a point to gain properly identified access to at least one member selected from the group consisting of: (a) computing capabilities, (b) the individual's cyber assets, (c) the individual's cyber telephone system, and (d) cyber resources.

The point where an individual gains cyber access may be the individual's point of cyber access computer 200. The point-of-cyber-access cyber system 10 provides a system architecture in which each individual that uses the point-of-cyber-access cyber system 10 has at least one point where the individual may gain access to at least one member selected from the group consisting of: (a) cyber activities, (b) cyber telephone communications, (c) cyber assets, and (d) available cyber resources. Further, at least one other party may have at least one point of cyber access where the at least one other party may interact with this specific individual for cyber telephone communications, for cyber activities, or for cyber interactions.

The foundation for configuring a cyber system 10 in such a way as to have it provide highest attainable levels of cyber security, privacy, and safety is to require that:

(a) each individual be properly identified prior each step the individual's cyber interactions take throughout the cyber system 10; and

(b) each cyber device be properly identified prior each step the cyber device's cyber interactions take throughout the cyber system 10.

An individual may use any cyber portal 100 for remote, or local, cyber interactions with the individual's at least one point of cyber access computer 200. The cyber portal 100 may be used to provide the individual's point of cyber access computer 200 with sensor observation derived information that enables the individual's point of cyber access computer 200 to establish the individual's identity.

After an individual's identity has been established by the individual's point of cyber access computer 200, the individual may be granted access to the resources of the individual's point of cyber access computer 200. Further, after the individual's identity has been established by the individual's point of cyber access computer 200, the individual's point of cyber access computer 200 may provide verification of the individual's identity prior to at least one step, or prior to each step that the individual's cyber interactions take throughout a cyber system 10.

An individual's at least one point of cyber access computer may be configured to establish the individual's identity and to provide verification of the individual's identity.

A point of cyber access computer 200 may be configured to work in conjunction with at least one separate private computer 230, or at least one separate public computer 260. Therefore, a point of cyber access computer 200 may be configured to be any combination of two or three of these separate types of computers.

An individual's at least one point of cyber access computer may be configured to provide the primary or only source of properly identified access control to at least one member selected from the group consisting of: (a) the individual's point of cyber access computers, (b) the individual's private computers, (c) the individual's public computers, (d) the individual's cyber telephone systems, (e) the individual's cyber device managers, and (f) other cyber devices.

Each individual that uses a cyber system 10 may be required to be properly identified. An individual's point of cyber access computer 200 may establish an individual's identity. After the individual's identity has been established, the individual may then gain access to the individual's private computer 230. Once the individual has gained access to the individual's private computer 230, the individual may have full operational access or administrative access to not only the individual's private computer 230, but also to the individual's point of cyber access computer 200 and to the individual's public computer 260 as well.

At least one configuration of the device architecture of the point of cyber access computer may solve many of the significant problems with prior art cyber systems and computers. An individual's point of cyber access computer may be optimally configured to be comprised of at least one of three separate types of computers. These types of computers include:

(a) an individual's point of cyber access computer;

(b) an individual's private computer; and

(c) an individual's public computer.

An individual's point of cyber access computer 200 may be configured to provide security, access control, and internal routing for all of the individual's point of cyber access computer's cyber activities. The individual's point of cyber access computer 200 may also provide interoperability processing or conversion, as needed, for inbound cyber activities, for outbound cyber activities, and for internal cyber activities.

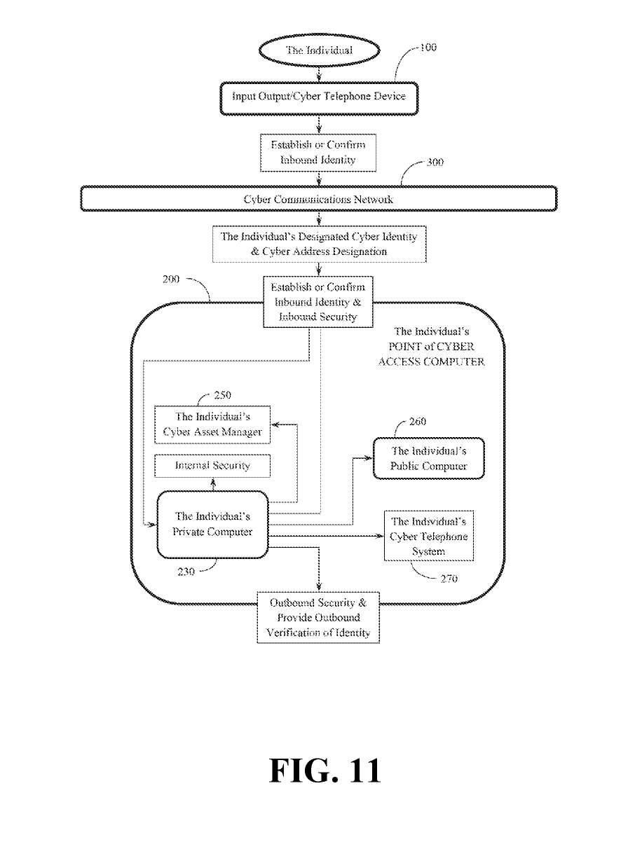

As shown in FIG. 11 an individual may gain administrative control or operational control of the individual's point of cyber access computer 200 through the individual's private computer 230.

An individual may have cyber interactions with the individual's private computer through the individual's use of any cyber portal 100. The individual's private computer 230 may be configured to provide the individual with the ability to have cyber interactions with at least one member selected from the group consisting of: (a) the individual's point of cyber access computers 200, (b) the individual's public computers 230, (c) the individual's cyber telephone systems 270, (d) the individual's cyber assets, (e) the individual's cyber device managers, and (f) available cyber resources. The individual's private computer 230 may also enable the individual to have cyber interactions with at least one other party.

An individual's point of cyber access computer 200 may be configured to establish the individual's identity prior to providing further access to the individual's cyber interactions. The individual's point of cyber access computer 200 may also be configured to establish the identity of at least one of the individual's device-based cyber assets prior to allowing the individual's device-based cyber asset's cyber interactions to gain further access to the individual's point of cyber access computer 200.

An individual's private computer may be configured such that access to the individual's private computer 230 may only be granted to cyber interactions from the individual, and to cyber interactions from at least one specified cyber asset of the individual. The individual's private computer may also be configured such that cyber interactions from all other parties, and cyber interactions from the cyber devices of all other parties, may be excluded from gaining access to the individual's private computer.

An individual's public computer 260 may be configured to be the only component that works in conjunction with the individual's point of cyber access computer 200 where others may participate in cyber interactions with the individual or where others may gain access to the individual's selected cyber resources. The individual's public computer and point of cyber access computer may be configured such that cyber resources may only be made available to others through the individual's public computer 260, and only with the permission of the individual.

An individual may choose to share at least one part of the individual's file-based cyber assets with specified other parties. The individual may make at least one part of the individual's file-based cyber assets available to at least one specified other party by providing the specified other party with copies of the individual's file-based cyber assets. These copies may be placed in the individual's properly configured public computer where they may be made available to be accessed by specified other parties through the other parties' cyber interactions with the individual's public computer 260.

File-based cyber resources are an individual's file-based cyber assets that have been copied to the individual's public computer 260 for use by at least one specified other party.

Preferably, a cyber system 10 may be configured to require the use of at least one member selected from the group consisting of different and unique: (a) processes, (b) procedures, (c) formats, (d) transfer packets, and (e) codes, for the operations of, or for cyber interactions with or between, at least one member selected from the group consisting of: (i) point of cyber access computers 200, (ii) private computers 230, and (iii) public computers 260. This arrangement may impart important security features of the cyber system.

A point of cyber access computer 200 may pre-process outbound cyber interactions to a cyber portal 100 so that the outbound cyber interactions may be transferred to, and used by, the cyber portal 100 with no further processing of content required.

A point of cyber access computer 200 may be configured to enable an individual to provide others with the individual's requests or requirements for privacy as well as the individual's preferences or requirements for inbound cyber activities or for inbound cyber content.

An individual's at least one point of cyber access computer 200 may be configured to provide for at least one member selected from the group consisting of:

(a) at least one point where the individual may gain identified access to at least one cyber system 10;

(b) at least one point where other parties may access an individual for cyber interactions;

(c) cyber security;

(d) the individual to have cyber interactions with cyber communications networks 300;

(e) cyber interactions with cyber portals 100 that are being used by the individual;

(f) cyber interactions using cyber telephone devices;

(g) routing of cyber activities;

(h) access to the individual's private computers 230;

(i) verification of the individual's identity prior to at least one step, or prior to each step that the individual's cyber interaction takes throughout a cyber system 10;

(j) sending outbound cyber interactions to a cyber portal or to remote cyber devices;

(k) denying access to the individual's private computer 260 by cyber interactions from all other parties and by cyber interactions from the cyber devices of all other parties;

(l) cyber interaction or security between the individual's point of cyber access computers 200 and the individual's private computers 230;

(m) cyber interaction or security between the individual's point of cyber access computers 200 and the individual's public computers 260;

(n) cyber interaction or security between the individual's private computers 230 and the individual's public computers 260;

(o) processes or procedures that may confirm the identity of each other party prior to granting or denying the cyber interactions of each selected other party further access to the individual's point of cyber access computers 200;

(p) the individual to enable at least one specified other party to gain access to the individual's public computers 260 for specified purposes;

(q) the individual to send outbound cyber interactions from the individual's public computers 260;

(r) verification of the individual's identity when the individual is sending outbound cyber interactions;

(s) verification of the individual's identity for the individual's interactions with the individual's device-based cyber assets;

(t) establishing the identity of the individual's device-based cyber assets prior to allowing cyber interactions from the individual's device-based cyber assets to gain further access to the individual's point of cyber access computers 200;

(u) interoperability conversion processes that convert devices or files to or from cyber system standard formats; and

(v) cyber telephone systems that provide cyber telephone or cyber video telephone services.

As shown in FIG. 13, an individual's private computer 230 may be configured to provide the individual with at least one member selected from the group consisting of:

(a) safe, secure, and private cyber environments where no others may gain access;

(b) computing capabilities;

(c) computer programs;

(d) computer applications;

(e) historical records of cyber activities;

(f) at least one member selected from the group consisting of: (i) storage, (ii) access, (iii) alteration, (iv) use, (v) sharing, and (vi) management of the individual's file-based cyber assets that include, but are not limited to, the individual's personal information, the individual's health information, and the individual's financial information;

(g) cyber device managers;

(h) administrative control or operational control of the individual's device-based cyber assets, this may include at least one member selected from the group consisting of: (i) the individual's point of cyber access computers, (ii) the individual's private computers, (iii) the individual's public computers, (iv) the individual's cyber device managers, and (v) the individual's cyber telephone systems;

(i) cyber interactions with other parties;

(j) cyber interactions with cyber resources of other parties;

(k) the ability to specify other parties that may have access to the individual's public computers;

(l) processes that enable the individual to share the individual's file-based cyber assets with other parties by making copies of the individual's file-based cyber assets available for the specified other parties to use as cyber resources;

(m) a system that enables the individual to designate which specific cyber resources are available for each specific other party to access through the individual's public computers;

(n) systems that enable the individual to grant, or to deny specified other parties access to the individual's public computers 260; and

(o) systems that enable the individual to grant, or to deny specified other parties access to specified cyber resources of the individual.

As shown in FIG. 14 an individual's at least one public computer 360 may be configured to provide at least one member selected from the group consisting of:

(a) at least one point of cyber access where other parties may interact with the individual;

(b) cyber security;

(c) at least one computing resource (this may be provided for other parties);

(d) the use of at least one computer program (this may be provided for other parties);

(e) the use of computer applications (this may be provided for other parties);

(f) the ability to send outbound cyber interactions in response to requests from other parties (this ability is preferably provided only to the individual);

(g) access to resources of the individual's inbound cyber mail systems (this may be provided to the individual or to other parties);

(h) access to resources of the individual's inbound cyber messaging systems (this may be provided to the individual or to other parties);

(i) specified other parties with access to the individual's cyber resources that have been selected for the specified other parties' use by the individual;

(j) at least one member selected from the group consisting of: (i) storage, (ii) access, (iii) alteration, (iv) use, (v) sharing, and (vi) management of the individual's file-based cyber resources;

(k) the ability to grant, or to deny specified other parties access to parts of the resources of the individual's public computers 260 (this ability is preferably provided only to the individual); and

(l) the ability to grant or to deny, specified other parties access to selected parts of the individual's cyber resources (this ability is preferably provided only to the individual).

### (12) Cyber Telephone System

At least one cyber telephone system 270 (see FIG. 2) may work in conjunction with at least one point of cyber access computer.

A cyber telephone system provides services for cyber telephone or cyber video telephone communications. The cyber telephone system may also be configured to send at least one automated cyber telephone communication to at least one other party.

An individual may utilize a cyber portal to initiate outbound cyber telephone communications through the individual's at least one point of cyber access computer, or the individual's at least one private computer, or the individual's at least one public computer, or the individual's at least one cyber telephone system.

An individual may grant, or deny cyber telephone system access to the cyber telephone communication interactions from at least one other party or to the cyber telephone communications interactions from at least one cyber device.

Transfer packet label information from an inbound cyber telephone communication interaction may be used to determine if an individual may grant or deny the at least one inbound cyber telephone communication interaction access to the individual's at least one cyber telephone system.

An individual may further grant or deny cyber telephone communication interactions from at least one specified other party access to at least one part of at least one service of the individual's at least one cyber telephone system.

An individual's at least one cyber telephone system may be configured to provide at least one member selected from the group consisting of:

(a) cyber security;

(b) the ability for the individual to grant or deny access to parts of the services of the individual's cyber telephone systems to cyber telephone communication interactions from other parties, or to cyber telephone communication interaction from cyber devices;

(c) routing of inbound cyber telephone communication interactions or cyber alerts to cyber telephone devices that are on or near the person of the individual;

(d) message-taking resources;

(e) routing of cyber telephone communication interactions to the individual's cyber telephone systems' message taking resources;

(f) messages for the senders of inbound cyber telephone communication interactions;

(g) for the individual to re-direct inbound cyber telephone communication interactions to specified recipients or to specified cyber devices; and

(h) historical records of cyber telephone system activities.

An individual, using a cyber portal, after gaining access to the individual's at least one private computer, may have at least one member selected from the group consisting of: (a) operational control, (b) administrative control, and (c) access control of the individual's cyber telephone systems.

An individual may simultaneously interact with two or more member selected from the group consisting of: (a) the individual's cyber telephone systems, (b) the individual's point of cyber access computers, (c) the individual's private computers, (d) the individual's public computers, and (e) the individual's device-based cyber assets.

The programming, processes, and procedures of the scalable configurable universal operating system may be configured to provide for or enable complete security for at least one cyber telephone communication interaction that is transferred from the individual's at least one cyber telephone system to the individual's at least one private computer or to the individual's at least one public computer.

### (13) Cyber Communications Network Between a Sender's Point of Cyber Access Computer and a Recipient's Point of Cyber Access Computer

The purpose of the part of the cyber communications network 300 that is used between a sender's point of cyber access computer and a recipient's point of cyber access computer is to safely and securely transfer at least one properly formatted and properly identified transfer packet between a sender's point of cyber access computer and a recipient's point of cyber access computer.

A sender's cyber interaction that is to be directed to a recipient may originate from the sender's interactions with a cyber portal. The cyber interaction that was derived from the sender's interactions with the cyber portal goes to and through the cyber communications network, and may go to and through the sender's point of cyber access computer, to and through the cyber communications network 300, to and through the recipient's point of cyber access computer, and then to the public computer component of the recipient's point of cyber access computer.

A sender's cyber interaction to a recipient may also come from the sender's public computer and go to and through the sender's point of cyber access computer, to and through the cyber communications network, to and through the recipient's point of cyber access computer, and then to the recipient's public computer.

A sender's cyber interaction to a recipient may also come from the sender's point of cyber access computer and go to and through the cyber communications network, to and through the recipient's point of cyber access computer, and then to the recipient's public computer.

There may be many unique types of transfer packets for cyber interactions from the sender's point of cyber access computer to the recipient's point of cyber access computer. The different and unique types of transfer packets may be used to identify different types of cyber activities in order to provide a high level of security for both the sender and the recipient.

Cyber interactions between a sender's point of cyber access computer and a recipient's point of cyber access computer may use at least one member selected from the group consisting of:

(a) lines of cyber communications

(b) types of lines of cyber communications; and

(c) sources of lines of cyber communications.

A sender may be required to be properly identified prior to each step the sender's cyber interactions take throughout the at least one cyber communications network 300.

Cyber interactions that use the part of the cyber communications network 300 between a sender's point of cyber access computer 200 and a recipient's point of cyber access computer 200, and most especially cyber interactions that use radio frequency, may be protected from intrusion and interference by others through the use of encryption, or other suitable cyber security measures that render the content of a transfer packet useless to all but the sender and the intended recipient of the transfer packet.

The devices, processes, and procedures that serve the part of the cyber communications network that is used between a sender's point of cyber access computer and a recipient's point of cyber access computer may be configured to provide for the cyber communications network transfer of at least one transfer packet that is free from intrusion or interference by others.

### (14) the Individual's Cyber Device Manager and the Individual's Device-Based Cyber Assets

An individual's device-based cyber assets may include at least one member selected from the group consisting of: (a) video cameras, (b) televisions, (c) television programming access or selection devices, (d) personal health monitors, (e) personal health care devices, (f) devices for properly identifying at least one person, (g) vehicles, (h) cyber vaults, (i) cyber file back-up or restore devices, (j) global position locating devices, (k) cyber device managers that are utilized for home or business automation management (which may include monitoring, recording, or operationally interacting with lights, heating or cooling systems, locks, garage door openers, lawn sprinkler systems, security systems, water or electric meter readings, automated pet doors, personal weather stations, and more), and (l) any other device-based cyber assets.

An individual may have at least one device-based cyber asset that is not an integral part of the individual's at least one point of cyber access computer.

An individual's at least one device-based cyber asset may have at least one cyber interaction with the individual through utilization of at least one cyber device manager.

An individual's at least one cyber device manager enables safe and secure cyber interactions between the individual and the individual's at least one device-based cyber asset. The individual's at least one cyber device manager may be configured to provide the individual with safe and secure access control, administrative control, and operational control of the individual's at least one device-based cyber asset.

An individual may gain access control, administrative control, and operational control of the individual's at least one cyber device manager through the individual's at least one private computer 230. Utilizing this choice of configuration of the combination of at least one private computer, and at least one cyber device manager, no others may gain access control, administrative control, or operational control of the individual's at least one cyber device manager.

There may be complete security for an individual's at least one cyber interaction that is transferred from the individual's at least one cyber device manager to the individual's at least one private computer.

An individual's at least one cyber device manager may establish the identity of the individual's at least one device-based cyber asset prior to providing at least one cyber interaction from the individual's at least one device-based cyber asset with further access to the individual's at least one cyber device manager.

An individual's at least one device-based cyber asset may establish the identity of the individual's at least one cyber device manager prior to the individual's at least one device-based cyber asset's providing further cyber access to at least one cyber interaction from the individual's at least one cyber device manager.

An individual's at least one cyber device manager may work in conjunction with the individual's at least one point of cyber access computer.

An individual may have at least one cyber device manager that is located within the individual's at least one point of cyber access computer, or at least one cyber device manager that may be located within the individual's at least one private computer. Locating a cyber device manager within the individual's properly configured private computer may provide for the highest attainable level of security and privacy for cyber interactions with the individual's at least one device-based cyber asset.

For example, an individual's at least one cyber device manager may have at least one cyber interaction with at least one cyber device on the person of the individual. One particular cyber device that may be located on the person of the individual may report on the individual's blood sugar level. The individual may also have a cyber insulin delivery system that is operated through cyber interactions with the individual's cyber device manager. The individual's health and well-being may depend on the cyber interactions with both of these devices. Therefore, the individual may be best served by using the highest level of security and privacy available for cyber interactions between the cyber device manager and these two cyber devices. This may be accomplished by having cyber interactions between these two device-based cyber assets provided by at least one private-computer-located cyber device manager.

An individual's at least one cyber device manager, and the same individual's at least one device-based cyber asset, may interconnect using the resources of at least one cyber communications network.

An individual's at least one cyber device manager may use at least one resource of the scalable configurable universal operating system for at least one cyber operation or at least one cyber interaction.

An individual's at least one device-based cyber asset may be configured to only interact with the individual. Other parties that wish to have cyber interactions with the individual's at least one device-based cyber asset must request that the individual provide the requestor with the requested cyber resource. The requested cyber resource may be made available for the requestor through the requestor's cyber interaction with the individual's at least one public computer 260.

An individual's at least one cyber device manager or the individual's at least one device-based cyber asset may provide at least one historical record of at least one cyber interaction or at least one cyber activity.

### (15) Cyber Communications Network Between an Individual's Cyber Device Manager and the Individual's Remote Device-Based Cyber Assets

The purpose of the part of the cyber communications network that is used between an individual's cyber device manager and the individual's remote device-based cyber assets is to safely and securely transfer at least one properly formatted and properly identified transfer packet between the individual's at least one cyber device manager and the individual's at least one remote device-based cyber asset.

An individual's cyber device manager's interaction with at least one of the individual's device-based cyber assets may come from the individual's cyber device manager, through the individual's private computer, to and through the individual's point of cyber access computer, to and through the cyber communications network, and to the individual's remote device-based cyber asset.

An individual's remote device-based cyber asset's interaction with the individual's cyber device manager may come from the individual's remote device-based cyber asset, to and through the cyber communications network, to and through the individual's point of cyber access computer, to at least one member selected from the group consisting of: (a) the individual's cyber device manager, or (b) the individual's private computer, and then on to the individual's cyber device manager.

There may be many unique transfer packet formats for cyber interactions between an individual's cyber device manager and the individual's device-based cyber assets. The different and unique transfer packet formats may be used to identify cyber interactions that came from different types of cyber devices or to identify cyber interactions for different functions or purposes.

Cyber interactions between an individual's at least one cyber device manager and the individual's at least one device-based cyber asset may use at least one member selected from the group consisting of:

(a) lines of cyber communications;

(b) types of lines of cyber communications; and

(c) sources of lines of cyber communications.

An individual's at least one device-based cyber asset may use a cyber telephone device that is being used by the individual or a cyber portal that is being used by the individual as a cyber communications network link to or from the individual's at least one point of cyber access computer.

An individual's at least one cyber device manager may be required to be properly identified prior to at least one step, or prior to each step that the individual's cyber device manager's cyber interactions take through at least one cyber communications network. Further, the individual's at least one device-based cyber asset may be required to be properly identified prior to at least one step, or prior to each step that the individual's remote device-based cyber asset's cyber interactions take throughout at least one cyber communications network.

Cyber interactions that use the part of the cyber communications network between an individual's cyber device manager and the individual's remote device-based cyber assets, (and especially those cyber interactions that use radio frequency), may be protected from intrusion and interference by others by the use of encryption or other suitable cyber security measures that render the content of a transfer packet useless to all but the sender and the designated recipient of the transfer packet.

The devices, processes, and procedures that control the operations of this part of the cyber communications network, through their use of the programming, processes, and procedures that may be a part of the scalable configurable universal operating system, may provide for the safe and secure transfer of at least one transfer packet that is free from intrusion or interference by others.

### (16) Examples of Use of the Point-of-Cyber-Access Cyber System

On election day in November every voter in the United States may, through use of a cyber portal, gain properly identified access to his or her point of cyber access computer. Through utilization of the proper-identity-based access control services of the point-of-cyber-access cyber system, every voter will have the ability to safely, securely, and privately cast his or her vote in at least one, or in all, of the elections where the individual is eligible to cast a vote.

In the context of education, in an elementary school classroom, a student may use a cyber portal such as shown in FIGS. 16A-16F. As shown in FIG. 16B, this device may have two approximately 8″ by 11″ touchless interaction image display screens that are hinged together on one side like a book in portrait format. The student may turn the same cyber portal 90 degrees where it may be configured to resemble and provide the functions of a laptop computer.

The student may utilize the cyber portal and the resources of at least one cyber communications network to interact with the student's at least one remotely located point of cyber access computer.

As shown in FIGS. 16C and 16F, the student may use a stylus 907 in conjunction with a digital tablet feature of the cyber portal's display screens to write, to draw, or to interact with an image appearing on the display screens. The student may also use the touchless interaction mode of the display screens for interaction with the student's remotely located point of cyber access computer. The display screens' touchless interaction mode may also be configured to provide the student with a touchless interaction keyboard on at least one of the cyber portal's display screens. Furthermore, the student may use the cyber portal's microphone or camera for cyber interaction input to the student's point of cyber access computer. Also, the student may use at least one other type of cyber input device that may work in conjunction with the student's cyber portal.

The student's point of cyber access computer may provide the student with access to cyber educational materials from multiple sources such as, for example, a public cyber library, a cyber compendium of information, or the school district's cyber library.

The student's point of cyber access computer may use school district-supplied computer programs, school district-supplied computer applications, and school district-supplied cyber educational materials.

The student uses a cyber portal to remotely access the student's point of cyber access computer so that the student may use the school district-supplied cyber-based educational resources and materials that are to be used during the class that the student is currently attending.

The cyber portal may be configured to provide the student with full interactive access to available cyber-based educational resources and materials.

The student may use a stylus 907 to either hand write a report or to work on math problems.

The student stores the student's schoolwork using the student's point of cyber access computer.

The student submits finished school work to the student's teacher using cyber mail functions.

The student may also enter in to cyber telephone communication interactions with the student's teacher during class by simply using video telephone functions for remote interaction with the student's teacher from across the classroom.

The student's teacher, through use of school district-supplied computer programs or computer applications, may access, during class, a copy of the image that is displayed on the student's cyber portal. Using the same school district-supplied computer programs and computer applications, the student's teacher may interact with the student during class by providing graphic input that may be viewed by the student in real time on an image display screen of the student's cyber portal.

All of the previously addressed school-related cyber activities do not necessarily require that cyber interconnection and computing infrastructure be provided to the student by the school district. Cyber-based educational activity is performed using cyber mail functions, cyber interaction functions, and cyber video telephone functions.

The school district may provide the student with any cyber educational materials that the school district deems appropriate.

The school district may also provide the student with cyber educational materials that are appropriate for the student's abilities in any field of study. Furthermore, the school district may supply the student with cyber educational materials that are formatted to be of most interest to the student and most suitable to the best learning styles for the student. By using these cyber educational resources, a school district may have the ability to make “no child left behind” an educational concept and challenge of the past.

It should also be noted that the student may use, from anywhere the student is located, at least one cyber portal to remotely access the cyber-based educational resources made available to the student through the student's point of cyber access computer.

In the context of the health care of a person as an individual, when the individual has a health-related examination by a health care provider, the health care provider may safely, securely and privately:

(a) maintain a record of the interaction between the health care provider and the individual for at least one part of the lifetime of the individual;

(b) provide a cyber system health care information registry with the individual's cyber system identity designation, along with the health care provider's cyber system identity designation and the date of the health care-related service; and

(c) provide the individual with a complete record of the individual's health care-related interaction with the health care provider by sending a copy of the health care provider's record to the individual through the individual's point of cyber access computer.

The individual may review the copy of the health care provider's record of the individual's health-related examination for accuracy and may then require the health care provider to correct inaccuracies (if necessary).

The individual may choose to save at least one part of, the health care provider's record of the individual's health-related examination by transferring the copy of the health care provider's record from the individual's public computer to the individual's private computer where the record or at least one part thereof, may be saved as a part of the individual's absolutely safe, secure, and private files that contain the individual's personal health records.

The individual may also choose to delete the copy of the health care provider's record of the individual's health-related examination.

If the individual happens to lose, or delete, the copy of the health care provider's record of the individual's health-related examination, the individual may contact the cyber system health care information registry and receive the needed information. The cyber system health care information registry provides information to the individual that only includes the health care provider's cyber system identity designation and the date of the individual's health-related examination. Using information provided by the cyber system health care information registry, the individual may request that the health care provider send the individual a copy of the health care provider's record of the individual's prior health-related examination. The health care provider may then provide a copy of the record of the individual's health-related examination to the individual only, thereby providing the individual with complete privacy for, and control over, the individual's cyber system-based health records.

The individual may, anonymously, or with the other parties' knowledge of the individual's identity, choose to share at least one part of the individual's health-related information with at least one specified other party.

If a third party, such as a health care insurance company, was obligated to pay for at least one part of the individual's health-related services, the third party insurance company may require that the individual provide the third party insurance company with a cyber interaction that discloses or confirms at least one of the details about the health-related services the individual received from the health care provider. This simple process may be used to eliminate many types of health care fraud.

The individual may safely, securely, and privately share at least one part of the individual's health information with at least one specified health care provider. The individual's shared health information may provide the health care provider with a tool to use to better provide appropriate health care services to the individual.

The individual may safely, securely, privately, and anonymously share at least one part of the individual's personal health information with at least one scientist or researcher that is working to provide improved health care outcomes. Quantum leaps forward may be made by scientists and researchers when vast amounts of donated reliable health information from large numbers of individuals are made available for research.

The individual may also choose to provide at least one part of the individual's health information to an agency such as the United States Center for Disease Control and Prevention (CDC) so that the CDC may use the individual as one of many that are used to monitor a geographic area or a specific part of the population for at least one targeted health-related occurrence. The CDC may then monitor a sample of people to determine when and where there is an outbreak of flu or disease (which may be, for example, a food-borne or host-borne illness), and when and where there is an occurrence of at least one other targeted health-related issue.

A cyber system's ability to allow an individual to safely, securely, privately and anonymously share at least one part of the individual's health information with at least one selected other party will provide public health entities with an informational tool that may fill the public health entities' state-of-the-public's-health informational needs.

A cyber system may enable or provide an all-inclusive world-wide database of health care information, as well as area-appropriate definitions for the health care information that is contained within the database. This database may be an ultimate informational tool for scientists or medical researchers to use to improve health care outcomes worldwide.

A cyber system may be configured to provide an individual with at least one safe, secure, and private process for cyber interactions with cyber health monitoring devices or cyber health care resource delivery devices that are on or near the person of the individual.

For example, an individual uses cyber health information sensors on his or her person. The cyber health information sensors, using the resources of the cyber system, interact with at least one of the individual's point of cyber access computers. The individual's cyber health information sensors report to the individual's at least one point of cyber access computers that the individual has a blood sugar level that requires the individual's cyber insulin delivery system (that may be placed on the person of the individual) to deliver a specified amount of insulin to the individual's bloodstream. The individual may require that the individual's permission is given prior to the delivery of insulin, or the individual may allow an automated delivery of insulin if the automated delivery does not exceed a pre-determined amount of insulin. The sensor observation indicates the individual requires a dose of insulin that exceeds this pre-determined maximum acceptable dose, so, the individual is required to approve the delivery of the indicated necessary dose of insulin before the indicated necessary dose of insulin is delivered.

The cyber system's ability to safely, securely and privately monitor and record information that is received from cyber health information sensors that are on or near the person of an individual provides the individual with intermittent or continuous reporting from cyber health information sensors of at least one type. Information from cyber health information sensors may be used by the individual or saved by the individual for later use by the individual or for later use by health care providers. Alternatively, saved information from the individual's cyber health information sensors may be used by science or medicine to enable science or medicine to better understand the intricacies of the workings of a human body in order to be able to provide improved health care outcomes worldwide.

In another example, an individual is driving towards the individual's residence. The individual inputs the voice command, “open the garage door,” to the individual's pocket-sized cyber portal cyber telephone device. The individual's point of cyber access computer receives the individual's voice-based cyber interaction and, in turn, monitors the global position locating sensor that is a part of the individual's cyber portal cyber telephone device. Such monitoring allows the individual's point of cyber access computer to determine the optimum point in time to interact with the individual's garage door opener. The individual's computer interacts with the individual's garage door opener to open the individual's garage door as the individual and the individual's vehicle approach.

The above description of the present invention is illustrative, and is not intended to be limiting. It will thus be appreciated that various additions, substitutions and modifications may be made to the above described embodiments without departing from the scope of the present disclosure. Accordingly, the scope of the present disclosure should be construed in reference to the appended claims. The elements of these claims may be combined in different combinations and sub-combinations without departing from the scope of the disclosure. For example, the subject matter of two or more dependent claims may be combined without departing from the scope of the disclosure, even if the claims do not share a dependency.

What is claimed is:

1. In combination with at least one cyber system, a scalable configurable universal operating system which provides or enables processes or procedures that may be utilized for at least one operation of at least one component of the at least one cyber system;
wherein said at least one cyber system may be utilized by at least one individual or at least one cyber device;
wherein said at least one cyber system includes at least one member selected from the group consisting of
(a) cyber communications networks,
(b) cyber portals,
(c) point of cyber access computers,
(d) private computers,
(e) public computers,
(f) cyber telephone systems,
(g) cyber device managers,
(h) cyber assets, and
(i) cyber resources;
wherein said scalable configurable universal operating system may be configured in at least one way;
wherein said scalable configurable universal operating system may be scaled to include operating system resources that fall at one point in the range of from a minimum to a maximum, wherein at the minimum said scalable configurable universal operating system is scaled to provide at least one part of the operating system resources that are needed to provide for the least complex, in regard to included operating system resources, of all operating system needs, and wherein at the maximum, said scalable configurable universal operating system is scaled to include all of the operating system resources that are needed to provide for every operating system need from a full spectrum of operating system needs;
wherein said scalable configurable universal operating system further comprises at least one part of the at least one member selected from the group consisting of
(a) programming that provides or enables processes or procedures that provide for properly identifying individuals,
(b) programming that provides or enables processes or procedures that provide for properly identifying cyber devices,
(c) programming that provides or enables processes or procedures that provide for requiring that at least one individual be properly identified prior to at least one step that at least one cyber interaction of said at least one individual carries out throughout said at least one cyber system,
(d) programming that provides or enables processes or procedures that provide for requiring that at least one cyber device be properly identified prior to at least one step that at least one cyber interaction of said at least one cyber device carries out throughout said at least one cyber system,
(e) programming that provides or enables processes or procedures that provide for at least one individual to be properly identified prior to at least one step that at least one cyber interaction of said at least one individual carries out throughout said at least one cyber system,
(f) programming that provides or enables processes or procedures that provide for at least one cyber device to be properly identified prior to at least one step that at least one cyber interaction of said at least one cyber device carries out throughout said at least one cyber system,
(g) programming that provides or enables processes or procedures that provide for the operations of, or the use of, cyber communications networks,
(h) programming that provides or enables processes or procedures that provide for the operations of, or the use of, cyber portals,
(i) programming that provides or enables processes or procedures that provide for the operations of, or the use of, point of cyber access computers,
(j) programming that provides or enables processes or procedures that provide for the operations of, or the use of, private computers,
(k) programming that provides or enables processes or procedures that provide for the operations of, or the use of, public computers,
(l) programming that provides or enables processes or procedures that provide for the operations of, or the use of, device-based cyber assets,
(m) programming that provides or enables processes or procedures that provide for the operations of, or the use of, device-based cyber resources,
(n) programming that provides or enables processes or procedures that provide for the operations of, or the use of, cyber device managers,
(o) programming that provides or enables processes or procedures that provide for the operations of, or the use of, cyber telephone systems,
(p) programming that provides or enables processes or procedures that provide for the operations of, or the use of, cyber transfer packet systems,
(q) programming that provides or enables processes or procedures that provide for the operations of, or the use of, mobile or in-motion cyber devices,
(r) programming that provides or enables processes or procedures that provide for the operations of, or the use of, cyber vaults,
(s) programming that provides or enables processes or procedures that provide for the operations of, or the use of, cyber health systems,
(t) programming that provides or enables processes or procedures that provide for the operations of, or the use of, at least one member selected from the group consisting of
(i) health care related cyber devices,
(ii) health care related cyber assets, and
(iii) health care related cyber resources,
(u) programming that provides or enables processes or procedures that provide for the operations of, or the use of, cyber rights licensing systems,
(v) programming that provides or enables processes or procedures that provide for the operations of, or the use of, cyber mail systems,
(w) programming that provides or enables processes or procedures that provide for the operations of, or the use of, cyber sites,
(x) programming that provides or enables processes or procedures that provide for the operations of, or the use of, cyber education systems,
(y) programming that provides or enables processes or procedures that provide for the operations of, or the use of, cyber payment systems,
(z) programming that provides or enables processes or procedures that provide for the operations of, or the use of, scalable configurable universal operating system standard device interconnection interfaces that may be utilized by cyber devices,
(aa) programming that provides or enables processes or procedures that provide for the operations of, or the use of, a frames and scrolls system or format for image-based cyber content,
(bb) programming that provides or enables processes or procedures that provide for the operations of, or the use of, autonomous devices,
(cc) programming that provides or enables processes or procedures that provide for at least one member selected from the group consisting of
(xv) creating,
(xvi) accessing,
(xvii) modifying,
(xviii) using,
(xix) sharing,
(xx) storing, and
(xxi) managing,
file-based cyber assets,
(dd) programming that provides or enables processes or procedures that provide for at least one member selected from the group consisting of
(iv) creating,
(v) accessing,
(vi) modifying,
(vii) using,
(viii) sharing,
(ix) storing, and
(x) managing,
file-based cyber resources,
(ee) programming that provides or enables processes or procedures that provide security,
(ff) programming that provides or enables processes or procedures that provide historical records regarding any aspect of the operations of cyber systems, and
(gg) programming that provides or enables processes or procedures that enable an individual to exclusively select at least one setting of at least one member selected from the group consisting of
(iv) the administrative settings of the individual's cyber systems,
(v) the operational settings of the individual's cyber systems, and
(vi) the access settings of the individual's cyber systems.

2. The combination of claim 1, wherein said at least one cyber system is selected from the group consisting of the full spectrum of cyber systems;
wherein said full spectrum of cyber systems includes at least one point-of-cyber-access cyber system.

3. The combination of claim 2, wherein said scalable configurable universal operating system further includes programming that provides or enables processes or procedures that require or provide for separate processing or support for one member or a combination of two or more members selected from the group consisting of
(a) an individual's private cyber activities,
(b) an individual's private cyber content, and
(c) an individual's private cyber interactions,
as well as separate and different processing or support for one member or a combination of two or more members selected from the group consisting of
(iv) an individual's public cyber activities,
(v) an individual's cyber content that is made available to at least one other party or at least one cyber device of at least one other party, and
(vi) an individual's public cyber interactions.

4. The combination of claim 2, wherein said scalable configurable universal operating system further includes programming that provides or enables processes or procedures that provide for interoperable use of at least one member selected from the group consisting of
(a) cyber programs,
(b) cyber files, and
(c) cyber devices,
that do not operate utilizing at least one member selected from the group consisting of
(iv) scalable configurable universal operating system standard processes,
(v) scalable configurable universal operating system standard procedures, and
(vi) scalable configurable universal operating system standard formats,
by providing at least one process or procedure that may be utilized to convert the operations of at least one member selected from the group consisting of
(A) said cyber programs,
(B) said cyber files, and
(C) said cyber devices,
to or from the operations of at least one member selected from the group consisting of
(1) said scalable configurable universal operating system standard processes,
(2) said scalable configurable universal operating system standard procedures, and
(3) said scalable configurable universal operating system standard formats.

5. The combination of claim 2, wherein said scalable configurable universal operating system further includes programming that provides or enables processes or procedures that require or provide for the use of at least one member selected from the group consisting of
(a) unique processes,
(b) unique procedures,
(c) unique protocols,
(d) unique code, and
(e) unique formats,
to be used for at least one member selected from the group consisting of
(v) cyber programs,
(vi) cyber applications,
(vii) cyber activities, and
(viii) cyber interactions,
that are utilized for different purposes.

6. The combination of claim 2, wherein said scalable configurable universal operating system further includes programming that provides or enables processes or procedures that may enable an individual to have exclusive control of at least one setting selected from the group consisting of
(a) administrative settings,
(b) operational settings, and
(c) access control settings,
for at least one member selected from the group consisting of
(j) said individual's point of cyber access computers,
(ii) said individual's private computers,
(iii) said individual's public computers,
(iv) said individual's cyber device managers,
(v) said individual's cyber telephone systems,
(vi) said individual's cyber vaults,
(vii) said individual's cyber assets, and
(viii) said individual's cyber resources.

7. The combination of claim 2, wherein said scalable configurable universal operating system further includes programming that provides or enables processes or procedures that utilize a combination of
(a) a virtual equivalent of at least one projector, in conjunction with,
(b) a virtual equivalent of at least one projection display screen that receives the virtual equivalent of at least one image output from said at least one projector, and
(c) a virtual equivalent of at least one recorder or capture device that provides the virtual equivalent of at least one recording of at least one image from said at least one projection screen, or the virtual equivalent of at least one recording of at least one part of the audio output from said at least one projector,
all of which may be utilized for providing at least one member selected from the group consisting of
(i) interoperability conversion of at least one member selected from the group consisting of
(A) cyber content,
(B) cyber programming,
(C) cyber interactions,
(D) cyber activities, and
(E) cyber device interactions,
to or from universal interactive operating system standard operations,
(ii) security,
(iii) at least one malicious content trap,
(iv) for altering the size of cyber images,
(v) for altering the resolution of cyber images,
(vi) for altering the visual presence of cyber images,
(vii) for interactive utilization of image-based cyber content, and
(viii) for converging two or more sources of image-based cyber content into at least one converged source of image-based cyber content.

8. The combination of claim 2, wherein said scalable configurable universal operating system further includes programming that provides or enables processes or procedures that enable an individual to perform at least one action selected from the group consisting of
(a) adding architectural components to,
(b) adding programs to,
(c) adding cyber devices to,
(d) removing architectural components from,
(e) removing programs from,
(f) removing cyber devices from,
(g) altering architectural component of,
(h) altering programs of, and
(i) altering cyber devices of,
said at least one cyber system.

9. The combination of claim 2, wherein said scalable configurable universal operating system further includes programming that provides or enables processes or procedures that enable at least one individual to perform at least one action selected from the group consisting of
(a) adding processes or procedures to,
(b) removing processes or procedures from, and
(c) altering processes or the procedures of,
at least one component of said at least one cyber system.

10. The combination of claim 2, wherein said scalable configurable universal operating system further includes programming that provides or enables processes or procedures that enable at least one individual to perform at least one action selected from the group consisting of
(a) adding at least one member selected from the group consisting of
(i) components,
(ii) processes and
(iii) procedures,
to at least one cyber device,
(b) removing at least one member selected from the group consisting of
(i) components,
(ii) processes, and
(iii) procedures,
from at least one cyber device, and
(c) altering at least one member selected from the group consisting of
(i) components,
(ii) processes, and
(iii) procedures,
of at least one cyber device.

11. The combination of claim 2, wherein said scalable configurable universal operating system further includes system standard processes or system standard procedures that are utilized for minimizing the number of differing processes or procedures used by others by providing said system standard processes or procedures for use by others.

12. The combination of claim 2, wherein said scalable configurable universal operating system further includes programming that provides or enables processes or procedures that enable an individual to request or require that at least one other party or at least one cyber device of at least one other party provide said individual with said individual's at least one preference for at least one member selected from the group consisting of
(iv) cyber interactions
(v) cyber content, and
(vi) privacy.

13. The combination of claim 2, wherein said scalable configurable universal operating system further includes programming that provides or enables processes or procedures that enable an individual to selectively grant or to selectively deny at least one member selected from the group consisting of
(a) said individual's device-based cyber assets,
(b) said individual's device-based cyber resources,
(c) other parties, and
(d) cyber devices of other parties,
access to at least one selected part of said individual's cyber assets or said individual's cyber resources, said at least one selected part being selected by said individual.

14. In combination with at least one cyber system, a tangible, non-transient medium having sufficient programming instructions recorded therein which, when executed by at least one computer processor, performs the step of:
establishing a scalable configurable universal operating system which provides or enables processes or procedures that may be utilized for at least one part of at least one operation of at least one component of the at least one cyber system,
wherein said at least one cyber system may be utilized by at least one individual or at least one cyber device, wherein said at least one cyber system includes at least one member selected from the group consisting of
(a) cyber communications networks,
(b) cyber portals,
(c) point of cyber access computers,
(d) private computers,
(e) public computers,
(f) cyber telephone systems,
(g) cyber device managers,
(h) cyber assets, and
(i) cyber resources,
wherein said scalable configurable universal operating system may be configured in at least one way, and
wherein said scalable configurable universal operating system may be scaled to include operating system resources that fall at one point in the range of from a minimum to a maximum, wherein at the minimum said scalable configurable universal operating system is scaled to provide at least one part of the operating system resources that are needed to provide for the least complex, in regard to included operating system resources, of all operating system needs, and wherein at the maximum said scalable configurable universal operating system is scaled to include all of the operating system resources that are needed to provide for every operating system need from a full spectrum of operating system needs; and
providing or enabling, with the established scalable configurable universal operating system, at least one part of at least one member selected from the group consisting of
(a) processes or procedures that provide for properly identifying individuals,
(b) processes or procedures that provide for properly identifying cyber devices,
(c) processes or procedures that provide for requiring that at least one individual be properly identified prior to at least one step that at least one cyber interaction of said at least one individual carries out throughout said at least one cyber system,
(d) processes or procedures that provide for requiring that at least one cyber device be properly identified prior to at least one step that at least one cyber interaction of said at least one cyber device carries out throughout said at least one cyber system,
(e) processes or procedures that provide for at least one individual to be properly identified prior to at least one step that at least one cyber interaction of said at least one individual carries out throughout said at least one cyber system,
(f) processes or procedures that provide for at least one cyber device to be properly identified prior to at least one step that at least one cyber interaction of said at least one cyber device carries out throughout said at least one cyber system,
(g) processes or procedures that provide for the operations of, or the use of, cyber communications networks,
(h) processes or procedures that provide for the operations of, or the use of, cyber portals,
(i) processes or procedures that provide for the operations of, or the use of, point of cyber access computers,
(j) processes or procedures that provide for the operations of, or the use of, private computers,
(k) processes or procedures that provide for the operations of, or the use of, public computers,
(l) processes or procedures that provide for the operations of, or the use of, device-based cyber assets,
(m) processes or procedures that provide for the operations of, or the use of, device-based cyber resources,
(n) processes or procedures that provide for the operations of, or the use of, cyber device managers,
(o) processes or procedures that provide for the operations of, or the use of, cyber telephone systems,
(p) processes or procedures that provide for the operations of, or the use of, cyber transfer packet systems,
(q) processes or procedures that provide for the operations of, or the use of, mobile or in-motion cyber devices,
(r) processes or procedures that provide for the operations of, or the use of, cyber vaults,
(s) processes or procedures that provide for the operations of, or the use of, cyber health systems,
(t) processes or procedures that provide for the operations of, or the use of, at least one member selected from the group consisting of
(i) health care related cyber devices,
(ii) health care related cyber assets, and
(iii) health care related cyber resources,
(u) processes or procedures that provide for the operations of, or the use of, cyber rights licensing systems,
(v) processes or procedures that provide for the operations of, or the use of, cyber mail systems,
(w) processes or procedures that provide for the operations of, or the use of, cyber site systems,
(x) processes or procedures that provide for the operations of, or the use of, cyber education systems,
(y) processes or procedures that provide for the operations of, or the use of, cyber payment systems,
(z) processes or procedures that provide for the operations of, or the use of, at least one scalable configurable universal operating system standard device interconnection interface that may be utilized by at least one cyber device,
(aa) processes or procedures that provide for the operations of, or the use of, a frames and scrolls system or format for image-based cyber content,
(bb) processes or procedures that provide for the operations of, or the use of, autonomous devices,
(cc) processes or procedures that provide for at least one member selected from the group consisting of
(xxii) creating,
(xxiii) accessing,
(xxiv) modifying,
(xxv) using,
(xxvi) sharing,
(xxvii) storing, and
(xxviii) managing,
file-based cyber assets,
(dd) processes or procedures that provide for at least one member selected from the group consisting of
(xi) creating,
(xii) accessing,
(xiii) modifying,
(xiv) using,
(xv) sharing,
(xvi) storing, and
(xvii) managing,
file-based cyber resources,
(ee) processes or procedures that provide security,
(ff) processes or procedures that provide historical records regarding any aspect of the operations of cyber systems, and
(gg) processes or procedures that enable an individual to exclusively select at least one setting of at least one member selected from the group consisting of
(vii) the administrative settings of the individual's at least one cyber system,
(viii) the operational settings of the individual's at least one cyber system, and
(ix) the access settings of the individual's at least one cyber system.
